SEQUENCE LISTING (44 sequences)

SEQ ID NO: 1 - protein, 50 aa, Araneus diadematus
SGCDVLVQALLEVVSALVSILGSSSIGQINYGASAQYTQMVGQSVAQALA

SEQ ID NO: 2 - protein, 30 aa, Araneus diadematus
SGCDVLVQALLEVVSALVSILGSSSIGQIN

SEQ ID NO: 3 - protein, 21 aa, Araneus diadematus
SGCDVLVQALLEVVSALVSIL

SEQ ID NO: 4 - protein, 1154 aa, Artificial Sequence
  recombinant spider silk protein ADF3KaiLargeNRSH1
MHHHHHHHHHHSSGSSLEVLFQGPARAGSGQQGPGQQGPGQQGPGQQGPYGPGASAAAAAAGGYGPGSGQQGPSQQGPGQQGPGGQGPYGPGASAAAAAAGGYGPGSGQQGPGGQGPYGPGSSAAAAAAGGNGPGSGQQGAGQQGPGQQGPGASAAAAAAGGYGPGSGQQGPGQQGPGGQGPYGPGASAAAAAAGGYGPGSGQGPGQQGPGGQGPYGPGASAAAAAAGGYGPGSGQQGPGQQGPGQQGPGGQGPYGPGASAAAAAAGGYGPGYGQQGPGQQGPGGQGPYGPGASAASAASGGYGPGSGQQGPGQQGPGGQGPYGPGASAAAAAAGGYGPGSGQQGPGQQGPGQQGPGQQGPGGQGPYGPGASAAAAAAGGYGPGSGQQGPGQQGPGQQGPGQQGPGQQGPGQQGPGQQGPGQQGPGQQGPGGQGAYGPGASAAAGAAGGYGPGSGQQGPGQQGPGQQGPGQQGPGQQGPGQQGPGQQGPGQQGPYGPGASAAAAAAGGYGPGSGQQGPGQQGPGQQGPGGQGPYGPGAASAAVSVSRARAGSGQQGPGQQGPGQQGPGQQGPYGPGASAAAAAAGGYGPGSGQQGPSQQGPGQQGPGGQGPYGPGASAAAAAAGGYGPGSGQQGPGGQGPYGPGSSAAAAAAGGNGPGSGQQGAGQQGPGQQGPGASAAAAAAGGYGPGSGQQGPGQQGPGGQGPYGPGASAAAAAAGGYGPGSGQGPGQQGPGGQGPYGPGASAAAAAAGGYGPGSGQQGPGQQGPGQQGPGGQGPYGPGASAAAAAAGGYGPGYGQQGPGQQGPGGQGPYGPGASAASAASGGYGPGSGQQGPGQQGPGGQGPYGPGASAAAAAAGGYGPGSGQQGPGQQGPGQQGPGQQGPGGQGPYGPGASAAAAAAGGYGPGSGQQGPGQQGPGQQGPGQQGPGQQGPGQQGPGQQGPGQQGPGQQGPGGQGAYGPGASAAAGAAGGYGPGSGQQGPGQQGPGQQGPGQQGPGQQGPGQQGPGQQGPGQQGPYGPGASAAAAAAGGYGPGSGQQGPGQQGPGQQGPGGQGPYGPGAASAAVSVGGYGPQSSSVPVASAVASRLSSPAASSRVSSAVSSLVSSGPTKHAALSNTISSVVSQVSASNPGLSGCDVLVQALLEVVSALVSIL

SEQ ID NO: 5 - protein, 24 aa, Artificial Sequence
  His tag and start codon
MHHHHHHHHHHSSGSSLEVLFQGP

SEQ ID NO: 6 - protein, 597 aa, Artificial Sequence
  Met-PRT380
MGPGQQGPYGPGASAAAAAGQNGPGSGQQGPGQSAAAAAGQYGPGQQGPGQQGPGSSAAAAAGPGQYGPGQQGPSASAAAAAGPGSGQQGPGASAAAAAGQYGPGQQGPGQQGPGSSAAAAAGQYGSGPGQQGPYGSAAAAAGPGSGQYGQGPYGPGASAAAAAGPGQYGPGQQGPSASAAAAAGSGQQGPGQYGPYASAAAAAGQYGSGPGQQGPYGPGQSAAAAAGSGQQGPGQQGPYASAAAAAGPGQQGPYGPGSSAAAAAGQYGYGPGQQGPYGPGASAAAAAGQNGPGSGQYGPGQQGPGQSAAAAAGPGQQGPYGPGASAAAAAGQYGPGQQGPGQYGPGSSAAAAAGPGQQGPYGPGSSAAAAAGQYGPGQQGPYGPGQSAAAAAGQYQQGPGQQGPYGPGASAAAAAGPGQQGPYGPGASAAAAAGPGQYGPGQQGPSASAAAAAGQYGSGPGQYGPYGPGQSAAAAAGPGSGQQGQGPYGPGASAAAAAGQYGPGQQGPYGPGQSAAAAAGPGSGQYGPGASAAAAAGQNGPGSGQYGPGQQGPGQSAAAAAGQYQQGPGQQGPYGPGASAAAAAGPGSGQQGPGAS

SEQ ID NO: 7 - protein, 590 aa, Artificial Sequence
  Met-PRT410
MGPGQQGPYGPGASAAAAAGQNGPGSGQQGPGQSGQYGPGQQGPGQQGPGSSAAAAAGPGQYGPGQQGPSASAAAAAGPGSGQQGPGASGQYGPGQQGPGQQGPGSSAAAAAGQYGSGPGQQGPYGSAAAAAGPGSGQYGQGPYGPGASGPGQYGPGQQGPSASAAAAAGSGQQGPGQYGPYASAAAAAGQYGSGPGQQGPYGPGQSGSGQQGPGQQGPYASAAAAAGPGQQGPYGPGSSAAAAAGQYGYGPGQQGPYGPGASGQNGPGSGQYGPGQQGPGQSAAAAAGPGQQGPYGPGASAAAAAGQYGPGQQGPGQYGPGSSGPGQQGPYGPGSSAAAAAGQYGPGQQGPYGPGQSAAAAAGQYQQGPGQQGPYGPGASGPGQQGPYGPGASAAAAAGPGQYGPGQQGPSASAAAAAGQYGSGPGQYGPYGPGQSGPGSGQQGQGPYGPGASAAAAAGQYGPGQQGPYGPGQSAAAAAGPGSGQYGPGASGQNGPGSGQYGPGQQGPGQSAAAAAGQYQQGPGQQGPYGPGASAAAAAGQYGSGPGQQGPYGPGQSGSGQQGPGQQGPYASAAAAAGPGSGQQGPGAS

SEQ ID NO: 8 - protein, 565 aa, Artificial Sequence
  Met-PRT525
MGPGQQGPYGPGASAAAAAAAGSNGPGSGQQGPGQSGQYGPGQQGPGQQGPGSSAAAAAAAGPGQYGPGQQGPSASAAAAAAAGPGSGQQGPGASGQYGPGQQGPGQQGPGSSAAAAAAAGSYGSGPGQQGPYGSAAAAAAAGPGSGQYGQGPYGPGASGPGQYGPGQQGPSASAAAAAAAGSGQQGPGQYGPYASAAAAAAAGSYGSGPGQQGPYGPGQSGSGQQGPGQQGPYASAAAAAAAGPGQQGPYGPGSSAAAAAAAGSYGYGPGQQGPYGPGASGQNGPGSGQYGPGQQGPGPSAAAAAAAGPGQQGPYGPGASAAAAAAAGSYGPGQQGPGQYGPGSSGPGQQGPYGPGSSAAAAAAAGSYGPGQQGPYGPGPSAAAAAAAGSYQQGPGQQGPYGPGASGPGQQGPYGPGASAAAAAAAGPGQYGPGQQGPSASAAAAAAAGSYGSGPGQYGPYGPGQSGPGSGQQGQGPYGPGASAAAAAAAGSYGPGQQGPYGPGPSAAAAAAAGPGSGQYGPGASGQNGPGSGQYGPGQQGPGPSAAAAAAAGPGSGQQGPGAS

SEQ ID NO: 9 - protein, 2364 aa, Artificial Sequence
  Met-PRT799
MGPGQQGPYGPGASAAAAAGQNGPGSGQQGPGQSGQYGPGQQGPGQQGPGSSAAAAAGPGQYGPGQQGPSASAAAAAGPGSGQQGPGASGQYGPGQQGPGQQGPGSSAAAAAGQYGSGPGQQGPYGSAAAAAGPGSGQYGQGPYGPGASGPGQYGPGQQGPSASAAAAAGSGQQGPGQYGPYASAAAAAGQYGSGPGQQGPYGPGQSGSGQQGPGQQGPYASAAAAAGPGQQGPYGPGSSAAAAAGQYGYGPGQQGPYGPGASGQNGPGSGQYGPGQQGPGQSAAAAAGPGQQGPYGPGASAAAAAGQYGPGQQGPGQYGPGSSGPGQQGPYGPGSSAAAAAGQYGPGQQGPYGPGQSAAAAAGQYQQGPGQQGPYGPGASGPGQQGPYGPGASAAAAAGPGQYGPGQQGPSASAAAAAGQYGSGPGQYGPYGPGQSGPGSGQQGQGPYGPGASAAAAAGQYGPGQQGPYGPGQSAAAAAGPGSGQYGPGASGQNGPGSGQYGPGQQGPGQSAAAAAGQYQQGPGQQGPYGPGASAAAAAGQYGSGPGQQGPYGPGQSGSGQQGPGQQGPYASAAAAAGPGSGQQGPGASGQQGPYGPGASAAAAAGQNGPGSGQQGPGQSGQYGPGQQGPGQQGPGSSAAAAAGPGQYGPGQQGPSASAAAAAGPGSGQQGPGASGQYGPGQQGPGQQGPGSSAAAAAGQYGSGPGQQGPYGSAAAAAGPGSGQYGQGPYGPGASGPGQYGPGQQGPSASAAAAAGSGQQGPGQYGPYASAAAAAGQYGSGPGQQGPYGPGQSGSGQQGPGQQGPYASAAAAAGPGQQGPYGPGSSAAAAAGQYGYGPGQQGPYGPGASGQNGPGSGQYGPGQQGPGQSAAAAAGPGQQGPYGPGASAAAAAGQYGPGQQGPGQYGPGSSGPGQQGPYGPGSSAAAAAGQYGPGQQGPYGPGQSAAAAAGQYQQGPGQQGPYGPGASGPGQQGPYGPGASAAAAAGPGQYGPGQQGPSASAAAAAGQYGSGPGQYGPYGPGQSGPGSGQQGQGPYGPGASAAAAAGQYGPGQQGPYGPGQSAAAAAGPGSGQYGPGASGQNGPGSGQYGPGQQGPGQSAAAAAGQYQQGPGQQGPYGPGASAAAAAGQYGSGPGQQGPYGPGQSGSGQQGPGQQGPYASAAAAAGPGSGQQGPGASGQQGPYGPGASAAAAAGQNGPGSGQQGPGQSGQYGPGQQGPGQQGPGSSAAAAAGPGQYGPGQQGPSASAAAAAGPGSGQQGPGASGQYGPGQQGPGQQGPGSSAAAAAGQYGSGPGQQGPYGSAAAAAGPGSGQYGQGPYGPGASGPGQYGPGQQGPSASAAAAAGSGQQGPGQYGPYASAAAAAGQYGSGPGQQGPYGPGQSGSGQQGPGQQGPYASAAAAAGPGQQGPYGPGSSAAAAAGQYGYGPGQQGPYGPGASGQNGPGSGQYGPGQQGPGQSAAAAAGPGQQGPYGPGASAAAAAGQYGPGQQGPGQYGPGSSGPGQQGPYGPGSSAAAAAGQYGPGQQGPYGPGQSAAAAAGQYQQGPGQQGPYGPGASGPGQQGPYGPGASAAAAAGPGQYGPGQQGPSASAAAAAGQYGSGPGQYGPYGPGQSGPGSGQQGQGPYGPGASAAAAAGQYGPGQQGPYGPGQSAAAAAGPGSGQYGPGASGQNGPGSGQYGPGQQGPGQSAAAAAGQYQQGPGQQGPYGPGASAAAAAGQYGSGPGQQGPYGPGQSGSGQQGPGQQGPYASAAAAAGPGSGQQGPGASGQQGPYGPGASAAAAAGQNGPGSGQQGPGQSGQYGPGQQGPGQQGPGSSAAAAAGPGQYGPGQQGPSASAAAAAGPGSGQQGPGASGQYGPGQQGPGQQGPGSSAAAAAGQYGSGPGQQGPYGSAAAAAGPGSGQYGQGPYGPGASGPGQYGPGQQGPSASAAAAAGSGQQGPGQYGPYASAAAAAGQYGSGPGQQGPYGPGQSGSGQQGPGQQGPYASAAAAAGPGQQGPYGPGSSAAAAAGQYGYGPGQQGPYGPGASGQNGPGSGQYGPGQQGPGQSAAAAAGPGQQGPYGPGASAAAAAGQYGPGQQGPGQYGPGSSGPGQQGPYGPGSSAAAAAGQYGPGQQGPYGPGQSAAAAAGQYQQGPGQQGPYGPGASGPGQQGPYGPGASAAAAAGPGQYGPGQQGPSASAAAAAGQYGSGPGQYGPYGPGQSGPGSGQQGQGPYGPGASAAAAAGQYGPGQQGPYGPGQSAAAAAGPGSGQYGPGASGQNGPGSGQYGPGQQGPGQSAAAAAGQYQQGPGQQGPYGPGASAAAAAGQYGSGPGQQGPYGPGQSGSGQQGPGQQGPYASAAAAAGPGSGQQGSSVDKLAAALEHHHHHH

SEQ ID NO: 10 - protein, 597 aa, Artificial Sequence
  Met-PRT313
MGPGGQGPYGPGASAAAAAGGNGPGSGQQGPGGSAAAAAGGYGPGGQGPGQQGPGSSAAAAAGPGGYGPGGQGPSASAAAAAGPGSGQQGPGASAAAAAGGYGPGGQGPGQQGPGSSAAAAAGGYGSGPGQQGPYGSAAAAAGPGSGGYGQGPYGPGASAAAAAGPGGYGPGGQGPSASAAAAAGSGQQGPGGYGPYASAAAAAGGYGSGPGQQGPYGPGGSAAAAAGSGQQGPGQQGPYASAAAAAGPGGQGPYGPGSSAAAAAGGYGYGPGGQGPYGPGASAAAAAGGNGPGSGGYGPGQQGPGGSAAAAAGPGGQGPYGPGASAAAAAGGYGPGGQGPGGYGPGSSAAAAAGPGGQGPYGPGSSAAAAAGGYGPGQQGPYGPGGSAAAAAGGYQQGPGGQGPYGPGASAAAAAGPGGQGPYGPGASAAAAAGPGGYGPGGQGPSASAAAAAGGYGSGPGGYGPYGPGGSAAAAAGPGSGQQGQGPYGPGASAAAAAGGYGPGQQGPYGPGGSAAAAAGPGSGGYGPGASAAAAAGGNGPGSGGYGPGQQGPGGSAAAAAGGYQQGPGGQGPYGPGASAAAAAGPGSGQQGPGAS

SEQ ID NO: 11 - protein, 12 aa, Artificial Sequence
  HisTag
MHHHHHHSSGSS

SEQ ID NO: 12 - protein, 608 aa, Artificial Sequence
  PRT380
MHHHHHHSSGSSGPGQQGPYGPGASAAAAAGQNGPGSGQQGPGQSAAAAAGQYGPGQQGPGQQGPGSSAAAAAGPGQYGPGQQGPSASAAAAAGPGSGQQGPGASAAAAAGQYGPGQQGPGQQGPGSSAAAAAGQYGSGPGQQGPYGSAAAAAGPGSGQYGQGPYGPGASAAAAAGPGQYGPGQQGPSASAAAAAGSGQQGPGQYGPYASAAAAAGQYGSGPGQQGPYGPGQSAAAAAGSGQQGPGQQGPYASAAAAAGPGQQGPYGPGSSAAAAAGQYGYGPGQQGPYGPGASAAAAAGQNGPGSGQYGPGQQGPGQSAAAAAGPGQQGPYGPGASAAAAAGQYGPGQQGPGQYGPGSSAAAAAGPGQQGPYGPGSSAAAAAGQYGPGQQGPYGPGQSAAAAAGQYQQGPGQQGPYGPGASAAAAAGPGQQGPYGPGASAAAAAGPGQYGPGQQGPSASAAAAAGQYGSGPGQYGPYGPGQSAAAAAGPGSGQQGQGPYGPGASAAAAAGQYGPGQQGPYGPGQSAAAAAGPGSGQYGPGASAAAAAGQNGPGSGQYGPGQQGPGQSAAAAAGQYQQGPGQQGPYGPGASAAAAAGPGSGQQGPGAS

SEQ ID NO: 13 - protein, 601 aa, Artificial Sequence
  PRT410
MHHHHHHSSGSSGPGQQGPYGPGASAAAAAGQNGPGSGQQGPGQSGQYGPGQQGPGQQGPGSSAAAAAGPGQYGPGQQGPSASAAAAAGPGSGQQGPGASGQYGPGQQGPGQQGPGSSAAAAAGQYGSGPGQQGPYGSAAAAAGPGSGQYGQGPYGPGASGPGQYGPGQQGPSASAAAAAGSGQQGPGQYGPYASAAAAAGQYGSGPGQQGPYGPGQSGSGQQGPGQQGPYASAAAAAGPGQQGPYGPGSSAAAAAGQYGYGPGQQGPYGPGASGQNGPGSGQYGPGQQGPGQSAAAAAGPGQQGPYGPGASAAAAAGQYGPGQQGPGQYGPGSSGPGQQGPYGPGSSAAAAAGQYGPGQQGPYGPGQSAAAAAGQYQQGPGQQGPYGPGASGPGQQGPYGPGASAAAAAGPGQYGPGQQGPSASAAAAAGQYGSGPGQYGPYGPGQSGPGSGQQGQGPYGPGASAAAAAGQYGPGQQGPYGPGQSAAAAAGPGSGQYGPGASGQNGPGSGQYGPGQQGPGQSAAAAAGQYQQGPGQQGPYGPGASAAAAAGQYGSGPGQQGPYGPGQSGSGQQGPGQQGPYASAAAAAGPGSGQQGPGAS

SEQ ID NO: 14 - protein, 576 aa, Artificial Sequence
  PRT525
MHHHHHHSSGSSGPGQQGPYGPGASAAAAAAAGSNGPGSGQQGPGQSGQYGPGQQGPGQQGPGSSAAAAAAAGPGQYGPGQQGPSASAAAAAAAGPGSGQQGPGASGQYGPGQQGPGQQGPGSSAAAAAAAGSYGSGPGQQGPYGSAAAAAAAGPGSGQYGQGPYGPGASGPGQYGPGQQGPSASAAAAAAAGSGQQGPGQYGPYASAAAAAAAGSYGSGPGQQGPYGPGQSGSGQQGPGQQGPYASAAAAAAAGPGQQGPYGPGSSAAAAAAAGSYGYGPGQQGPYGPGASGQNGPGSGQYGPGQQGPGPSAAAAAAAGPGQQGPYGPGASAAAAAAAGSYGPGQQGPGQYGPGSSGPGQQGPYGPGSSAAAAAAAGSYGPGQQGPYGPGPSAAAAAAAGSYQQGPGQQGPYGPGASGPGQQGPYGPGASAAAAAAAGPGQYGPGQQGPSASAAAAAAAGSYGSGPGQYGPYGPGQSGPGSGQQGQGPYGPGASAAAAAAAGSYGPGQQGPYGPGPSAAAAAAAGPGSGQYGPGASGQNGPGSGQYGPGQQGPGPSAAAAAAAGPGSGQQGPGAS

SEQ ID NO: 15 - protein, 2375 aa, Artificial Sequence
  PRT799
MHHHHHHSSGSSGPGQQGPYGPGASAAAAAGQNGPGSGQQGPGQSGQYGPGQQGPGQQGPGSSAAAAAGPGQYGPGQQGPSASAAAAAGPGSGQQGPGASGQYGPGQQGPGQQGPGSSAAAAAGQYGSGPGQQGPYGSAAAAAGPGSGQYGQGPYGPGASGPGQYGPGQQGPSASAAAAAGSGQQGPGQYGPYASAAAAAGQYGSGPGQQGPYGPGQSGSGQQGPGQQGPYASAAAAAGPGQQGPYGPGSSAAAAAGQYGYGPGQQGPYGPGASGQNGPGSGQYGPGQQGPGQSAAAAAGPGQQGPYGPGASAAAAAGQYGPGQQGPGQYGPGSSGPGQQGPYGPGSSAAAAAGQYGPGQQGPYGPGQSAAAAAGQYQQGPGQQGPYGPGASGPGQQGPYGPGASAAAAAGPGQYGPGQQGPSASAAAAAGQYGSGPGQYGPYGPGQSGPGSGQQGQGPYGPGASAAAAAGQYGPGQQGPYGPGQSAAAAAGPGSGQYGPGASGQNGPGSGQYGPGQQGPGQSAAAAAGQYQQGPGQQGPYGPGASAAAAAGQYGSGPGQQGPYGPGQSGSGQQGPGQQGPYASAAAAAGPGSGQQGPGASGQQGPYGPGASAAAAAGQNGPGSGQQGPGQSGQYGPGQQGPGQQGPGSSAAAAAGPGQYGPGQQGPSASAAAAAGPGSGQQGPGASGQYGPGQQGPGQQGPGSSAAAAAGQYGSGPGQQGPYGSAAAAAGPGSGQYGQGPYGPGASGPGQYGPGQQGPSASAAAAAGSGQQGPGQYGPYASAAAAAGQYGSGPGQQGPYGPGQSGSGQQGPGQQGPYASAAAAAGPGQQGPYGPGSSAAAAAGQYGYGPGQQGPYGPGASGQNGPGSGQYGPGQQGPGQSAAAAAGPGQQGPYGPGASAAAAAGQYGPGQQGPGQYGPGSSGPGQQGPYGPGSSAAAAAGQYGPGQQGPYGPGQSAAAAAGQYQQGPGQQGPYGPGASGPGQQGPYGPGASAAAAAGPGQYGPGQQGPSASAAAAAGQYGSGPGQYGPYGPGQSGPGSGQQGQGPYGPGASAAAAAGQYGPGQQGPYGPGQSAAAAAGPGSGQYGPGASGQNGPGSGQYGPGQQGPGQSAAAAAGQYQQGPGQQGPYGPGASAAAAAGQYGSGPGQQGPYGPGQSGSGQQGPGQQGPYASAAAAAGPGSGQQGPGASGQQGPYGPGASAAAAAGQNGPGSGQQGPGQSGQYGPGQQGPGQQGPGSSAAAAAGPGQYGPGQQGPSASAAAAAGPGSGQQGPGASGQYGPGQQGPGQQGPGSSAAAAAGQYGSGPGQQGPYGSAAAAAGPGSGQYGQGPYGPGASGPGQYGPGQQGPSASAAAAAGSGQQGPGQYGPYASAAAAAGQYGSGPGQQGPYGPGQSGSGQQGPGQQGPYASAAAAAGPGQQGPYGPGSSAAAAAGQYGYGPGQQGPYGPGASGQNGPGSGQYGPGQQGPGQSAAAAAGPGQQGPYGPGASAAAAAGQYGPGQQGPGQYGPGSSGPGQQGPYGPGSSAAAAAGQYGPGQQGPYGPGQSAAAAAGQYQQGPGQQGPYGPGASGPGQQGPYGPGASAAAAAGPGQYGPGQQGPSASAAAAAGQYGSGPGQYGPYGPGQSGPGSGQQGQGPYGPGASAAAAAGQYGPGQQGPYGPGQSAAAAAGPGSGQYGPGASGQNGPGSGQYGPGQQGPGQSAAAAAGQYQQGPGQQGPYGPGASAAAAAGQYGSGPGQQGPYGPGQSGSGQQGPGQQGPYASAAAAAGPGSGQQGPGASGQQGPYGPGASAAAAAGQNGPGSGQQGPGQSGQYGPGQQGPGQQGPGSSAAAAAGPGQYGPGQQGPSASAAAAAGPGSGQQGPGASGQYGPGQQGPGQQGPGSSAAAAAGQYGSGPGQQGPYGSAAAAAGPGSGQYGQGPYGPGASGPGQYGPGQQGPSASAAAAAGSGQQGPGQYGPYASAAAAAGQYGSGPGQQGPYGPGQSGSGQQGPGQQGPYASAAAAAGPGQQGPYGPGSSAAAAAGQYGYGPGQQGPYGPGASGQNGPGSGQYGPGQQGPGQSAAAAAGPGQQGPYGPGASAAAAAGQYGPGQQGPGQYGPGSSGPGQQGPYGPGSSAAAAAGQYGPGQQGPYGPGQSAAAAAGQYQQGPGQQGPYGPGASGPGQQGPYGPGASAAAAAGPGQYGPGQQGPSASAAAAAGQYGSGPGQYGPYGPGQSGPGSGQQGQGPYGPGASAAAAAGQYGPGQQGPYGPGQSAAAAAGPGSGQYGPGASGQNGPGSGQYGPGQQGPGQSAAAAAGQYQQGPGQQGPYGPGASAAAAAGQYGSGPGQQGPYGPGQSGSGQQGPGQQGPYASAAAAAGPGSGQQGSSVDKLAAALEHHHHHH

SEQ ID NO: 16 - protein, 608 aa, Artificial Sequence
  PRT313
MHHHHHHSSGSSGPGGQGPYGPGASAAAAAGGNGPGSGQQGPGGSAAAAAGGYGPGGQGPGQQGPGSSAAAAAGPGGYGPGGQGPSASAAAAAGPGSGQQGPGASAAAAAGGYGPGGQGPGQQGPGSSAAAAAGGYGSGPGQQGPYGSAAAAAGPGSGGYGQGPYGPGASAAAAAGPGGYGPGGQGPSASAAAAAGSGQQGPGGYGPYASAAAAAGGYGSGPGQQGPYGPGGSAAAAAGSGQQGPGQQGPYASAAAAAGPGGQGPYGPGSSAAAAAGGYGYGPGGQGPYGPGASAAAAAGGNGPGSGGYGPGQQGPGGSAAAAAGPGGQGPYGPGASAAAAAGGYGPGGQGPGGYGPGSSAAAAAGPGGQGPYGPGSSAAAAAGGYGPGQQGPYGPGGSAAAAAGGYQQGPGGQGPYGPGASAAAAAGPGGQGPYGPGASAAAAAGPGGYGPGGQGPSASAAAAAGGYGSGPGGYGPYGPGGSAAAAAGPGSGQQGQGPYGPGASAAAAAGGYGPGQQGPYGPGGSAAAAAGPGSGGYGPGASAAAAAGGNGPGSGGYGPGQQGPGGSAAAAAGGYQQGPGGQGPYGPGASAAAAAGPGSGQQGPGAS

SEQ ID NO: 17 - protein, 590 aa, Artificial Sequence
  Met-PRT399
MGPGGQGPYGPGASAAAAAGGNGPGSGQQGPGGSGGYGPGGQGPGQQGPGSSAAAAAGPGGYGPGGQGPSASAAAAAGPGSGQQGPGASGGYGPGGQGPGQQGPGSSAAAAAGGYGSGPGQQGPYGSAAAAAGPGSGGYGQGPYGPGASGPGGYGPGGQGPSASAAAAAGSGQQGPGGYGPYASAAAAAGGYGSGPGQQGPYGPGGSGSGQQGPGQQGPYASAAAAAGPGGQGPYGPGSSAAAAAGGYGYGPGGQGPYGPGASGGNGPGSGGYGPGQQGPGGSAAAAAGPGGQGPYGPGASAAAAAGGYGPGGQGPGGYGPGSSGPGGQGPYGPGSSAAAAAGGYGPGQQGPYGPGGSAAAAAGGYQQGPGGQGPYGPGASGPGGQGPYGPGASAAAAAGPGGYGPGGQGPSASAAAAAGGYGSGPGGYGPYGPGGSGPGSGQQGQGPYGPGASAAAAAGGYGPGQQGPYGPGGSAAAAAGPGSGGYGPGASGGNGPGSGGYGPGQQGPGGSAAAAAGGYQQGPGGQGPYGPGASAAAAAGGYGSGPGQQGPYGPGGSGSGQQGPGQQGPYASAAAAAGPGSGQQGPGAS

SEQ ID NO: 18 - protein, 601 aa, Artificial Sequence
  PRT399
MHHHHHHSSGSSGPGGQGPYGPGASAAAAAGGNGPGSGQQGPGGSGGYGPGGQGPGQQGPGSSAAAAAGPGGYGPGGQGPSASAAAAAGPGSGQQGPGASGGYGPGGQGPGQQGPGSSAAAAAGGYGSGPGQQGPYGSAAAAAGPGSGGYGQGPYGPGASGPGGYGPGGQGPSASAAAAAGSGQQGPGGYGPYASAAAAAGGYGSGPGQQGPYGPGGSGSGQQGPGQQGPYASAAAAAGPGGQGPYGPGSSAAAAAGGYGYGPGGQGPYGPGASGGNGPGSGGYGPGQQGPGGSAAAAAGPGGQGPYGPGASAAAAAGGYGPGGQGPGGYGPGSSGPGGQGPYGPGSSAAAAAGGYGPGQQGPYGPGGSAAAAAGGYQQGPGGQGPYGPGASGPGGQGPYGPGASAAAAAGPGGYGPGGQGPSASAAAAAGGYGSGPGGYGPYGPGGSGPGSGQQGQGPYGPGASAAAAAGGYGPGQQGPYGPGGSAAAAAGPGSGGYGPGASGGNGPGSGGYGPGQQGPGGSAAAAAGGYQQGPGGQGPYGPGASAAAAAGGYGSGPGQQGPYGPGGSGSGQQGPGQQGPYASAAAAAGPGSGQQGPGAS

SEQ ID NO: 19 - protein, 612 aa, Artificial Sequence
  Met-PRT720
MGPGQQGPYGPGASAAAAAGQNGPGSGQQGPGQSGQYGPGQQGPGQQGPGSSAAAAAGPGQYVLIGPGQQVLIGPSASAAAAAGPGSGQQGPGASGQYGPGQQGPGQQGPGSSAAAAAGSYGSVLIGPGQQVLIGPYGSAAAAAGPGSGQYGQGPYGPGASGPGQYGPGQQGPSASAAAAAGSGQQVLIGPGQYVLIGPYASAAAAAGQYGSGPGQQGPYGPGQSGSGQQGPGQQGPYASAAAAAGPGQQVLIGPYVLIGPGSSAAAAAGQYGYGPGQQGPYGPGASGQNGPGSGQYGPGQQGPGQSAAAAAGPGQQVLIGPYVLIGPGASAAAAAGQYGPGQQGPGQYGPGSSGPGQQGPYGPGSSAAAAAGSYGPGQQVLIGPYVLIGPGPSAAAAAGQYQQGPGQQGPYGPGASGPGQQGPYGPGASAAAAAGPGQYVLIGPGQQVLIGPSASAAAAAGQYGSGPGQYGPYGPGQSGPGSGQQGQGPYGPGASAAAAAGSYGPGQQVLIGPYVLIGPGPSAAAAAGPGSGQYGPGASGQNGPGSGQYGPGQQGPGQSAAAAAGQYQQVLIGPGQQGPYVLIGPGASAAAAAGPGSGQQVLIGPGASVLI

SEQ ID NO: 20 - protein, 592 aa, Artificial Sequence
  Met-PRT665
MGPGQQGPYGPGASAAAAAAAGSNGPGSGQQGPGQSGQYGPGQQGPGQQGPGSSAAAAAAAGPGQYVLIGPGQQGPSASAAAAAAAGPGSGQQGPGASGQYGPGQQGPGQQGPGSSAAAAAAAGSYGSVLIGPGQQGPYGSAAAAAAAGPGSGQYGQGPYGPGASGPGQYGPGQQGPSASAAAAAAAGSGQQVLIGPGQYGPYASAAAAAAAGSYGSGPGQQGPYGPGQSGSGQQGPGQQGPYASAAAAAAAGPGQQVLIGPYGPGSSAAAAAAAGSYGYGPGQQGPYGPGASGQNGPGSGQYGPGQQGPGPSAAAAAAAGPGQQVLIGPYGPGASAAAAAAAGSYGPGQQGPGQYGPGSSGPGQQGPYGPGSSAAAAAAAGSYGPGQQVLIGPYGPGPSAAAAAAAGSYQQGPGQQGPYGPGASGPGQQGPYGPGASAAAAAAAGPGQYVLIGPGQQGPSASAAAAAAAGSYGSGPGQYGPYGPGQSGPGSGQQGQGPYGPGASAAAAAAAGSYGPGQQVLIGPYGPGPSAAAAAAAGPGSGQYGPGASGQNGPGSGQYGPGQQGPGPSAAAAAAAGPGSGQQGPGASVLI

SEQ ID NO: 21 - protein, 619 aa, Artificial Sequence
  Met-PRT666
MGPGQQGPYGPGASAAAAAAAGSNGPGSGQQGPGQSGQYGPGQQGPGQQGPGSSAAAAAAAGPGQYVLIGPGQQVLIGPSASAAAAAAAGPGSGQQGPGASGQYGPGQQGPGQQGPGSSAAAAAAAGSYGSVLIGPGQQVLIGPYGSAAAAAAAGPGSGQYGQGPYGPGASGPGQYGPGQQGPSASAAAAAAAGSGQQVLIGPGQYVLIGPYASAAAAAAAGSYGSGPGQQGPYGPGQSGSGQQGPGQQGPYASAAAAAAAGPGQQVLIGPYVLIGPGSSAAAAAAAGSYGYGPGQQGPYGPGASGQNGPGSGQYGPGQQGPGPSAAAAAAAGPGQQVLIGPYVLIGPGASAAAAAAAGSYGPGQQGPGQYGPGSSGPGQQGPYGPGSSAAAAAAAGSYGPGQQVLIGPYVLIGPGPSAAAAAAAGSYQQGPGQQGPYGPGASGPGQQGPYGPGASAAAAAAAGPGQYVLIGPGQQVLIGPSASAAAAAAAGSYGSGPGQYGPYGPGQSGPGSGQQGQGPYGPGASAAAAAAAGSYGPGQQVLIGPYVLIGPGPSAAAAAAAGPGSGQYGPGASGQNGPGSGQYGPGQQGPGPSAAAAAAAGPGSGQQVLIGPGASVLI

SEQ ID NO: 22 - protein, 623 aa, Artificial Sequence
  PRT720
MHHHHHHSSGSSGPGQQGPYGPGASAAAAAGQNGPGSGQQGPGQSGQYGPGQQGPGQQGPGSSAAAAAGPGQYVLIGPGQQVLIGPSASAAAAAGPGSGQQGPGASGQYGPGQQGPGQQGPGSSAAAAAGSYGSVLIGPGQQVLIGPYGSAAAAAGPGSGQYGQGPYGPGASGPGQYGPGQQGPSASAAAAAGSGQQVLIGPGQYVLIGPYASAAAAAGQYGSGPGQQGPYGPGQSGSGQQGPGQQGPYASAAAAAGPGQQVLIGPYVLIGPGSSAAAAAGQYGYGPGQQGPYGPGASGQNGPGSGQYGPGQQGPGQSAAAAAGPGQQVLIGPYVLIGPGASAAAAAGQYGPGQQGPGQYGPGSSGPGQQGPYGPGSSAAAAAGSYGPGQQVLIGPYVLIGPGPSAAAAAGQYQQGPGQQGPYGPGASGPGQQGPYGPGASAAAAAGPGQYVLIGPGQQVLIGPSASAAAAAGQYGSGPGQYGPYGPGQSGPGSGQQGQGPYGPGASAAAAAGSYGPGQQVLIGPYVLIGPGPSAAAAAGPGSGQYGPGASGQNGPGSGQYGPGQQGPGQSAAAAAGQYQQVLIGPGQQGPYVLIGPGASAAAAAGPGSGQQVLIGPGASVLI

SEQ ID NO: 23 - protein, 603 aa, Artificial Sequence
  PRT665
MHHHHHHSSGSSGPGQQGPYGPGASAAAAAAAGSNGPGSGQQGPGQSGQYGPGQQGPGQQGPGSSAAAAAAAGPGQYVLIGPGQQGPSASAAAAAAAGPGSGQQGPGASGQYGPGQQGPGQQGPGSSAAAAAAAGSYGSVLIGPGQQGPYGSAAAAAAAGPGSGQYGQGPYGPGASGPGQYGPGQQGPSASAAAAAAAGSGQQVLIGPGQYGPYASAAAAAAAGSYGSGPGQQGPYGPGQSGSGQQGPGQQGPYASAAAAAAAGPGQQVLIGPYGPGSSAAAAAAAGSYGYGPGQQGPYGPGASGQNGPGSGQYGPGQQGPGPSAAAAAAAGPGQQVLIGPYGPGASAAAAAAAGSYGPGQQGPGQYGPGSSGPGQQGPYGPGSSAAAAAAAGSYGPGQQVLIGPYGPGPSAAAAAAAGSYQQGPGQQGPYGPGASGPGQQGPYGPGASAAAAAAAGPGQYVLIGPGQQGPSASAAAAAAAGSYGSGPGQYGPYGPGQSGPGSGQQGQGPYGPGASAAAAAAAGSYGPGQQVLIGPYGPGPSAAAAAAAGPGSGQYGPGASGQNGPGSGQYGPGQQGPGPSAAAAAAAGPGSGQQGPGASVLI

SEQ ID NO: 24 - protein, 630 aa, Artificial Sequence
  PRT666
MHHHHHHSSGSSGPGQQGPYGPGASAAAAAAAGSNGPGSGQQGPGQSGQYGPGQQGPGQQGPGSSAAAAAAAGPGQYVLIGPGQQVLIGPSASAAAAAAAGPGSGQQGPGASGQYGPGQQGPGQQGPGSSAAAAAAAGSYGSVLIGPGQQVLIGPYGSAAAAAAAGPGSGQYGQGPYGPGASGPGQYGPGQQGPSASAAAAAAAGSGQQVLIGPGQYVLIGPYASAAAAAAAGSYGSGPGQQGPYGPGQSGSGQQGPGQQGPYASAAAAAAAGPGQQVLIGPYVLIGPGSSAAAAAAAGSYGYGPGQQGPYGPGASGQNGPGSGQYGPGQQGPGPSAAAAAAAGPGQQVLIGPYVLIGPGASAAAAAAAGSYGPGQQGPGQYGPGSSGPGQQGPYGPGSSAAAAAAAGSYGPGQQVLIGPYVLIGPGPSAAAAAAAGSYQQGPGQQGPYGPGASGPGQQGPYGPGASAAAAAAAGPGQYVLIGPGQQVLIGPSASAAAAAAAGSYGSGPGQYGPYGPGQSGPGSGQQGQGPYGPGASAAAAAAAGSYGPGQQVLIGPYVLIGPGPSAAAAAAAGPGSGQYGPGASGQNGPGSGQYGPGQQGPGPSAAAAAAAGPGSGQQVLIGPGASVLI

SEQ ID NO: 25 - protein, 593 aa, Artificial Sequence
  Met-PRT888
MGSSGPGVLGPYGPGASAAAAAGQNGPGSGVLGPGQSGQYGPGVLGPGVLGPGSSAAAAAGPGQYGPGVLGPSASAAAAAGPGSGVLGPGASGQYGPGVLGPGVLGPGSSAAAAAGQYGSGPGVLGPYGSAAAAAGPGSGQYGQGPYGPGASGPGQYGPGVLGPSASAAAAAGSGVLGPGQYGPYASAAAAAGQYGSGPGVLGPYGPGQSGSGVLGPGVLGPYASAAAAAGPGVLGPYGPGSSAAAAAGQYGYGPGVLGPYGPGASGQNGPGSGQYGPGVLGPGQSAAAAAGPGVLGPYGPGASAAAAAGQYGPGVLGPGQYGPGSSGPGVLGPYGPGSSAAAAAGQYGPGVLGPYGPGQSAAAAAGQYVLGPGVLGPYGPGASGPGVLGPYGPGASAAAAAGPGQYGPGVLGPSASAAAAAGQYGSGPGQYGPYGPGQSGPGSGVLGQGPYGPGASAAAAAGQYGPGVLGPYGPGQSAAAAAGPGSGQYGPGASGQNGPGSGQYGPGVLGPGQSAAAAAGQYVLGPGVLGPYGPGASAAAAAGQYGSGPGVLGPYGPGQSGSGVLGPGVLGPYASAAAAAGPGSGVLGPGAS

SEQ ID NO: 26 - protein, 590 aa, Artificial Sequence
  Met-PRT965
MGPGTSGPYGPGASAAAAAGANGPGSGTSGPGASGAYGPGTSGPGTSGPGSSAAAAAGPGAYGPGTSGPSASAAAAAGPGSGTSGPGASGAYGPGTSGPGTSGPGSSAAAAAGAYGSGPGTSGPYGSAAAAAGPGSGAYGAGPYGPGASGPGAYGPGTSGPSASAAAAAGSGTSGPGAYGPYASAAAAAGAYGSGPGTSGPYGPGASGSGTSGPGTSGPYASAAAAAGPGTSGPYGPGSSAAAAAGAYGYGPGTSGPYGPGASGANGPGSGAYGPGTSGPGASAAAAAGPGTSGPYGPGASAAAAAGAYGPGTSGPGAYGPGSSGPGTSGPYGPGSSAAAAAGAYGPGTSGPYGPGASAAAAAGAYTSGPGTSGPYGPGASGPGTSGPYGPGASAAAAAGPGAYGPGTSGPSASAAAAAGAYGSGPGAYGPYGPGASGPGSGTSGAGPYGPGASAAAAAGAYGPGTSGPYGPGASAAAAAGPGSGAYGPGASGANGPGSGAYGPGTSGPGASAAAAAGAYTSGPGTSGPYGPGASAAAAAGAYGSGPGTSGPYGPGASGSGTSGPGTSGPYASAAAAAGPGSGTSGPGAS

SEQ ID NO: 27 - protein, 593 aa, Artificial Sequence
  Met-PRT889
MGSSGPGVLGPYGPGASAAAAAGINGPGSGVLGPGISGIYGPGVLGPGVLGPGSSAAAAAGPGIYGPGVLGPSASAAAAAGPGSGVLGPGASGIYGPGVLGPGVLGPGSSAAAAAGIYGSGPGVLGPYGSAAAAAGPGSGIYGIGPYGPGASGPGIYGPGVLGPSASAAAAAGSGVLGPGIYGPYASAAAAAGIYGSGPGVLGPYGPGISGSGVLGPGVLGPYASAAAAAGPGVLGPYGPGSSAAAAAGIYGYGPGVLGPYGPGASGINGPGSGIYGPGVLGPGISAAAAAGPGVLGPYGPGASAAAAAGIYGPGVLGPGIYGPGSSGPGVLGPYGPGSSAAAAAGIYGPGVLGPYGPGISAAAAAGIYVLGPGVLGPYGPGASGPGVLGPYGPGASAAAAAGPGIYGPGVLGPSASAAAAAGIYGSGPGIYGPYGPGISGPGSGVLGIGPYGPGASAAAAAGIYGPGVLGPYGPGISAAAAAGPGSGIYGPGASGINGPGSGIYGPGVLGPGISAAAAAGIYVLGPGVLGPYGPGASAAAAAGIYGSGPGVLGPYGPGISGSGVLGPGVLGPYASAAAAAGPGSGVLGPGAS

SEQ ID NO: 28 - protein, 590 aa, Artificial Sequence
  Met-PRT916
MGPGVIGPYGPGASAAAAAGLNGPGSGVIGPGLSGLYGPGVIGPGVIGPGSSAAAAAGPGLYGPGVIGPSASAAAAAGPGSGVIGPGASGLYGPGVIGPGVIGPGSSAAAAAGLYGSGPGVIGPYGSAAAAAGPGSGLYGLGPYGPGASGPGLYGPGVIGPSASAAAAAGSGVIGPGLYGPYASAAAAAGLYGSGPGVIGPYGPGLSGSGVIGPGVIGPYASAAAAAGPGVIGPYGPGSSAAAAAGLYGYGPGVIGPYGPGASGLNGPGSGLYGPGVIGPGLSAAAAAGPGVIGPYGPGASAAAAAGLYGPGVIGPGLYGPGSSGPGVIGPYGPGSSAAAAAGLYGPGVIGPYGPGLSAAAAAGLYVIGPGVIGPYGPGASGPGVIGPYGPGASAAAAAGPGLYGPGVIGPSASAAAAAGLYGSGPGLYGPYGPGLSGPGSGVIGLGPYGPGASAAAAAGLYGPGVIGPYGPGLSAAAAAGPGSGLYGPGASGLNGPGSGLYGPGVIGPGLSAAAAAGLYVIGPGVIGPYGPGASAAAAAGLYGSGPGVIGPYGPGLSGSGVIGPGVIGPYASAAAAAGPGSGVIGPGAS

SEQ ID NO: 29 - protein, 590 aa, Artificial Sequence
  Met-PRT918
MGPGVFGPYGPGASAAAAAGINGPGSGVFGPGISGIYGPGVFGPGVFGPGSSAAAAAGPGIYGPGVFGPSASAAAAAGPGSGVFGPGASGIYGPGVFGPGVFGPGSSAAAAAGIYGSGPGVFGPYGSAAAAAGPGSGIYGIGPYGPGASGPGIYGPGVFGPSASAAAAAGSGVFGPGIYGPYASAAAAAGIYGSGPGVFGPYGPGISGSGVFGPGVFGPYASAAAAAGPGVFGPYGPGSSAAAAAGIYGYGPGVFGPYGPGASGINGPGSGIYGPGVFGPGISAAAAAGPGVFGPYGPGASAAAAAGIYGPGVFGPGIYGPGSSGPGVFGPYGPGSSAAAAAGIYGPGVFGPYGPGISAAAAAGIYVFGPGVFGPYGPGASGPGVFGPYGPGASAAAAAGPGIYGPGVFGPSASAAAAAGIYGSGPGIYGPYGPGISGPGSGVFGIGPYGPGASAAAAAGIYGPGVFGPYGPGISAAAAAGPGSGIYGPGASGINGPGSGIYGPGVFGPGISAAAAAGIYVFGPGVFGPYGPGASAAAAAGIYGSGPGVFGPYGPGISGSGVFGPGVFGPYASAAAAAGPGSGVFGPGAS

SEQ ID NO: 30 - protein, 565 aa, Artificial Sequence
  Met-PRT699
MGPGVLGPYGPGASAAAAAAAGSNGPGSGVLGPGQSGQYGPGVLGPGVLGPGSSAAAAAAAGPGQYGPGVLGPSASAAAAAAAGPGSGVLGPGASGQYGPGVLGPGVLGPGSSAAAAAAAGSYGSGPGVLGPYGSAAAAAAAGPGSGQYGQGPYGPGASGPGQYGPGVLGPSASAAAAAAAGSGVLGPGQYGPYASAAAAAAAGSYGSGPGVLGPYGPGQSGSGVLGPGVLGPYASAAAAAAAGPGVLGPYGPGSSAAAAAAAGSYGYGPGVLGPYGPGASGQNGPGSGQYGPGVLGPGPSAAAAAAAGPGVLGPYGPGASAAAAAAAGSYGPGVLGPGQYGPGSSGPGVLGPYGPGSSAAAAAAAGSYGPGVLGPYGPGPSAAAAAAAGSYVLGPGVLGPYGPGASGPGVLGPYGPGASAAAAAAAGPGQYGPGVLGPSASAAAAAAAGSYGSGPGQYGPYGPGQSGPGSGVLGQGPYGPGASAAAAAAAGSYGPGVLGPYGPGPSAAAAAAAGPGSGQYGPGASGQNGPGSGQYGPGVLGPGPSAAAAAAAGPGSGVLGPGAS

SEQ ID NO: 31 - protein, 565 aa, Artificial Sequence
  Met-PRT698
MGPGVLGPYGPGASAAAAAAAGSNGPGSGVLGPGISGIYGPGVLGPGVLGPGSSAAAAAAAGPGIYGPGVLGPSASAAAAAAAGPGSGVLGPGASGIYGPGVLGPGVLGPGSSAAAAAAAGSYGSGPGVLGPYGSAAAAAAAGPGSGIYGIGPYGPGASGPGIYGPGVLGPSASAAAAAAAGSGVLGPGIYGPYASAAAAAAAGSYGSGPGVLGPYGPGISGSGVLGPGVLGPYASAAAAAAAGPGVLGPYGPGSSAAAAAAAGSYGYGPGVLGPYGPGASGINGPGSGIYGPGVLGPGPSAAAAAAAGPGVLGPYGPGASAAAAAAAGSYGPGVLGPGIYGPGSSGPGVLGPYGPGSSAAAAAAAGSYGPGVLGPYGPGPSAAAAAAAGSYVLGPGVLGPYGPGASGPGVLGPYGPGASAAAAAAAGPGIYGPGVLGPSASAAAAAAAGSYGSGPGIYGPYGPGISGPGSGVLGIGPYGPGASAAAAAAAGSYGPGVLGPYGPGPSAAAAAAAGPGSGIYGPGASGINGPGSGIYGPGVLGPGPSAAAAAAAGPGSGVLGPGAS

SEQ ID NO: 32 - protein, 1179 aa, Artificial Sequence
  Met-PRT966
MGPGVFGPYGPGASAAAAAGINGPGSGVFGPGISGIYGPGVFGPGVFGPGSSAAAAAGPGIYGPGVFGPSASAAAAAGPGSGVFGPGASGIYGPGVFGPGVFGPGSSAAAAAGIYGSGPGVFGPYGSAAAAAGPGSGIYGIGPYGPGASGPGIYGPGVFGPSASAAAAAGSGVFGPGIYGPYASAAAAAGIYGSGPGVFGPYGPGISGSGVFGPGVFGPYASAAAAAGPGVFGPYGPGSSAAAAAGIYGYGPGVFGPYGPGASGINGPGSGIYGPGVFGPGISAAAAAGPGVFGPYGPGASAAAAAGIYGPGVFGPGIYGPGSSGPGVFGPYGPGSSAAAAAGIYGPGVFGPYGPGISAAAAAGIYVFGPGVFGPYGPGASGPGVFGPYGPGASAAAAAGPGIYGPGVFGPSASAAAAAGIYGSGPGIYGPYGPGISGPGSGVFGIGPYGPGASAAAAAGIYGPGVFGPYGPGISAAAAAGPGSGIYGPGASGINGPGSGIYGPGVFGPGISAAAAAGIYVFGPGVFGPYGPGASAAAAAGIYGSGPGVFGPYGPGISGSGVFGPGVFGPYASAAAAAGPGSGVFGPGASGPGVFGPYGPGASAAAAAGINGPGSGVFGPGISGIYGPGVFGPGVFGPGSSAAAAAGPGIYGPGVFGPSASAAAAAGPGSGVFGPGASGIYGPGVFGPGVFGPGSSAAAAAGIYGSGPGVFGPYGSAAAAAGPGSGIYGIGPYGPGASGPGIYGPGVFGPSASAAAAAGSGVFGPGIYGPYASAAAAAGIYGSGPGVFGPYGPGISGSGVFGPGVFGPYASAAAAAGPGVFGPYGPGSSAAAAAGIYGYGPGVFGPYGPGASGINGPGSGIYGPGVFGPGISAAAAAGPGVFGPYGPGASAAAAAGIYGPGVFGPGIYGPGSSGPGVFGPYGPGSSAAAAAGIYGPGVFGPYGPGISAAAAAGIYVFGPGVFGPYGPGASGPGVFGPYGPGASAAAAAGPGIYGPGVFGPSASAAAAAGIYGSGPGIYGPYGPGISGPGSGVFGIGPYGPGASAAAAAGIYGPGVFGPYGPGISAAAAAGPGSGIYGPGASGINGPGSGIYGPGVFGPGISAAAAAGIYVFGPGVFGPYGPGASAAAAAGIYGSGPGVFGPYGPGISGSGVFGPGVFGPYASAAAAAGPGSGVFGPGAS

SEQ ID NO: 33 - protein, 601 aa, Artificial Sequence
  PRT888
MHHHHHHSSGSSGPGVLGPYGPGASAAAAAGQNGPGSGVLGPGQSGQYGPGVLGPGVLGPGSSAAAAAGPGQYGPGVLGPSASAAAAAGPGSGVLGPGASGQYGPGVLGPGVLGPGSSAAAAAGQYGSGPGVLGPYGSAAAAAGPGSGQYGQGPYGPGASGPGQYGPGVLGPSASAAAAAGSGVLGPGQYGPYASAAAAAGQYGSGPGVLGPYGPGQSGSGVLGPGVLGPYASAAAAAGPGVLGPYGPGSSAAAAAGQYGYGPGVLGPYGPGASGQNGPGSGQYGPGVLGPGQSAAAAAGPGVLGPYGPGASAAAAAGQYGPGVLGPGQYGPGSSGPGVLGPYGPGSSAAAAAGQYGPGVLGPYGPGQSAAAAAGQYVLGPGVLGPYGPGASGPGVLGPYGPGASAAAAAGPGQYGPGVLGPSASAAAAAGQYGSGPGQYGPYGPGQSGPGSGVLGQGPYGPGASAAAAAGQYGPGVLGPYGPGQSAAAAAGPGSGQYGPGASGQNGPGSGQYGPGVLGPGQSAAAAAGQYVLGPGVLGPYGPGASAAAAAGQYGSGPGVLGPYGPGQSGSGVLGPGVLGPYASAAAAAGPGSGVLGPGAS

SEQ ID NO: 34 - protein, 601 aa, Artificial Sequence
  PRT965
MHHHHHHSSGSSGPGTSGPYGPGASAAAAAGANGPGSGTSGPGASGAYGPGTSGPGTSGPGSSAAAAAGPGAYGPGTSGPSASAAAAAGPGSGTSGPGASGAYGPGTSGPGTSGPGSSAAAAAGAYGSGPGTSGPYGSAAAAAGPGSGAYGAGPYGPGASGPGAYGPGTSGPSASAAAAAGSGTSGPGAYGPYASAAAAAGAYGSGPGTSGPYGPGASGSGTSGPGTSGPYASAAAAAGPGTSGPYGPGSSAAAAAGAYGYGPGTSGPYGPGASGANGPGSGAYGPGTSGPGASAAAAAGPGTSGPYGPGASAAAAAGAYGPGTSGPGAYGPGSSGPGTSGPYGPGSSAAAAAGAYGPGTSGPYGPGASAAAAAGAYTSGPGTSGPYGPGASGPGTSGPYGPGASAAAAAGPGAYGPGTSGPSASAAAAAGAYGSGPGAYGPYGPGASGPGSGTSGAGPYGPGASAAAAAGAYGPGTSGPYGPGASAAAAAGPGSGAYGPGASGANGPGSGAYGPGTSGPGASAAAAAGAYTSGPGTSGPYGPGASAAAAAGAYGSGPGTSGPYGPGASGSGTSGPGTSGPYASAAAAAGPGSGTSGPGAS

SEQ ID NO: 35 - protein, 601 aa, Artificial Sequence
  PRT889
MHHHHHHSSGSSGPGVLGPYGPGASAAAAAGINGPGSGVLGPGISGIYGPGVLGPGVLGPGSSAAAAAGPGIYGPGVLGPSASAAAAAGPGSGVLGPGASGIYGPGVLGPGVLGPGSSAAAAAGIYGSGPGVLGPYGSAAAAAGPGSGIYGIGPYGPGASGPGIYGPGVLGPSASAAAAAGSGVLGPGIYGPYASAAAAAGIYGSGPGVLGPYGPGISGSGVLGPGVLGPYASAAAAAGPGVLGPYGPGSSAAAAAGIYGYGPGVLGPYGPGASGINGPGSGIYGPGVLGPGISAAAAAGPGVLGPYGPGASAAAAAGIYGPGVLGPGIYGPGSSGPGVLGPYGPGSSAAAAAGIYGPGVLGPYGPGISAAAAAGIYVLGPGVLGPYGPGASGPGVLGPYGPGASAAAAAGPGIYGPGVLGPSASAAAAAGIYGSGPGIYGPYGPGISGPGSGVLGIGPYGPGASAAAAAGIYGPGVLGPYGPGISAAAAAGPGSGIYGPGASGINGPGSGIYGPGVLGPGISAAAAAGIYVLGPGVLGPYGPGASAAAAAGIYGSGPGVLGPYGPGISGSGVLGPGVLGPYASAAAAAGPGSGVLGPGAS

SEQ ID NO: 36 - protein, 601 aa, Artificial Sequence
  PRT916
MHHHHHHSSGSSGPGVIGPYGPGASAAAAAGLNGPGSGVIGPGLSGLYGPGVIGPGVIGPGSSAAAAAGPGLYGPGVIGPSASAAAAAGPGSGVIGPGASGLYGPGVIGPGVIGPGSSAAAAAGLYGSGPGVIGPYGSAAAAAGPGSGLYGLGPYGPGASGPGLYGPGVIGPSASAAAAAGSGVIGPGLYGPYASAAAAAGLYGSGPGVIGPYGPGLSGSGVIGPGVIGPYASAAAAAGPGVIGPYGPGSSAAAAAGLYGYGPGVIGPYGPGASGLNGPGSGLYGPGVIGPGLSAAAAAGPGVIGPYGPGASAAAAAGLYGPGVIGPGLYGPGSSGPGVIGPYGPGSSAAAAAGLYGPGVIGPYGPGLSAAAAAGLYVIGPGVIGPYGPGASGPGVIGPYGPGASAAAAAGPGLYGPGVIGPSASAAAAAGLYGSGPGLYGPYGPGLSGPGSGVIGLGPYGPGASAAAAAGLYGPGVIGPYGPGLSAAAAAGPGSGLYGPGASGLNGPGSGLYGPGVIGPGLSAAAAAGLYVIGPGVIGPYGPGASAAAAAGLYGSGPGVIGPYGPGLSGSGVIGPGVIGPYASAAAAAGPGSGVIGPGAS

SEQ ID NO: 37 - protein, 601 aa, Artificial Sequence
  PRT918
MHHHHHHSSGSSGPGVFGPYGPGASAAAAAGINGPGSGVFGPGISGIYGPGVFGPGVFGPGSSAAAAAGPGIYGPGVFGPSASAAAAAGPGSGVFGPGASGIYGPGVFGPGVFGPGSSAAAAAGIYGSGPGVFGPYGSAAAAAGPGSGIYGIGPYGPGASGPGIYGPGVFGPSASAAAAAGSGVFGPGIYGPYASAAAAAGIYGSGPGVFGPYGPGISGSGVFGPGVFGPYASAAAAAGPGVFGPYGPGSSAAAAAGIYGYGPGVFGPYGPGASGINGPGSGIYGPGVFGPGISAAAAAGPGVFGPYGPGASAAAAAGIYGPGVFGPGIYGPGSSGPGVFGPYGPGSSAAAAAGIYGPGVFGPYGPGISAAAAAGIYVFGPGVFGPYGPGASGPGVFGPYGPGASAAAAAGPGIYGPGVFGPSASAAAAAGIYGSGPGIYGPYGPGISGPGSGVFGIGPYGPGASAAAAAGIYGPGVFGPYGPGISAAAAAGPGSGIYGPGASGINGPGSGIYGPGVFGPGISAAAAAGIYVFGPGVFGPYGPGASAAAAAGIYGSGPGVFGPYGPGISGSGVFGPGVFGPYASAAAAAGPGSGVFGPGAS

SEQ ID NO: 38 - protein, 576 aa, Artificial Sequence
  PRT699
MHHHHHHSSGSSGPGVLGPYGPGASAAAAAAAGSNGPGSGVLGPGQSGQYGPGVLGPGVLGPGSSAAAAAAAGPGQYGPGVLGPSASAAAAAAAGPGSGVLGPGASGQYGPGVLGPGVLGPGSSAAAAAAAGSYGSGPGVLGPYGSAAAAAAAGPGSGQYGQGPYGPGASGPGQYGPGVLGPSASAAAAAAAGSGVLGPGQYGPYASAAAAAAAGSYGSGPGVLGPYGPGQSGSGVLGPGVLGPYASAAAAAAAGPGVLGPYGPGSSAAAAAAAGSYGYGPGVLGPYGPGASGQNGPGSGQYGPGVLGPGPSAAAAAAAGPGVLGPYGPGASAAAAAAAGSYGPGVLGPGQYGPGSSGPGVLGPYGPGSSAAAAAAAGSYGPGVLGPYGPGPSAAAAAAAGSYVLGPGVLGPYGPGASGPGVLGPYGPGASAAAAAAAGPGQYGPGVLGPSASAAAAAAAGSYGSGPGQYGPYGPGQSGPGSGVLGQGPYGPGASAAAAAAAGSYGPGVLGPYGPGPSAAAAAAAGPGSGQYGPGASGQNGPGSGQYGPGVLGPGPSAAAAAAAGPGSGVLGPGAS

SEQ ID NO: 39 - protein, 576 aa, Artificial Sequence
  PRT698
MHHHHHHSSGSSGPGVLGPYGPGASAAAAAAAGSNGPGSGVLGPGISGIYGPGVLGPGVLGPGSSAAAAAAAGPGIYGPGVLGPSASAAAAAAAGPGSGVLGPGASGIYGPGVLGPGVLGPGSSAAAAAAAGSYGSGPGVLGPYGSAAAAAAAGPGSGIYGIGPYGPGASGPGIYGPGVLGPSASAAAAAAAGSGVLGPGIYGPYASAAAAAAAGSYGSGPGVLGPYGPGISGSGVLGPGVLGPYASAAAAAAAGPGVLGPYGPGSSAAAAAAAGSYGYGPGVLGPYGPGASGINGPGSGIYGPGVLGPGPSAAAAAAAGPGVLGPYGPGASAAAAAAAGSYGPGVLGPGIYGPGSSGPGVLGPYGPGSSAAAAAAAGSYGPGVLGPYGPGPSAAAAAAAGSYVLGPGVLGPYGPGASGPGVLGPYGPGASAAAAAAAGPGIYGPGVLGPSASAAAAAAAGSYGSGPGIYGPYGPGISGPGSGVLGIGPYGPGASAAAAAAAGSYGPGVLGPYGPGPSAAAAAAAGPGSGIYGPGASGINGPGSGIYGPGVLGPGPSAAAAAAAGPGSGVLGPGAS

SEQ ID NO: 40 - protein, 1190 aa, Artificial Sequence
  PRT966
MHHHHHHSSGSSGPGVFGPYGPGASAAAAAGINGPGSGVFGPGISGIYGPGVFGPGVFGPGSSAAAAAGPGIYGPGVFGPSASAAAAAGPGSGVFGPGASGIYGPGVFGPGVFGPGSSAAAAAGIYGSGPGVFGPYGSAAAAAGPGSGIYGIGPYGPGASGPGIYGPGVFGPSASAAAAAGSGVFGPGIYGPYASAAAAAGIYGSGPGVFGPYGPGISGSGVFGPGVFGPYASAAAAAGPGVFGPYGPGSSAAAAAGIYGYGPGVFGPYGPGASGINGPGSGIYGPGVFGPGISAAAAAGPGVFGPYGPGASAAAAAGIYGPGVFGPGIYGPGSSGPGVFGPYGPGSSAAAAAGIYGPGVFGPYGPGISAAAAAGIYVFGPGVFGPYGPGASGPGVFGPYGPGASAAAAAGPGIYGPGVFGPSASAAAAAGIYGSGPGIYGPYGPGISGPGSGVFGIGPYGPGASAAAAAGIYGPGVFGPYGPGISAAAAAGPGSGIYGPGASGINGPGSGIYGPGVFGPGISAAAAAGIYVFGPGVFGPYGPGASAAAAAGIYGSGPGVFGPYGPGISGSGVFGPGVFGPYASAAAAAGPGSGVFGPGASGPGVFGPYGPGASAAAAAGINGPGSGVFGPGISGIYGPGVFGPGVFGPGSSAAAAAGPGIYGPGVFGPSASAAAAAGPGSGVFGPGASGIYGPGVFGPGVFGPGSSAAAAAGIYGSGPGVFGPYGSAAAAAGPGSGIYGIGPYGPGASGPGIYGPGVFGPSASAAAAAGSGVFGPGIYGPYASAAAAAGIYGSGPGVFGPYGPGISGSGVFGPGVFGPYASAAAAAGPGVFGPYGPGSSAAAAAGIYGYGPGVFGPYGPGASGINGPGSGIYGPGVFGPGISAAAAAGPGVFGPYGPGASAAAAAGIYGPGVFGPGIYGPGSSGPGVFGPYGPGSSAAAAAGIYGPGVFGPYGPGISAAAAAGIYVFGPGVFGPYGPGASGPGVFGPYGPGASAAAAAGPGIYGPGVFGPSASAAAAAGIYGSGPGIYGPYGPGISGPGSGVFGIGPYGPGASAAAAAGIYGPGVFGPYGPGISAAAAAGPGSGIYGPGASGINGPGSGIYGPGVFGPGISAAAAAGIYVFGPGVFGPYGPGASAAAAAGIYGSGPGVFGPYGPGISGSGVFGPGVFGPYASAAAAAGPGSGVFGPGAS

SEQ ID NO: 41 - protein, 590 aa, Artificial Sequence
  Met-PRT917
MGPGLIGPYGPGASAAAAAGVNGPGSGLIGPGVSGVYGPGLIGPGLIGPGSSAAAAAGPGVYGPGLIGPSASAAAAAGPGSGLIGPGASGVYGPGLIGPGLIGPGSSAAAAAGVYGSGPGLIGPYGSAAAAAGPGSGVYGVGPYGPGASGPGVYGPGLIGPSASAAAAAGSGLIGPGVYGPYASAAAAAGVYGSGPGLIGPYGPGVSGSGLIGPGLIGPYASAAAAAGPGLIGPYGPGSSAAAAAGVYGYGPGLIGPYGPGASGVNGPGSGVYGPGLIGPGVSAAAAAGPGLIGPYGPGASAAAAAGVYGPGLIGPGVYGPGSSGPGLIGPYGPGSSAAAAAGVYGPGLIGPYGPGVSAAAAAGVYLIGPGLIGPYGPGASGPGLIGPYGPGASAAAAAGPGVYGPGLIGPSASAAAAAGVYGSGPGVYGPYGPGVSGPGSGLIGVGPYGPGASAAAAAGVYGPGLIGPYGPGVSAAAAAGPGSGVYGPGASGVNGPGSGVYGPGLIGPGVSAAAAAGVYLIGPGLIGPYGPGASAAAAAGVYGSGPGLIGPYGPGVSGSGLIGPGLIGPYASAAAAAGPGSGLIGPGAS

SEQ ID NO: 42 - protein, 587 aa, Artificial Sequence
  Met-PRT1028
MGPGIFGPYGPGASAAAAAGTGPGSGIFGPGTSGTYGPGIFGPGIFGPGSSAAAAAGPGTYGPGIFGPSASAAAAAGPGSGIFGPGASGTYGPGIFGPGIFGPGSSAAAAAGTYGSGPGIFGPYGSAAAAAGPGSGTYGTGPYGPGASGPGTYGPGIFGPSASAAAAAGSGIFGPGTYGPYASAAAAAGTYGSGPGIFGPYGPGTSGSGIFGPGIFGPYASAAAAAGPGIFGPYGPGSSAAAAAGTYGYGPGIFGPYGPGASGTGPGSGTYGPGIFGPGTSAAAAAGPGIFGPYGPGASAAAAAGTYGPGIFGPGTYGPGSSGPGIFGPYGPGSSAAAAAGTYGPGIFGPYGPGTSAAAAAGTYIFGPGIFGPYGPGASGPGIFGPYGPGASAAAAAGPGTYGPGIFGPSASAAAAAGTYGSGPGTYGPYGPGTSGPGSGIFGTGPYGPGASAAAAAGTYGPGIFGPYGPGTSAAAAAGPGSGTYGPGASGTGPGSGTYGPGIFGPGTSAAAAAGTYIFGPGIFGPYGPGASAAAAAGTYGSGPGIFGPYGPGTSGSGIFGPGIFGPYASAAAAAGPGSGIFGPGAS

SEQ ID NO: 43 - protein, 601 aa, Artificial Sequence
  PRT917
MHHHHHHSSGSSGPGLIGPYGPGASAAAAAGVNGPGSGLIGPGVSGVYGPGLIGPGLIGPGSSAAAAAGPGVYGPGLIGPSASAAAAAGPGSGLIGPGASGVYGPGLIGPGLIGPGSSAAAAAGVYGSGPGLIGPYGSAAAAAGPGSGVYGVGPYGPGASGPGVYGPGLIGPSASAAAAAGSGLIGPGVYGPYASAAAAAGVYGSGPGLIGPYGPGVSGSGLIGPGLIGPYASAAAAAGPGLIGPYGPGSSAAAAAGVYGYGPGLIGPYGPGASGVNGPGSGVYGPGLIGPGVSAAAAAGPGLIGPYGPGASAAAAAGVYGPGLIGPGVYGPGSSGPGLIGPYGPGSSAAAAAGVYGPGLIGPYGPGVSAAAAAGVYLIGPGLIGPYGPGASGPGLIGPYGPGASAAAAAGPGVYGPGLIGPSASAAAAAGVYGSGPGVYGPYGPGVSGPGSGLIGVGPYGPGASAAAAAGVYGPGLIGPYGPGVSAAAAAGPGSGVYGPGASGVNGPGSGVYGPGLIGPGVSAAAAAGVYLIGPGLIGPYGPGASAAAAAGVYGSGPGLIGPYGPGVSGSGLIGPGLIGPYASAAAAAGPGSGLIGPGAS

SEQ ID NO: 44 - protein, 598 aa, Artificial Sequence
  PRT1028
MHHHHHHSSGSSGPGIFGPYGPGASAAAAAGTGPGSGIFGPGTSGTYGPGIFGPGIFGPGSSAAAAAGPGTYGPGIFGPSASAAAAAGPGSGIFGPGASGTYGPGIFGPGIFGPGSSAAAAAGTYGSGPGIFGPYGSAAAAAGPGSGTYGTGPYGPGASGPGTYGPGIFGPSASAAAAAGSGIFGPGTYGPYASAAAAAGTYGSGPGIFGPYGPGTSGSGIFGPGIFGPYASAAAAAGPGIFGPYGPGSSAAAAAGTYGYGPGIFGPYGPGASGTGPGSGTYGPGIFGPGTSAAAAAGPGIFGPYGPGASAAAAAGTYGPGIFGPGTYGPGSSGPGIFGPYGPGSSAAAAAGTYGPGIFGPYGPGTSAAAAAGTYIFGPGIFGPYGPGASGPGIFGPYGPGASAAAAAGPGTYGPGIFGPSASAAAAAGTYGSGPGTYGPYGPGTSGPGSGIFGTGPYGPGASAAAAAGTYGPGIFGPYGPGTSAAAAAGPGSGTYGPGASGTGPGSGTYGPGIFGPGTSAAAAAGTYIFGPGIFGPYGPGASAAAAAGTYGSGPGIFGPYGPGTSGSGIFGPGIFGPYASAAAAAGPGSGIFGPGAS

(19) United States
(12) Patent Application Publication
(10) Pub. No.: US 2022/0251739 A1
(43) Pub. Date: Aug. 11, 2022

(54) Fabric, 3D Shaped Fabric, and Production Method Therefor

(71) Applicants: Spiber Inc., Tsuruoka-shi, Yamagata (JP); Yuima Nakazato Co., Ltd., Shibuya-ku, Tokyo (JP)

(72) Inventors: Yuima Nakazato, Shibuya-ku, Tokyo (JP); Atsushi Ikeda, Tsuruoka-shi, Yamagata (JP)

(73) Assignees: Spiber Inc., Tsuruoka-shi, Yamagata (JP); Yuima Nakazato Co., Ltd., Shibuya-ku, Tokyo (JP)

(21) Appl. No.: 17/622,269

(22) PCT Filed: Jun. 26, 2020
(86) PCT No.: PCT/JP2020/025208

§ 371 Date: Dec. 23, 2021

(30) Foreign Application Priority Data
Jun. 28, 2019 (JP) 2019-122503

(51) Int. Cl. D03D 3/00; C08L 89/00; D04B 1/22; D06M 14/24

(52) U.S. Cl. CPC D03D 3/00; C08L 89/00; D04B 1/22; D06M 2101/12; C08L 2203/12; C08L 2205/025; D10B 2211/04; D06M 14/24

(57) ABSTRACT

An object of the present invention is to provide a fabric capable of easily and inexpensively forming a desired three-dimensional shape. The fabric according to the present invention contains an artificial protein fiber that contains a protein, in which the fabric has a surface including: a portion A that shrinks at a predetermined shrinkage rate when being brought into contact with water; and a portion B that has a shrinkage rate lower than that of the portion A when being brought into contact with water.

### TECHNICAL FIELD

The present invention relates to a fabric and a fabric having a three-dimensional shape and a method for producing the same.

### BACKGROUND ART

In general, various colors and patterns are applied to fabrics used for clothing and bedding by dyeing, printing, or the like. In addition, some articles of clothing and the like have a desired three-dimensional shape formed by smocking or the like, in addition to a flat pattern, by dyeing, printing, or the like.

As a woven fabric having a three-dimensional shape, for example, Patent Literature 1 discloses a woven fabric including a plurality of warp yarns and a plurality of weft yarns interlacing with the plurality of warp yarns, in which some warp yarns among the plurality of warp yarns are shrinkable warp yarns that shrink in a length direction more than the other warp yarns when subjected to a specific treatment, the shrinkable warp yarns have a first leap portion in which a first predetermined number of adjacent weft yarns are leaped over at least in one place in the length direction, and a plurality of first leap portions are arranged in a first predetermined pattern, some weft yarns among the plurality of weft yarns are shrinkable weft yarns that shrink in a length direction more than the other weft yarns when subjected to the specific treatment, the shrinkable weft yarns have a second leap portion in which a second predetermined number of adjacent warp yarns are leaped over at least in one place in the length direction, and a plurality of second leap portions are arranged in a second predetermined pattern, the shrinkable warp yarns form a constant first shrunk portion by shrinking in the length direction more than the other warp yarns when subjected to the specific treatment, the shrinkable weft yarns form a constant second shrunk portion by shrinking in the length direction more than the other weft yarns when subjected to the specific treatment, and a first fold line portion is formed along a direction of the weft yarn by continuously arranging a plurality of first shrunk portions, and a second fold line portion is formed along a direction of the warp yarn by continuously arranging a plurality of second shrunk portions.

### CITATION LIST

### Patent Literature

Patent Literature 1: JP 2015-218426 A

### SUMMARY OF INVENTION

### Technical Problem

The woven fabric disclosed in Patent Literature 1 is a fabric obtained by combining and weaving the shrinkable warp yarns and the shrinkable weft yarns with common yarns to form a predetermined pattern and then shrinking the shrinkable warp yarns and the shrinkable weft yarns to form a predetermined three-dimensional shape. The method described in Patent Literature 1 has problems in that the pattern cannot be changed after the weaving and an advanced design and an advanced weaving technique are required to form the pattern.

An object of the present invention is to provide a fabric capable of easily and inexpensively forming a desired three-dimensional shape. Another object of the present invention is to provide a fabric having a three-dimensional shape capable of easily and inexpensively forming a desired three-dimensional shape. Still another object of the present invention is to provide a method capable of easily and inexpensively producing the fabric having a three-dimensional shape.

### Solution to Problem

The present invention relates to, for example, each of the following inventions.

[1]

A fabric containing an artificial protein fiber that contains a protein, in which

the fabric has a surface including: a portion A that shrinks at a predetermined shrinkage rate when being brought into contact with water; and a portion B that has a shrinkage rate lower than that of the portion A when being brought into contact with water.

[2]

The fabric according to [1], in which the portion B is a portion that does not shrink when being brought into contact with water.

[3]

The fabric according to [1] or [2], in which a plurality of portions A are present.

[4]

The fabric according to any one of [1] to [3], in which the fabric includes a base material that contains the artificial protein fiber, and a water-repellent or waterproof coating film that partially covers a surface of the base material, and

the portion B is composed of a coated portion by the coating film, and the portion A is composed of an uncoated portion.

[5]

The fabric according to any one of [1] to [3], in which the portion A contains the artificial protein fiber that shrinks at the predetermined shrinkage rate when being brought into contact with water, and the portion B contains a fiber that has the shrinkage rate lower than that of the artificial protein fiber contained in the portion A.

[6]

The fabric according to [5], in which the portion B contains an artificial protein fiber that has the shrinkage rate lower than that of the artificial protein fiber contained in the portion A.

[7]

The fabric according to any one of [1] to [6], in which at least the artificial protein fiber contained in the portion A has a shrinkage rate when dried of more than 7%, the shrinkage rate when dried being defined by the following Equation I:

Shrinkage rate when dried={1−(length of artificial protein fiber in dry state/length of artificial protein fiber before being brought into contact with water after spinning)}×100(%) (Equation I).

[8]

The fabric according to any one of [1] to [7], in which the protein is modified fibroin.

[9]

A fabric, in which the fabric has a surface including: a portion C that contains a fiber that shrinks at a predetermined shrinkage rate in response to an external stimulus; and a portion D that contains a fiber of which a shrinkage rate obtained by the external stimulus is smaller than that of the fiber contained in the portion C, and a shrinkage rate obtained by the external stimulus of the portion D is smaller than that of the portion C.

[10]

The fabric according to [9], in which the fabric is made of a woven fabric obtained by knitting yarns extending in one direction and yarns extending in a direction intersecting with the one direction, the yarns extending in the one direction form the portion C that contains the fiber that shrinks at the predetermined shrinkage rate in response to the external stimulus, and the yarns extending in the direction intersecting with the one direction form the portion D that contains the fiber of which the shrinkage rate obtained by the external stimulus is smaller than that of the fiber contained in the portion C.

[11]

A fabric having a three-dimensional shape, containing an artificial protein fiber that contains a protein, in which

the fabric has a surface including: a portion E that is shrunk at a predetermined shrinkage rate by being brought into contact with water; and a portion F that is shrunk at a shrinkage rate lower than that of the portion E by being brought into contact with water or is not shrunk even by being brought into contact with water, and the three-dimensional shape is formed on the surface due to a difference in shrinkage rate between the portion E and the portion F.

[12]

The fabric having a three-dimensional shape according to [11], in which the portion F is a portion that is not shrunk even by being brought into contact with water.

[13]

A fabric having a three-dimensional shape, in which the fabric has a surface including: a portion G that is shrunk at a predetermined shrinkage rate in response to an external stimulus; and a portion H that is shrunk at a shrinkage rate lower than that of the portion G by the external stimulus or is not shrunk even by the external stimulus, and the three-dimensional shape is formed on the surface due to a difference in shrinkage rate between the portion G and the portion H.

[14]

A method for producing a fabric having a three-dimensional shape, the method including a step of performing shrinking processing including bringing the fabric according to any one of [1] to [8] into contact with water.

[15]

A method for producing a fabric having a three-dimensional shape, the method including a step of performing shrinking processing including applying an external stimulus to the fabric according to [9] or [10].

### Advantageous Effects of Invention

According to the present invention, it is possible to provide the fabric capable of easily and inexpensively forming a desired three-dimensional shape, the fabric having a three-dimensional shape capable of easily and inexpensively forming a desired three-dimensional shape, and the method capable of easily and inexpensively producing the fabric having a three-dimensional shape.

### BRIEF DESCRIPTION OF DRAWINGS

FIG. 1 is a cross-sectional schematic view of a fabric according to an embodiment.

FIG. 2 is a cross-sectional schematic view of a fabric according to an embodiment.

FIG. 3 is a schematic view of a fabric according to an embodiment.

FIG. 4 is a photograph of a fabric produced in Test Example 5.

FIG. 5 is a photograph of a fabric having a three-dimensional shape produced in Test Example 6.

FIG. 6 is a schematic view illustrating an example of a domain sequence of modified fibroin.

FIG. 7 is a view illustrating a distribution of values of z/w (%) in naturally derived fibroin.

FIG. 8 is a view illustrating a distribution of values of x/y (%) in naturally derived fibroin.

FIG. 9 is a schematic view illustrating an example of a domain sequence of modified fibroin.

FIG. 10 is a schematic view illustrating an example of a domain sequence of modified fibroin.

FIG. 11 is a photograph of a fabric having a three-dimensional shape produced in Test Example 7.

### DESCRIPTION OF EMBODIMENTS

Hereinafter, embodiments of the present invention will be described in detail with reference to the drawings. For convenience, substantially the same elements are denoted by the same reference numerals, and the description thereof may be omitted. The present invention is not limited to the following embodiments.

### [Fabric]

An aspect of a fabric according to the present embodiment contains an artificial protein fiber that contains a protein, in which the fabric has a surface including: a portion A that shrinks at a predetermined shrinkage rate when being brought into contact with water; and a portion B that has a shrinkage rate lower than that of the portion A when being brought into contact with water.

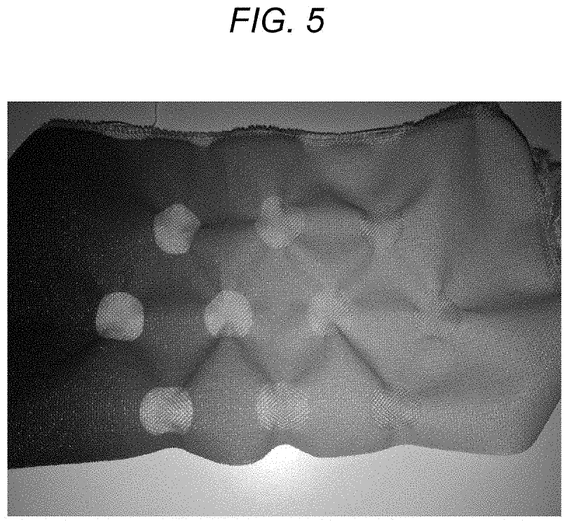

In the fabric according to the present aspect, the property in which the artificial protein fiber shrinks when being brought into contact with water is utilized, and a three-dimensional shape can be formed by the portion A that shrinks more than the portion B by an easy and inexpensive method such as contact with water. For example, the portion B in a region connecting a plurality of shrunk portions A (an area occupied decreases) by a straight line has a degree of shrinkage smaller than that of the portion A and occupies a relatively large area, such that convex portions are formed on a front surface and a rear surface of the fabric (for example, see FIG. 5).

As the artificial protein fiber contained in the fabric according to the present aspect, for example, a fiber (a) before being brought into contact with water after spinning (has no history of being brought into contact with water after spinning) and a fiber (b) that shrinks when being brought into contact with water after spinning and has zero or suppressed shrinkage when further being brought into contact with water are used alone, respectively, or in an appropriate combination. In addition, in a case where the artificial protein fiber (b) is used, two or more types of artificial protein fibers that have shrinkage rates different from each other when further being brought into contact with water may be used. The combination of the artificial protein fiber (a) and the artificial protein fiber (b) is not particularly limited as long as the portion A and the portion B can be formed as described below.

The artificial protein fiber (a) before being brought into contact with water after spinning shrinks irreversibly when being brought into contact with water. In addition, the artificial protein fiber (b) that shrinks when being brought into contact with water and has zero or suppressed shrinkage when further being brought into contact with water also shrinks irreversibly, but not as much as the shrinkage amount of the fiber (a). These irreversible shrinkages have a large shrinkage rate, and thus it is easy to form a three-dimensional shape. In addition, in the fibers that are shrunk by being brought into contact with water after spinning and have shrinkage rates different from each other when further being brought into contact with water, irreversible shrinkage rates when being brought into contact with water are different from each other, such that three-dimensional shapes formed by the shrinkages are also different from each other. Therefore, the fabric according to the present embodiment is preferably configured to be able to form a three-dimensional shape using the irreversible shrinkage. In addition, it is considered that the irreversible shrinkage of the artificial protein fiber occurs, for example, for the following reasons. That is, one reason is considered to be due to a secondary structure or a tertiary structure of the artificial protein fiber, and another reason is considered to be caused by, for example, relaxation of a residual stress in the artificial protein fiber having the residual stress generated by drawing or the like in a production process. The shrinkage rate of the irreversible shrinkage of the artificial protein fiber can be appropriately adjusted by a contact time of the artificial protein fiber with water, a temperature of water, a tensile force applied to the artificial protein fiber at the time of being brought into contact with water or subsequent drying, and the like. By doing so, artificial protein fibers that have different shrinkage rates when being brought into contact with water can be obtained.

The portion B can be formed, for example, by subjecting at least a part of a base material (for example, a knitted and woven fabric, a non-woven fabric, or the like) that contains an artificial protein fiber to water-repellent processing or waterproof processing. Since a region to be subjected to water-repellent processing or waterproof processing can be arbitrarily designed, the region of the portion B can also be arbitrarily designed (at the same time, the region of the portion A is also set). Therefore, a fabric in which an arbitrary three-dimensional shape can be formed can be obtained. In addition, since a common knitted and woven fabric or the like can be used as the base material, a three-dimensionally shaped pattern can also be easily changed. In a case where the portion B is formed by performing water-repellent processing or waterproof processing, the fibers (a) before being brought into contact with water described above are generally used as the artificial protein fiber contained in each of the portion B and the portion A subjected to no water-repellent processing or waterproof processing.

In addition, the portion B to be formed can contain a fiber that has a shrinkage rate lower than that of the artificial protein fiber contained in the portion A when being brought into contact with water. This is realized, for example, by forming the portion B that contains the artificial protein fiber (b) described above and forming the portion A that contains the artificial protein fiber (a) described above. In addition, this is also realized by forming both the portion B and the portion A that contain the artificial protein fibers (b), and selecting a fiber that has a shrinkage rate lower than that of the artificial protein fiber contained in the portion A when being brought into contact with water as the fiber contained in the portion B. In addition, this is also realized, for example, by forming the portion B that contains the artificial protein fiber (b) described above, and forming the portion A using the fiber (a) and the fiber (b) that has a shrinkage rate higher than that of the fiber (b) contained in the portion B when being brought into contact with water, or forming the portion A that contains two or more types of fibers (b) that have shrinkage rates that are different from each other and higher than that of the fiber (b) contained in the portion B when being brought into contact with water. In a case where the portion A that contains two or more types of fibers (b) that have shrinkage rates different from each other when being brought into contact with water is formed, a fabric having a more complicated shape or a more varied shape can be easily formed.

In a case where the fabric according to the present aspect is a woven fabric, at least a part of the fabric consisting of one of a weft yarn and a warp yarn may be formed of the portion A using the artificial protein fiber (a) described above for one of the weft yarn and the warp yarn, and at least a part of the fabric consisting of the other one of the weft yarn and the warp yarn may be formed of the portion B using, for the other one of the weft yarn and the warp yarn, the artificial protein fiber (b) described above or a fiber other than the artificial protein fiber that does not shrink when being brought into contact with water. Then, when the fabric is brought into contact with water, the portion A can be shrunk in a direction in which the weft yarns or the warp yarns constituting the artificial protein fiber (a) extend. In addition, a three-dimensional shape corresponding thereto can be applied to the fabric.

The fabric according to the present aspect may have a plurality of portions A or portions B. The shape of the portion A is not particularly limited, and may be, for example, any shape such as a circle, an ellipse, a regular polygon (for example, a regular triangle, a regular square, a regular pentagon, a regular hexagon, or the like), or a polygon (for example, a triangle, a square, a pentagon, a hexagon, or the like), or may be a band shape extending in one direction or a plurality of directions of a width direction, a length direction, and the like of the fabric. In a case where a plurality of portions A or portions B are included, the shapes thereof may be the same as each other or different from each other. By designing arrangements and shapes of the plurality of portions A or portions B, it is possible to control the obtained three-dimensional shape. By controlling the obtained three-dimensional shape, a three-dimensional pattern can be formed on the fabric, the fabric can be squeezed, or a desired shape (uneven shape or the like) can be applied to a part or the whole of the fabric. In addition, for example, when manufacturing a garment using a fabric to which an uneven shape is applied, it is possible to apply an uneven shape that fits along the shape of a body to a garment portion corresponding to positions such as shoulders, elbows, knees, waist, and other constriction portions when being worn.

In addition, in another aspect of a fabric according to the present embodiment, the fabric has a surface including: a portion C that contains a fiber that shrinks at a predetermined shrinkage rate in response to an external stimulus; and a portion D that contains a fiber of which a shrinkage rate obtained by the external stimulus is smaller than that of the fiber contained in the portion C, and a shrinkage rate obtained by the external stimulus of the portion D is smaller than that of the portion C.

In such an aspect, the property in which the fibers contained in the fabric shrink in response to various external stimuli is utilized, and the portion C shrinks more than the portion D by an easy and inexpensive method such as a reaction with an external stimulus, such that a three-dimensional shape can be formed.

In the fabric according to the present aspect, for example, a fiber (c) that does not shrink before receiving an external stimulus, and a fiber (d) that shrinks by receiving an external stimulus and has zero or suppressed shrinkage by further receiving an external stimulus are used alone, respectively, or in an appropriate combination. In addition, in a case where such a fiber (d) is used, two or more types of fibers (b) that have shrinkage rates different from each other and obtained by further receiving external stimuli may be used. The combination of these fibers (c) and (d) is not particularly limited as long as the portion C and the portion D can be formed as described below. The external stimulus referred to herein is not limited at all as long as the fiber (c) can shrink irreversibly, and examples thereof can include contact with water, heating, irradiation with light, and contact with various chemical substances such as liquid, gas, and solid. In addition, an example of the fiber that shrinks irreversibly by an external stimulus can include a synthetic fiber such as an artificial protein fiber or an acrylic fiber that shrinks when being heated, in addition to an artificial protein fiber, a natural fiber such as cotton or a regenerated fiber such as rayon that shrinks when being brought into contact with water.

In a case where the fabric according to the present aspect is a woven fabric, at least a part of the fabric consisting of one of a weft yarn and a warp yarn may be formed of the portion C using the fiber (c) described above for one of the weft yarn and the warp yarn, and at least a part of the fabric consisting of the other one of the weft yarn and the warp yarn may be formed of the portion D using the fiber (d) described above for the other one of the weft yarn and the warp yarn. Then, when an external stimulus is applied to the fabric, the portion C can be shrunk in a direction in which the weft yarns or the warp yarns constituting the fiber (c) extend. In addition, a three-dimensional shape corresponding thereto can be applied to the fabric.

In the fabric according to the present aspect, the shrinkage rate of the fiber shrunk in response to an external stimulus is increased, such that a three-dimensional shape is easily formed. In addition, in the fibers that are shrunk by external stimuli and have shrinkage rates different from each other obtained by further external stimuli, shrinkage rates obtained by the external stimuli are different from each other, such that three-dimensional shapes formed by the shrinkages are also different from each other. Therefore, the fabric according to the present aspect is preferably configured to be able to form a three-dimensional shape using the irreversible shrinkage. A shrinkage rate of shrinkage of such a fiber obtained by an external stimulus can be appropriately adjusted by, for example, an intensity of the external stimulus, a reaction time, or the like.

In the fabric according to the present aspect, the portion D to be formed can contain a fiber that has a shrinkage rate that is obtained by a reaction with an external stimulus and smaller than that of the fiber contained in the portion C. This is realized, for example, by forming the portion D containing the fiber (d) described above and forming the portion C containing the fiber (c) described above. In addition, this is also realized by forming both the portion D and the portion C that contain the fibers (d), and selecting a fiber that has a shrinkage rate that is obtained by an external stimulus and is smaller than that of the fiber contained in the portion C as the fiber contained in the portion D. In addition, this is also realized, for example, by forming the portion D that contains the fiber (d) described above, and forming the portion C using the fiber (c) and the fiber (d) that has a shrinkage rate higher than that of the fiber (d) contained in the portion D when being brought into contact with water, or forming the portion C that contains two or more types of fibers (d) that have shrinkage rates different from each other that are obtained by external stimuli and larger than that of the fiber (d) contained in the portion D. In a case where the portion C that contains two or more types of fibers (d) that have shrinkage rates different from each other obtained by external stimuli is formed, a fabric that has a more complicated shape or a more varied shape can be easily formed.

Also in the fabric according to the present aspect, the numbers and shapes of the portions C and the portions D are same as the numbers and shapes of the portions A and the portions C provided in an aspect of the fabric according to the present embodiment described above. In addition, as the effects obtained by selecting the number and shape, the same effects as those exhibited in an aspect of the fabric according to the present embodiment are obtained.

### (Artificial Protein Fiber)

The artificial protein fiber is a fiber obtained by spinning a raw material that contains a protein. The artificial protein fiber can be obtained by, for example, dissolving a raw material that contains a protein in a solvent that can dissolve a protein to prepare a dope solution and performing spinning by a known spinning method such as wet spinning, dry spinning, dry wet spinning, or melt spinning. Examples of the solvent that can dissolve a protein can include dimethyl sulfoxide (DMSO), N,N-dimethylformamide (DMF), formic acid, and hexafluoroisopropanol (HFIP). An inorganic salt may be added to the solvent as a dissolution promoter.

A protein as a raw material of the artificial protein fiber is not particularly limited, and any protein can be used. Examples of the protein can include a natural protein and a recombinant protein (artificial protein). An example of the recombinant protein can include any protein that can be produced in an industrial scale, and examples thereof can include a protein that can be used for industrial purposes, a protein that can be used for medical purposes, and a structural protein. Specific examples of the protein that can be used for industrial purposes or medical purposes can include an enzyme, a regulatory protein, a receptor, a peptide hormone, a cytokine, a membrane or transport protein, an antigen used for vaccination, a vaccine, an antigen-binding protein, an immunostimulatory protein, an allergen, and a full length antibody or an antibody fragment or a derivative thereof. Specific examples of the structural protein can include spider silk, silkworm silk, keratin, collagen, elastin, resilin, and proteins derived from them. As the protein to be used, modified fibroin is preferable, and modified spider silk fibroin is more preferable, because a sufficient shrinkage rate can be applied to the base material that contains the artificial protein fiber, such that a difference between the shrinkage rate of the portion A and the shrinkage rate of the portion B subjected to water-repellent processing or waterproof processing can be more sufficiently increased. A preferred aspect of the modified fibroin will be described below.

A shrinkage rate when dried of the artificial protein fiber may be more than 7%. The shrinkage rate when dried may be 15% or more, 25% or more, 32% or more, 40% or more, 48% or more, 56% or more, 64% or more, or 72% or more. An upper limit of the shrinkage rate when dried is generally 80% or less. The shrinkage rate when dried is defined by the following Equation I:

Shrinkage rate when dried={1−(length of artificial protein fiber in dry state/length of artificial protein fiber before being brought into contact with water after spinning)}×100(%) (Equation I).

The “artificial protein fiber being in a dry state” herein refers to an artificial protein fiber that has a history of being brought into contact with water after spinning and is in a dry state.

A shrinkage rate when wetted of the artificial protein fiber may be 2% or more. The shrinkage rate when wetted may be 4% or more, 6% or more, 8% or more, 10% or more, 15% or more, 20% or more, 25% or more, or 30% or more. An upper limit of the shrinkage rate when wetted is generally 80% or less. The shrinkage rate when wetted is defined by the following Equation II:

Shrinkage rate when wetted={1−(length of artificial protein fiber in wet state by being brought into contact with water/length of artificial protein fiber before being brought into contact with water after spinning)}×100(%) (Equation II).

### (Base Material)

The type of the base material of the fabric according to the present embodiment is not particularly limited. Specific examples of the base material can include a knitted and woven fabric and a non-woven fabric.

The knitted and woven fabric is a generic term of a knitted fabric and a woven fabric. The knitted fabric may be any of a knitted fabric having a weft knitting pattern such as flat knitting, circular knitting, jersey stitch knitting, or plating jersey stitch knitting (simply referred to as a “weft knitted fabric”) and a knitted fabric having a warp knitting pattern such as tricot or raschel (simply referred to as a “warp knitted fabric”). The woven fabric may be a woven fabric having any texture of a plain weave texture, a twill weave texture, a satin weave texture, and other known weave textures.

The knitted and woven fabric can be obtained by knitting or weaving raw material yarns. As a knitting method and a weaving method, known methods can be used. As a knitting machine to be used, for example, a circular knitting machine, a warp knitting machine, a flat knitting machine, or the like can be used, and a circular knitting machine is preferably used from the viewpoint of productivity. Examples of the flat knitting machine can include a mold knitting machine and a seamless knitting machine, and in particular, it is more preferable to use a seamless knitting machine because a knitted fabric can be produced in a form of a final product. Examples of a weaving machine to be used can include a shuttle weaving machine and a shuttle-less weaving machine such as a gripper weaving machine, a rapier weaving machine, a water jet weaving machine, or an air jet weaving machine.

The raw material yarn may be a single yarn, a composite yarn (for example, a blended yarn, a mixed yarn, a covering yarn, or the like), or a combination thereof. The single yarn and the composite yarn may be spun yarns in which short fibers are twisted, or may be filament yarns in which long fibers are twisted.

The raw material yarn may contain other fibers in addition to the artificial protein fibers as long as the effects of the present invention are not impaired. Examples of the other fibers can include synthetic fibers such as nylon, polyester, and polytetrafluoroethylene, regenerated fibers such as cupra, rayon, and lyocell, and natural fibers such as cotton, hemp, and silk. In addition, as the raw material yarn containing a fiber that shrinks by an external stimulus, another fiber that does not contain an artificial protein fiber can be used.

A non-woven fabric can be produced by a known production method using, for example, a fiber that contains an artificial protein fiber or other fibers. Specifically, a non-woven fabric can be obtained, for example, by forming a web (including a single layer web and a laminated web) using a fiber that contains an artificial protein fiber by a dry method, a wet method, an air-laid method, and the like, and then bonding fibers of the web by a chemical bond method (an immersion method, a spray method, or the like), a needle punch method, and the like.

A non-woven fabric can be produced, for example, by adding and dissolving a protein, and if necessary, an inorganic salt as a dissolution promoter, to and in a solvent such as dimethyl sulfoxide (DMSO), N,N-dimethylformamide (DMF), formic acid, or hexafluoroisopropanol (HFIP) to prepare a dope solution, and then performing spinning using the dope solution by an electrospinning method (an electrostatic spinning method). In the electrospinning method, a voltage applied between a supply-side electrode (can also be used as a spinneret) and a collection-side electrode (for example, a metal roll, a metal net, or the like), and the dope solution extruded from the spinneret is charged and blown off to the collection-side electrode. In this case, the dope solution is stretched to form fibers. The applied voltage is generally 5 to 100 kV and preferably 10 to 50 kV. A distance between the electrodes is generally 1 to 25 cm and preferably 2 to 20 cm. An average fiber diameter (average value of fiber diameters) of the artificial protein fibers obtained by the electrospinning method is usually 1,000 nm or less, and may be 100 nm to 1,000 nm, 200 nm to 900 nm, or 300 nm to 800 nm. The fiber diameter of the artificial protein fiber may be changed between 100 nm to 1,000 nm (1 μm).

A fiber density (basis weight), a porosity, a bulk density, and the like of the non-woven fabric can be adjusted, for example, by increasing and decreasing the amount of fibers constituting the web, and increasing or decreasing the number of laminated layers in the case of the laminated web.

The base material according to the present embodiment may contain a known additive, if necessary. Examples of the additive can include a colorant, a smoothing agent, an antioxidant, an ultraviolet absorber, a dye, a matting agent, and a leveling agent.

Among the base materials according to the present embodiment, in particular, a non-woven fabric may have a fiber density increase rate of 20% or more. The fiber density increase rate may be 30% or more, 40% or more, 50% or more, or 100% or more. The fiber density increase rate is a value defined by the following Equation III:

Fiber density increase rate={(fiber density of base material after shrinking processing/fiber density of base material before shrinking processing)−1}×100(%) (Equation III).

### (Formation of Portion a and Portion B)

### <Water-Repellent or Waterproof Processing>

The water-repellent or waterproof processing of the base material can be performed by, for example, a method of binding a hydrophobic polymer such as a fluorine-based polymer or a silicone-based polymer to the region set as the portion B (first method), a method of forming a photocurable resin layer in the region set as the portion B (second method), or the like. In addition, various methods used for forming a water-repellent or waterproof coating film on an arbitrary portion of the base material can be employed as the water-repellent or waterproof processing method for the base material.

The first method may include, for example, a step of irradiating the base material with plasma in a state where the base material is brought into contact with a hydrophobic polymer such as a fluorine-based polymer or a silicone-based polymer, or a precursor (monomer) of the hydrophobic polymer to covalently bind the base material and the hydrophobic polymer to the region set as the portion B. Even in a case where a precursor (monomer) is used, the precursors (monomers) are polymerized by irradiation with plasma to form a hydrophobic polymer, such that a base material to which the hydrophobic polymer is bound can be obtained.

The fluorine-based polymer is not particularly limited as long as it is a polymer containing fluorine. The fluorine-based polymer may be, for example, a polymer obtained by polymerizing olefins containing fluorine. Examples of the fluorine-based polymer can include polytetrafluoroethylene, polytrifluoroethylene, polychlorotrifluoroethylene, polyvinyl fluoride, polyvinylidene fluoride, polyperfluoroalkyl vinyl ether, polyperfluoropropylene, a polytetrafluoroethylene-perfluoropropylene copolymer, a tetrafluoroethylene-ethylene copolymer, and a polyvinyl fluoride-ethylene copolymer. The fluorine-based polymer may be a copolymer (including a random copolymer, a block copolymer, or an alternating copolymer) obtained by polymerizing two or more types of monomers constituting the exemplified polymer.

The silicone-based polymer is not particularly limited as long as it is a polymer having a polysiloxane structure in a main chain thereof. The silicone-based polymer may be, for example, a homopolymer or copolymer (including a random copolymer, a block copolymer, or an alternating copolymer) obtained by polymerizing one or two or more types of monomers having a siloxane structural unit. The silicone-based polymer may be a copolymer (including a random copolymer, a block copolymer, or an alternating copolymer) obtained by polymerizing one or two or more types of monomers having a siloxane structural unit and one or two or more types of monomers having no siloxane structural unit.

The plasma to be irradiated may be appropriately set according to the type and the like of each of the base material and the hydrophobic polymer (or the precursor thereof). A flow rate of a discharge gas may be, for example, in a range of 0.1 L/min or more and 10 L/min or less. A plasma density of the plasma to be generated may be, for example, in a range of 1×10¹³ cm⁻³ or more and 1×10¹⁵ cm⁻³ or less. The discharge gas may be, for example, a rare gas such as helium, neon, or argon, oxygen, nitrogen, or the like. The air can be used as the discharge gas.

The plasma irradiation can be performed using a known plasma irradiation apparatus. As the plasma irradiation apparatus, for example, a plasma treatment apparatus manufactured by Europlasma, SA can be used.

In the first method, for example, the portion B may be formed in a portion irradiated with plasma and the portion A may be formed in a portion not irradiated with plasma by controlling a portion irradiated with plasma and a portion not irradiated with plasma. In the first method, the portion A and the portion B may be formed by irradiating the base material with plasma after masking a portion (corresponding to the portion A) not irradiated with plasma.

The second method may include, for example, a step of forming a photocurable resin layer in the region set as the portion B by irradiating the base material with light energy such as an ultraviolet ray or an electron beam in a state where a monomer composition of a photocurable resin is brought into contact with the base material and curing the base material.

The monomer composition contains a photopolymerizable monomer. The photopolymerizable monomer may be, for example, a component that is polymerized and cured by irradiation with light energy such as an ultraviolet ray. The photopolymerizable monomer is not particularly limited, and one type of conventionally known photopolymerizable monomer can be used alone, or two or more types of photopolymerizable monomers can be used in combination. An example of the photopolymerizable monomer can include a radically polymerizable monomer having one or more radically polymerizable groups such as a (meth)acryloyl group and a vinyl group. Specific examples of the photopolymerizable monomer can include a (meth)acrylate monomer having a (meth)acryloyl group such as a monofunctional (meth)acrylate such as isobornyl (meth)acrylate or benzyl (meth)acrylate, a bifunctional (meth)acrylate such as hexamethylene di(meth)acrylate, or a trifunctional (meth)acrylate such as trimethyl isopropane tri(meth)acrylate. As the photopolymerizable monomer, two or more monomers having different numbers of radically polymerizable groups are preferably used in combination. In the present specification, “(meth)acryloyl” includes “methacryloyl” and “acryloyl”, and “(meth)acrylate” is a term including “methacrylate” and “acrylate”.

The monomer composition may also contain components other than the photopolymerizable monomer. Examples of the other components can include a photopolymerization initiator, a pigment, a dye, a colorant, a polymerization inhibitor, a radical scavenger, an antioxidant, an ultraviolet absorber, a plasticizer, a surfactant, a leveling agent, a thickener, a dispersant, an antifoaming agent, a preservative, and a solvent.

The photopolymerization initiator is a component decomposed by irradiation with light energy such as an ultraviolet ray or an electron beam to generate active species such as radicals and initiate a polymerization reaction of the photopolymerizable monomer. The photopolymerization initiator is not particularly limited, and one type of conventionally known photopolymerization initiator can be used alone, or two or more types of photopolymerization initiators can be used in combination.

The second method can be performed using, for example, a UV printer (for example, VersaUV LEF2-200, manufactured by Roland DG Corporation). The ink of the UV printer contains a photopolymerizable monomer capable of forming a photocurable resin layer, and the photocurable resin layer can be formed by arranging the ink in a desired pattern and then irradiating the ink with UV. In addition, a desired pattern (arrangement of the portion A and the portion B) can be easily and inexpensively printed on the base material using the UV printer. Furthermore, a desired ink pattern that functions as a water-repellent coating film can be easily and reliably formed at a sufficient thickness on the fabric while stain and the like on the fabric are suppressed. In addition, a desired colored design can be easily realized by variously changing the color of the ink pattern.

<Use of Artificial Protein Fibers that have Shrinkage Rates Different from Each Other when being Brought into Contact with Water>

As described above, the portion A and the portion B of the fabric according to the present embodiment can also be formed by using artificial protein fibers that have shrinkage rates different from each other when being brought into contact with water. The fabric including the portion A and the portion B can be obtained in a form in which the portion A and the portion B are continuously and integrally formed, for example, by changing (switching) the artificial protein fibers to be used in the middle of production. In a case where the fabric is a woven fabric, a known method capable of switching the fibers without interlacing the fibers in the middle of weaving is advantageously employed. Alternatively, the portion A and the portion B are separately prepared, and then, the portion A and the portion B are joined as patchwork or the like, such that a fabric including the portion A and the portion B can be obtained. In general, a known method is appropriately adopted for joining of the portion A and the portion B depending on the form of the base material. For example, in a case where the base material is a knitted and woven fabric, the portion A and the portion B are joined by being sewn to each other or bonded with an adhesive or the like at the respective side edges. In addition, in a case where the base material is a non-woven fabric, the portion A and the portion B are joined by being entangled with each other or bonded with an adhesive or the like at the respective side edges.

<Use of Fibers that have Shrinkage Rates Different from Each Other Obtained by External Stimuli>

As described above, the portion C and the portion D of the fabric according to the present embodiment can also be formed by using artificial protein fibers that have shrinkage rates different from each other obtained by contact with water, heating, or external stimuli such as irradiation with light. The fabric including the portion C and the portion D can be obtained in a form in which the portion C and the portion D are continuously and integrally formed, for example, by changing (switching) the artificial protein fibers to be used in the middle of production. In a case where the fabric is a woven fabric, a known method capable of switching the fibers without interlacing the fibers in the middle of weaving is advantageously employed. Alternatively, the portion C and the portion D are separately prepared, and then, the portion C and the portion D are joined as patchwork or the like, such that a fabric including the portion C and the portion D can be obtained. In general, a known method is appropriately adopted for joining of the portion C and the portion D depending on the form of the base material. For example, in a case where the base material is a knitted and woven fabric, the portion C and the portion D are joined by being sewn to each other or being bonded with an adhesive or the like at the respective side edges. In addition, in a case where the base material is a non-woven fabric, the portion C and the portion D are joined by being entangled with each other or bonded with an adhesive or the like at the respective side edges.

In a case where the portions A and B or the portions C and D are formed by using fibers that have shrinkage rates different from each other when being brought into contact with water or shrinkage rates different from each other obtained by external stimuli, in particular, the following portions A to D can be formed in a woven fabric. For example, yarns extending in a direction of a fabric made of a woven fabric, that is, for example, one of a warp yarn and a weft yarn may be formed of a fiber that shrinks when being brought into contact with water or by an external stimulus, the portion A or the portion C is formed of one of the warp yarn and the weft yarn, yarns extending in a direction intersecting with one direction, that is, for example, the other one of the warp yarn and the weft yarn may be formed of a fiber that has a shrinkage rate lower than that of a fiber constituting one of the warp yarn and the weft yarn, and the portion B or the portion D may be formed of the other one of the warp yarn and the weft yarn. In a case where the woven fabric is formed by, for example, triaxial weaving, one of the portions A and C and the portions B and D is formed by yarns extending in one direction or two directions among three directions in which the yarns extend, and the other one of the portions A and C and the portions B and D is formed by the yarns in the remaining one direction.

The shrinkage rate (shrinkage rate when shrinking by being brought into contact with water or by an external stimulus) of the portion A or the portion C of the fabric according to the present embodiment may be, for example, more than 7%, 10% or more, 15% or more, 20% or more, or 25% or more. The shrinkage rate of the portion A is a value defined by the following equation when a square region in the portion A is designated.

Shrinkage rate (%)={1−(average value of lengths of sides after reaction by contact with water or external stimulus/average value of lengths of sides before reaction by contact with water or external stimulus)}×100

The shrinkage rate (shrinkage rate when shrinking by being brought into contact with water or by an external stimulus) of the portion B or the portion D of the fabric according to the present embodiment is not particularly limited as long as it is lower than the shrinkage rate of the portion A or the portion C, and may be, for example, 20% or less, 15% or less, 10% or less, 7% or less, 5% or less, 3% or less, 1% or less, or 0% (does not shrink). The shrinkage rate of the portion B or the portion D is a value defined by the same shrinkage rate as that of the portion A or the portion C.

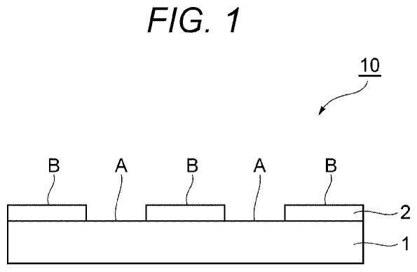

FIG. 1 is a cross-sectional schematic view of a fabric according to an embodiment. A fabric 10 illustrated in FIG. 1 includes a base material 1 and a water-repellent or waterproof coating film 2 that partially covers a surface of the base material 1. The surface of the fabric 10 has a portion B constituted by the water-repellent or waterproof coating film 2 and a portion A constituted by the surface of the base material 1 that is not covered. By bringing water into contact with the surface of the fabric 10, the portion A shrinks at a shrinkage rate higher than that of the portion B to form a three-dimensional shape. The portion B may be a portion that does not shrink when being brought into contact with water.

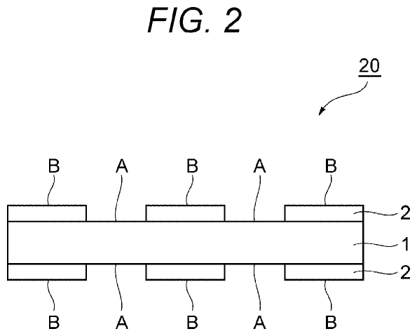

FIG. 2 is a cross-sectional schematic view of a fabric according to another embodiment. A fabric 20 illustrated in FIG. 2 includes a base material 1 and water-repellent or waterproof coating films 2 that partially cover surfaces (both surfaces) of the base material 1. Since the fabric 20 includes the water-repellent or waterproof coating films 2 formed on the both surfaces of the base material 1, for example, shrinking processing can be performed by immersion in water.

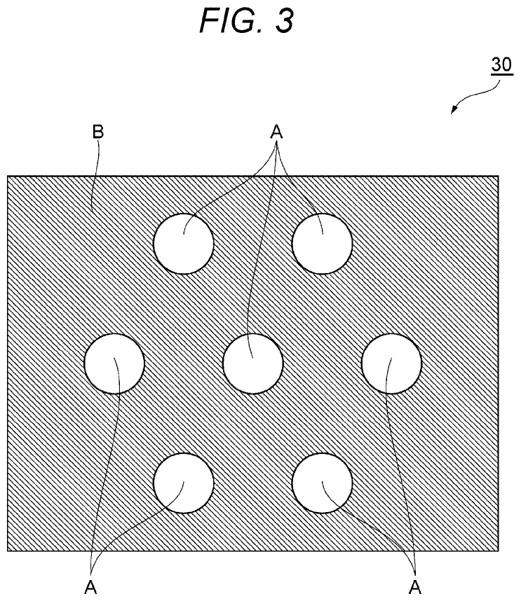

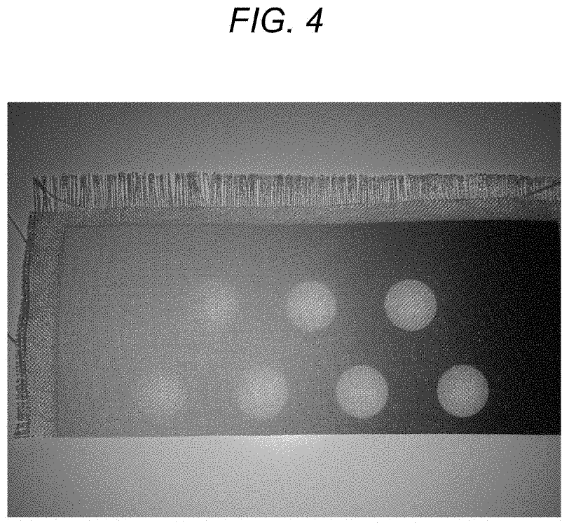

FIG. 3 is a schematic view of a fabric according to an embodiment. A fabric 30 illustrated in FIG. 3 includes circular portions A having repeated patterns arranged at the vertex and center of a regular hexagon (corresponding to the fabric of Test Example 5, see FIG. 4). The fabric 30 is subjected to shrinking processing, such that a fabric having a three-dimensional shape in which an uneven shape is formed as illustrated in FIG. 5 is obtained.

Although not illustrated, a fabric according to another embodiment has a longitudinal rectangular shape, and both end regions in a length direction are portions B, respectively. In addition, in the intermediate region in the length direction, the portions A are formed so as to continuously extend over the entire width. Here, for example, the portions B to be formed contain an artificial protein fiber already shrunk by being brought into contact with water after spinning. In addition, the portions A to be formed contain an artificial protein fiber that has no history of being brought into contact with water. In such a fabric, both side edges in the width direction are joined to each other to form a tubular shape, and then, shrinking processing is formed to form a fabric having a three-dimensional shape in which a constriction portion is formed in the intermediate portion in a height direction of the tubular shape.

Although not illustrated, a fabric according to still another embodiment has a ring-shaped portion A. In a fabric 50, for example, a portion B that contains an artificial protein fiber already shrunk by being brought into contact with water after spinning is formed, and a portion A that contains an artificial protein fiber that has no history of being brought into contact with water after spinning is formed. The fabric is subjected to shrinking processing, such that a fabric having a three-dimensional shape in which a convex shape is formed in a circular portion B surrounded by a ring-shaped portion A is obtained. Then, when the fabric having a three-dimensional shape is used as a fabric for a garment, for example, a garment in which a convex shape is formed at portions corresponding to shoulders, elbows, knees, and the like when being worn is obtained.

Although not illustrated, a fabric according to still another embodiment is a knitted fabric in which jersey stitch knitted portions knitted by plating jersey stitch knitting between a plurality of tubular knitted portions knitted by tubular knitting, and in other words, is a knitted fabric in which tubular knitted portions and jersey stitch knitted portions are alternately provided. In such a fabric, the entire rear side of the tubular knitted portion is a portion A, and the entire front side of the tubular knitted portion is a portion B. The fabric is produced, for example, by using a yarn that contains an artificial protein fiber that has no history of being brought into contact with water after spinning as a rear yarn applied to the rear side of the tubular knitted portion, and using a yarn that contains an artificial protein fiber already shrunk by being brought into contact with water after spinning as a front yarn applied to the front side of the tubular knitted portion. Such a fabric is subjected to shrinking processing, such that a fabric having a three-dimensional shape in which a specific three-dimensional shape is formed in the tubular knitted portion is obtained.

Although not illustrated, a fabric according to still another embodiment is a substantially longitudinal rectangular woven fabric applied to a front body of pants. In such a fabric, two triangular regions are provided in the intermediate portion in a length direction located at knees when being worn in a state where vertices in a height direction are butted against each other at the center in a width direction of the fabric and a bottom is located at both side edges in the width direction. Warp yarns included in each of the triangular regions and extending in the length direction of the woven fabric (a length direction of the pants) are formed of a fiber that shrinks when being heated (for example, an acrylic fiber), and weft yarns are formed of a fiber that does not shrink even when being heated (for example, a fiber other than the acrylic fiber). That is, in the fabric of the present embodiment, a portion C formed of some warp yarns and a portion D formed of some weft yarns are formed at the intermediate portion in the length direction. An external stimulus generated by heating is applied to such a fabric, such that shrinkage due to shrinkage of the portion C is formed at the intermediate portion in the length direction. When pants are produced using the fabric having a three-dimensional shape, portions corresponding to side portions of knees are shrunk, and thus, a feeling of tightness when the knees are bent and stretched can be effectively suppressed. That is, it is possible to produce pants having a shape fitting a body without three-dimensional cutting, for example.

### [Fabric Having Three-Dimensional Shape]

An aspect of a fabric having a three-dimensional shape according to the present embodiment contains an artificial protein fiber that contains a protein, in which the fabric has a surface including: a portion E that is shrunk at a predetermined shrinkage rate by being brought into contact with water; and a portion F that is shrunk at a shrinkage rate lower than that of the portion E by being brought into contact with water or is not shrunk even by being brought into contact with water, and the three-dimensional shape is formed on the surface due to a difference in shrinkage rate between the portion E and the portion F.

The fabric having a three-dimensional shape according to the present aspect is obtained, for example, by performing shrinking processing by bringing the fabric according to the present embodiment described above into contact with water. In this case, the portion E corresponds to the portion A that is shrunk by being brought into contact with water, and the portion F corresponds to the portion B that is not shrunk even by brought into contact with water or the portion B that is shrunk at a shrinkage rate lower than that of the portion A by being brought into contact with water.

Another aspect of a fabric having a three-dimensional shape according to the present embodiment contains a fiber that shrinks by an external stimulus, in which the fabric has a surface including: a portion G that is shrunk at a predetermined shrinkage rate by an external stimulus; and a portion H that is shrunk at a shrinkage rate lower than that of the portion E by the external stimulus or is not shrunk even by the external stimulus, and the three-dimensional shape is formed on the surface due to a difference in shrinkage rate between the portion G and the portion H.

The fabric having a three-dimensional shape according to the present aspect is obtained, for example, by performing shrinking processing by applying an external stimulus to the fabric according to the present embodiment described above. In this case, the portion G corresponds to the portion C that is shrunk by an external stimulus, and the portion H corresponds to the portion D that is not shrunk even by an external stimulus or the portion D that is shrunk at a shrinkage rate lower than that of the portion C by an external stimulus.

A fiber density (basis weight) of each of the portion E or the portion G is, for example, 0.04 g/cm² or more, 0.045 g/cm² or more, 0.05 g/cm² or more, or 0.055 g/cm² or more. The fiber density (basis weight) is a value defined by a weight per unit area.

### [Method for Producing Fabric Having Three-Dimensional Shape]

An aspect of a method for producing a fabric having a three-dimensional shape according to the present embodiment includes a step of performing shrinking processing including bringing the fabric according to the present embodiment described above into contact with water (shrinking step). By the shrinking processing, the artificial protein fiber irreversibly shrinks, and the three-dimensional shape is formed. The fabric to be subjected to the shrinking processing preferably contains an artificial protein fiber (that is, an artificial protein fiber that has no shrinkage history by contact with water) after spinning and before being brought into contact with water.

In the shrinking step, the artificial protein fiber shrinks when being brought into contact with water regardless of an external force. The water to be brought into contact may be water in ether a liquid state or a gas state. A method of bringing the artificial protein fiber into contact with water is also not particularly limited, and examples thereof can include a method of immersing the fabric according to the present embodiment (containing an artificial protein fiber) in water, a method of spraying water to the fabric according to the present embodiment at room temperature or in a state of heated steam or the like, and a method of exposing the fabric according to the present embodiment under a high-humidity environment filled with water vapor. Among these methods, the method of immersing the fabric according to the present embodiment in water is preferable because the shrinkage time can be effectively shortened and the processing equipment can be simplified. A specific example of the method of immersing the fabric according to the present embodiment in water can include a method of injecting the fabric according to the present embodiment into a container containing water at a predetermined temperature and bringing the fabric into contact with water.

The temperature of the water to be brought into contact with the fabric according to the present embodiment is not particularly limited, and for example, is preferably lower than a boiling point of the water. At such a temperature, handleability, workability in the shrinking step, and the like are improved. In addition, an upper limit of the temperature of the water is preferably 90° C. or lower and more preferably 80° C. or lower. A lower limit of the temperature of the water is preferably 10° C. or higher, more preferably 40° C. or higher, and still more preferably 70° C. or higher. The temperature of the water to be brought into contact with the fabric according to the present embodiment can be adjusted according to the fibers constituting the artificial protein fiber contained in the fabric according to the present embodiment. In addition, the temperature of the water may be constant or may be varied so as to be a predetermined temperature while the water is brought into contact with the fabric according to the present embodiment.

The time for bringing the fabric according to the present embodiment into contact with water is not particularly limited, and may be, for example, 10 seconds or longer. The corresponding time may be 30 seconds or longer, 1 minute or longer, 1 minute 30 seconds or longer, 2 minutes or longer, 10 minutes or longer, 20 minutes or longer, or 30 minutes or longer. In addition, an upper limit of the corresponding time is not particularly limited, and may be, for example, 120 minutes or shorter, 90 minutes or shorter, or 60 minutes or shorter, from the viewpoint of shortening the time in the production process and eliminating the possibility of hydrolysis of the artificial protein fiber.

The shrinking step may further include a step of bringing the fabric according to the present embodiment into contact with water and then drying the fabric (drying step).

A drying method in the drying step is not particularly limited, and may be, for example, natural drying or forced drying using drying equipment. A dry temperature is not limited as long as it is a temperature lower than a temperature at which the protein is thermally damaged, and in general, may be a temperature of 20 to 150° C., a temperature of 40 to 120° C., or a temperature of 60 to 100° C. When the temperature is within the above range, the fabric according to the present embodiment can be more quickly and efficiently dried without causing thermal damage of the protein or the like. The dry temperature may also be room temperature or ambient temperature. A dry time is appropriately selected depending on the dry temperature or the like, and for example, a time during which the influence on the quality and physical properties of the fabric due to overdrying of the artificial protein fiber can be eliminated is employed.

Another aspect of a method for producing a fabric having a three-dimensional shape according to the present embodiment includes a step of performing shrinking processing including applying an external stimulus to the fabric according to the present embodiment described above (shrinking step). By the shrinking processing, the fiber irreversibly shrinks, and the three-dimensional shape is formed. The fabric to be subjected to the shrinking processing preferably contains a fiber (that is, a fiber that has no shrinkage history by an external stimulus) before receiving an external stimulus after spinning.

In the shrinking step, the fiber shrinks by an external stimulus regardless of an external force. Examples of the external stimulus can include the contact with water, the heating, the irradiation with light, and the contact with various chemical substances such as liquid, gas, and solid described above. Any known method can be adopted as a method of applying the external stimulus to the fabric.

### [Modified Fibroin]

Modified fibroin according to the present embodiment is a protein containing a domain sequence represented by Formula 1: [(A)ₙ motif-REP]ₘ or Formula 2: [(A)ₙ motif-REP]ₘ-(A)ₙ motif. An amino acid sequence (N-terminal sequence and C-terminal sequence) may be further added to either or both of the N-terminal side and the C-terminal side of the domain sequence of the modified fibroin. The N-terminal sequence and the C-terminal sequence are not limited thereto, but, typically are regions having no repetitions of amino acid motifs characterized in fibroin, and each consists of amino acids of approximately 100 residues.

The term “modified fibroin” in the present specification refers to artificially produced fibroin (artificial fibroin). The modified fibroin may be fibroin in which a domain sequence is different from an amino acid sequence of naturally derived fibroin or may be fibroin in which a domain sequence is the same as an amino acid sequence of naturally derived fibroin. The term “naturally derived fibroin” as used in the present specification is also a protein containing a domain sequence represented by Formula 1: [(A)ₙ motif-REP]ₘ or Formula 2: [(A)ₙ motif-REP]ₘ-(A)ₙ motif.

The “modified fibroin” may be fibroin obtained by using an amino acid sequence of naturally derived fibroin as it is, fibroin in which an amino acid sequence is modified based on an amino acid sequence of naturally derived fibroin (for example, fibroin in which an amino acid sequence is modified by modifying a cloned gene sequence of naturally derived fibroin), or fibroin artificially designed and synthesized independently of naturally derived fibroin (for example, fibroin having a desired amino acid sequence by chemically synthesizing a nucleic acid encoding a designed amino acid sequence).

The term “domain sequence” in the present specification is an amino acid sequence that produces a crystal region (typically, corresponding to the (A)ₙ motif of the amino acid sequence) and an amorphous region (typically, corresponding to REP of the amino acid sequence) specific to fibroin, and means an amino acid sequence represented by Formula 1: [(A)ₙ motif-REP]ₘ or Formula 2: [(A)ₙ motif-REP]ₘ-(A)ₙ motif. Here, the (A)ₙ motif represents an amino acid sequence mainly composed of alanine residues, and the number of amino acid residues therein is 2 to 27. The number of the amino acid residues in the (A)ₙ motif may be an integer of 2 to 20, 4 to 27, 4 to 20, 8 to 20, 10 to 20, 4 to 16, 8 to 16, or 10 to 16. In addition, the proportion of the number of alanine residues in the total number of amino acid residues in the (A)ₙ motif may be 40% or more, or may also be 60% or more, 70% or more, 80% or more, 83% or more, 85% or more, 86% or more, 90% or more, 95% or more, or 100% (meaning that the (A)ₙ motif only consists of alanine residues). At least seven of a plurality of (A)ₙ motifs in the domain sequence may consist of only alanine residues. The REP represents an amino acid sequence consisting of 2 to 200 amino acid residues. The REP may be an amino acid sequence consisting of 10 to 200 amino acid residues. m represents an integer of 2 to 300, and may be an integer of 10 to 300. A plurality of (A)ₙ motifs may be the same amino acid sequences or different amino acid sequences. A plurality of REPs may be the same amino acid sequences or different amino acid sequences.

The modified fibroin according to the present embodiment can be obtained by, for example, performing modification of an amino acid sequence corresponding to substitution, deletion, insertion, and/or addition of one or a plurality of amino acid residues with respect to a cloned gene sequence of naturally derived fibroin. Substitution, deletion, insertion, and/or addition of the amino acid residues can be performed by methods well known to those skilled in the art, such as site-directed mutagenesis. Specifically, the modification may be performed in accordance with a method described in literatures such as Nucleic Acid Res. 10, 6487 (1982), and Methods in Enzymology, 100, 448 (1983).

The naturally derived fibroin is a protein containing a domain sequence represented by Formula 1: [(A)n motif-REP]m or Formula 2: [(A)ₙ motif-REP]ₘ-(A)ₙ motif, and a specific example thereof can include fibroin produced by insects or spiders.

Examples of the fibroin produced by insects can include silk proteins produced by silkworms such as Bombyx mori, Bombyx mandarina, Antheraea yamamai, Anteraea pernyi, Eriogyna pyretorum, Pilosamia Cynthia ricini, Samia cynthia, Caligura japonica, Antheraea mylitta, and Antheraea assama and hornet silk proteins discharged from larvae of Vespa simillima xanthoptera.

More specific examples of the fibroin produced by insects can include the silkworm fibroin L chain (GenBank Accession Nos. M76430 (base sequence) and AAA27840.1 (amino acid sequence)).

Examples of the fibroin produced by spiders can include spider silk proteins produced by spiders belonging to the order Araneae. More specific examples thereof can include spider silk proteins produced by spiders belonging to the genus Araneus, such as Araneus ventricosus, Araneus diadematus, Araneus pinguis, Araneus pentagrammicus, and Araneus nojimai, spiders belonging to the genus Neoscona, such as Neoscona scylla, Neoscona nautica, Neoscona adianta, and Neoscona scylloides, spiders belonging to the genus Pronus, such as Pronous minutus, spiders belonging to the genus Cyrtarachne, such as Cyrtarachne bufo and Cyrtarachne inaequalis, spiders belonging to the genus Gasteracantha, such as Gasteracantha kuhlii and Gasteracantha mammosa, spiders belonging to the genus Ordgarius, such as Ordgarius hobsoni and Ordgarius sexspinosus, spiders belonging to the genus Argiope, such as Argiope amoena, Argiope minuta, and Argiope bruennichi, spiders belonging to the genus Arachnura, such as Arachnura logio, spiders belonging to the genus Acusilas, such as Acusilas coccineus, spiders belonging to the genus Cytophora, such as Cyrtophora moluccensis, Cyrtophora exanthematica, and Cyrtophora unicolor, spiders belonging to the genus Poltys, such as Poltys illepidus, spiders belonging to the genus Cyclosa, such as Cyclosa octotuberculata, Cyclosa sedeculata, Cyclosa vallata, and Cyclosa atrata, and spiders belonging to the genus Chorizopes, such as Chorizopes nipponicus, and spider silk proteins produced by spiders belonging to the family Tetragnathidae, such as spiders belonging to the genus Tetragnatha, such as Tetragnatha praedonia, Tetragnatha maxillosa, Tetragnatha extensa, and Tetragnatha squamata, spiders belonging to the genus Leucauge, such as Leucauge magnifica, Leucauge blanda, and Leucauge subblanda, spiders belonging to the genus Nephila, such as Nephila clavata and Nephila pilipes, spiders belonging to the genus Menosira, such as Menosira ornata, spiders belonging to the genus Dyschiriognatha, such as Dyschiriognatha tenera, spiders belonging to the genus Latrodectus, such as Latrodectus mactans, Latrodectus hasseltii, Latrodectus geometricus, and Latrodectus tredecimguttatus, and spiders belonging to the genus Euprosthenops. Examples of the spider silk protein can include dragline silk proteins such as MaSps (MaSp1 and MaSp2) and ADFs (ADF3 and ADF4), MiSps (MiSp1 and MiSp2), AcSp, PySp, and Flag.

More specific examples of the spider silk protein produced by spiders include fibroin-3 (adf-3) [derived from Araneus diadematus] (GenBank Accession No. AAC47010 (amino acid sequence), U47855 (base sequence)), fibroin-4 (adf-4) [derived from Araneus diadematus] (GenBank Accession No. AAC47011 (amino acid sequence), U47856 (base sequence)), dragline silk protein spidroin 1 [derived from Nephila clavipes] (GenBank Accession No. AAC04504 (amino acid sequence), U37520 (base sequence)), major ampullate spidroin 1 [derived from Latrodectus hesperus] (GenBank Accession No. ABR68856 (amino acid sequence), EF595246 (base sequence)), dragline silk protein spidroin 2 [derived from Nephila clavata] (GenBank Accession No. AAL32472 (amino acid sequence), AF441245 (base sequence)), major ampullate spidroin 1 [derived from Euprosthenops australis] (GenBank Accession No. CAJ00428 (amino acid sequence), AJ973155 (base sequence)), and major ampullate spidroin 2 [Euprosthenops australis] (GenBank Accession No. CAM32249.1 (amino acid sequence), AM490169 (base sequence)), minor ampullate silk protein 1 [Nephila clavipes] (GenBank Accession No. AAC14589.1 (amino acid sequence)), minor ampullate silk protein 2 [Nephila clavipes] (GenBank Accession No. AAC14591.1 (amino acid sequence)), and minor ampullate spidroin-like protein [Nephilengys cruentata] (GenBank Accession No. ABR37278.1 (amino acid sequence).

More specific examples of the naturally derived fibroin can include fibroin whose sequence information is registered in NCBI GenBank. For example, sequences thereof may be confirmed by extracting sequences in which spidroin, ampullate, fibroin, “silk and polypeptide”, or “silk and protein” is described as a keyword in DEFINITION among sequences containing INV as DIVISION among sequence information registered in NCBI GenBank, sequences in which a specific character string of products is described from CDS, or sequences in which a specific character string is described from SOURCE to TISSUE TYPE.

The modified fibroin according to the present embodiment may be modified silk fibroin (in which an amino acid sequence of a silk protein produced by silkworm is modified), or may be modified spider silk fibroin (in which an amino acid sequence of a spider silk protein produced by spiders is modified).

Specific examples of the modified fibroin can include modified fibroin derived from a major dragline silk protein produced in a major ampullate gland of a spider (first modified fibroin), modified fibroin containing a domain sequence in which the content of glycine residues is reduced (second modified fibroin), modified fibroin containing a domain sequence in which the content of an (A)ₙ motif is reduced (third modified fibroin), modified fibroin in which the content of glycine residues and the content of an (A)ₙ motif are reduced (fourth modified fibroin), modified fibroin containing a domain sequence including a region locally having a high hydropathy index (fifth modified fibroin), and modified fibroin containing a domain sequence in which the content of glutamine residues is reduced (sixth modified fibroin).

An example of the first modified fibroin can include a protein containing a domain sequence represented by Formula 1: [(A)ₙ motif-REP]ₘ. In the first modified fibroin, the number of amino acid residues in the (A)ₙ motif is preferably an integer of 3 to 20, more preferably an integer of 4 to 20, still more preferably an integer of 8 to 20, even still more preferably an integer of 10 to 20, still further preferably an integer of 4 to 16, particularly preferably an integer of 8 to 16, and most preferably an integer of 10 to 16. In the first modified fibroin, the number of amino acid residues constituting REP in Formula 1 is preferably 10 to 200 residues, more preferably 10 to 150 residues, and still more preferably 20 to 100 residues, and still even more preferably 20 to 75 residues. In the first modified fibroin, the total number of glycine residues, serine residues, and alanine residues included in the amino acid sequence represented by Formula 1: [(A)ₙ motif-REP]ₘ is preferably 40% or more, more preferably 60% or more, and still more preferably 70% or more, relative to the total number of amino acid residues.

The first modified fibroin may be a polypeptide including an amino acid sequence unit represented by Formula 1: [(A)ₙ motif-REP]ₘ, and including a C-terminal sequence which is an amino acid sequence set forth in any one of SEQ ID NO: 1 to 3 or a C-terminal sequence which is an amino acid sequence having 90% or more homology with the amino acid sequence set forth in any one of SEQ ID NO: 1 to 3.

The amino acid sequence set forth in SEQ ID NO: 1 is identical to an amino acid sequence consisting of 50 amino acid residues of the C-terminus of an amino acid sequence of ADF3 (GI: 1263287, NCBI). The amino acid sequence set forth in SEQ ID NO: 2 is identical to an amino acid sequence set forth in SEQ ID NO: 1 in which 20 amino acid residues have been removed from the C-terminus. The amino acid sequence set forth in SEQ ID NO: 3 is identical to an amino acid sequence set forth in SEQ ID NO: 1 in which 29 amino acid residues have been removed from the C-terminus.

A specific example of the first modified fibroin can include modified fibroin including (1-i) the amino acid sequence set forth in SEQ ID NO: 4 (recombinant spider silk protein ADF3KaiLargeNRSH1), or (1-ii) an amino acid sequence having 90% or more sequence identity with the amino acid sequence set forth in SEQ ID NO: 4. The sequence identity is preferably 95% or more.

The amino acid sequence set forth in SEQ ID NO: 4 is obtained by the following mutation: in an amino acid sequence of ADF3 in which an amino acid sequence (SEQ ID NO: 5) consisting of a start codon, a His 10-tag, and an HRV3C protease (Human rhinovirus 3C protease) recognition site is added to the N-terminus, the 1st to 13th repetitive regions are about doubled and the translation ends at the 1154th amino acid residue. The C-terminal amino acid sequence of the amino acid sequence set forth in SEQ ID NO: 4 is identical to the amino acid sequence set forth in SEQ ID NO: 3.

The modified fibroin of (1-i) may consist of the amino acid sequence set forth in SEQ ID NO: 4.

The domain sequence of the second modified fibroin has an amino acid sequence in which the content of glycine residues is reduced, as compared with naturally derived fibroin. It can be said that the second modified fibroin has an amino acid sequence corresponding to an amino acid sequence in which at least one or a plurality of glycine residues in REP are substituted with another amino acid residue, as compared with naturally derived fibroin.

The domain sequence of the second modified fibroin may have an amino acid sequence corresponding to an amino acid sequence in which one glycine residue in at least one or the plurality of motif sequences is substituted with another amino acid residue, in at least one motif sequence selected from GGX and GPGXX (where G represents a glycine residue, P represents a proline residue, and X represents an amino acid residue other than glycine) in REP, as compared with naturally derived fibroin.

In the second modified fibroin, the proportion of the motif sequence in which the glycine residue has been substituted with another amino acid residue may be 10% or more relative to the entire motif sequence.

The second modified fibroin contains a domain sequence represented by Formula 1: [(A)ₙ motif-REP]ₘ, and may have an amino acid sequence in which z/w is 30% or more, 40% or more, 50% or more, or 50.9% or more in a case where the total number of amino acid residues in the amino acid sequence consisting of XGX (where X represents an amino acid residue other than glycine) included in all REPs in a sequence excluding the sequence from the (A)ₙ motif located at the most C-terminal side to the C-terminus of the domain sequence from the domain sequence is defined as z, and the total number of amino acid residues in the sequence excluding the sequence from the (A)ₙ motif located at the most C-terminal side to the C-terminus of the domain sequence from the domain sequence is defined as w. The number of alanine residues with respect to the total number of amino acid residues in the (A)ₙ motif is 83% or more, preferably 86% or more, more preferably 90% or more, still more preferably 95% or more, and even still more preferably 100% (meaning that the (A)ₙ motif consists of only alanine residues).

The second modified fibroin is preferably one in which the content ratio of the amino acid sequence consisting of XGX is increased by substituting one glycine residue of the GGX motif with another amino acid residue. In the second modified fibroin, the content ratio of the amino acid sequence consisting of GGX in the domain sequence is preferably 30% or less, more preferably 20% or less, still more preferably 10% or less, even still more preferably 6% or less, still further preferably 4% or less, and particularly preferably 2% or less. The content ratio of the amino acid sequence consisting of GGX in the domain sequence can be calculated by the same method as the calculation method of the content ratio (z/w) of the amino acid sequence consisting of XGX described below.

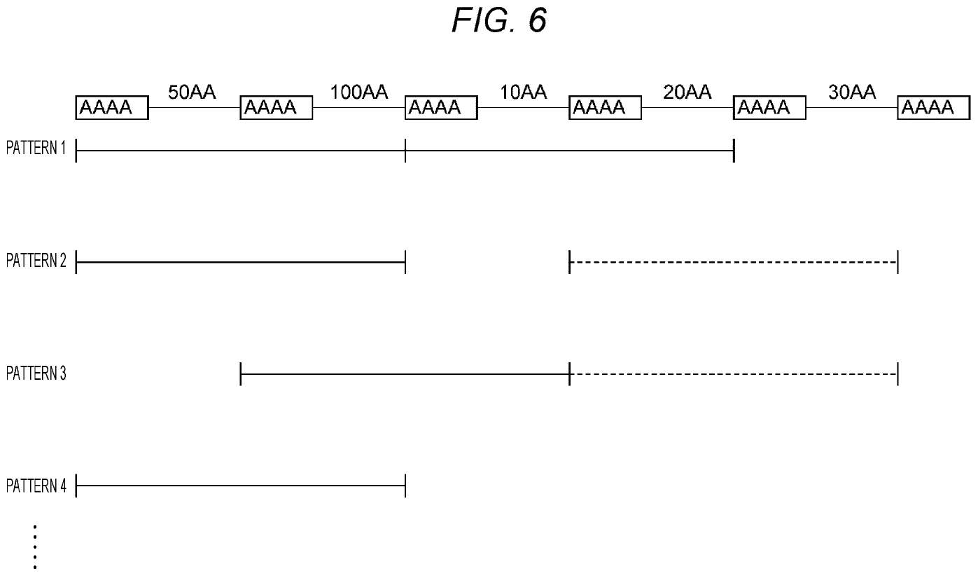

The method of calculating z/w will be described in more detail. First, the amino acid sequence consisting of XGX is extracted from all REPs included in a sequence excluding the sequence from the (A)ₙ motif located at the most C-terminal side to the C-terminus of the domain sequence from the domain sequence in the fibroin containing a domain sequence represented by Formula 1: [(A)ₙ motif-REP]ₘ (modified fibroin or naturally derived fibroin). The total number of amino acid residues constituting XGX is z. For example, in a case where 50 amino acid sequences consisting of XGX are extracted (there is no overlap), z is 50×3=150. Also, for example, in a case where X (central X) included in two XGXs exists as in a case of the amino acid sequence consisting of XGXGX, z is calculated by subtracting the overlapping portion (in a case of XGXGX, it is 5 amino acid residues). w is the total number of amino acid residues included in a sequence excluding the sequence from the (A)n motif located at the most C-terminal side to the C-terminus of the domain sequence from the domain sequence. For example, in a case of the domain sequence illustrated in FIG. 6, w is 4+50+4+100+4+10+4+20+4+30=230 (excluding the (A)ₙ motif located at the most C-terminal side). Next, z/w (%) can be calculated by dividing z by w.

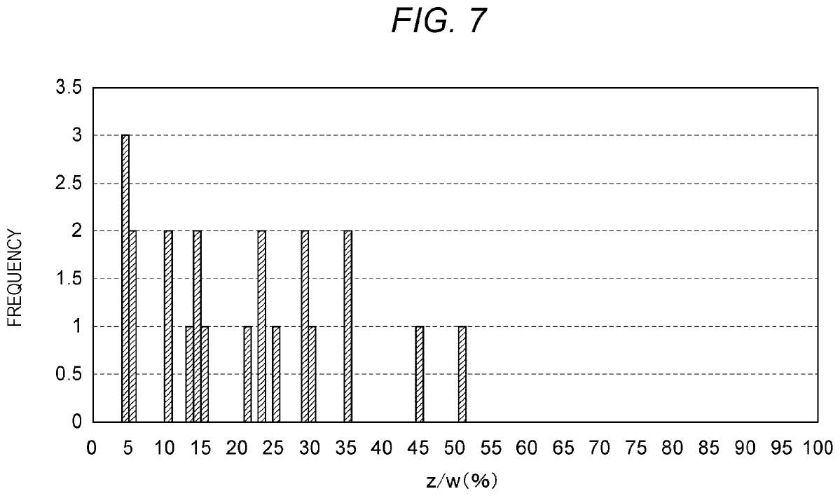

Here, z/w in naturally derived fibroin will be described. First, as described above, 663 types of fibroins (415 types of fibroins derived from spiders among them) were extracted by confirming fibroins with amino acid sequence information registered in NCBI GenBank by an exemplified method. The values of z/w were calculated by the calculation method described above, from amino acid sequences of naturally derived fibroins which contain a domain sequence represented by Formula 1: [(A)n motif-REP]m and in which the content ratio of the amino acid sequence consisting of GGX in the fibroin is 6% or less, among all the extracted fibroins. The results are illustrated in FIG. 7. In FIG. 7, the horizontal axis represents z/w (%), and the vertical axis represents a frequency. As is clear from FIG. 7, the values of z/w in naturally derived fibroin are all smaller than 50.9% (the largest value is 50.86%).

In the second modified fibroin, z/w is preferably 50.9% or more, more preferably 56.1% or more, still more preferably 58.7% or more, even still more preferably 70% or more, and still further preferably 80% or more. The upper limit of z/w is not particularly limited, but may be 95% or less, for example.

The second modified fibroin can be obtained by, for example, substituting and modifying at least a part of a base sequence encoding a glycine residue from a cloned gene sequence of naturally derived fibroin so as to encode another amino acid residue. In this case, one glycine residue in a GGX motif or a GPGXX motif may be selected as the glycine residue to be modified, and substitution may be performed so that z/w is 50.9% or more. In addition, the second modified fibroin can also be obtained by, for example, designing an amino acid sequence satisfying each of the above aspects from the amino acid sequence of naturally derived fibroin, and chemically synthesizing a nucleic acid encoding the designed amino acid sequence. In any case, in addition to the modification corresponding to substitution of a glycine residue in REP with another amino acid residue from the amino acid sequence of naturally derived fibroin, modification of the amino acid sequence corresponding to substitution, deletion, insertion, and/or addition of one or a plurality of amino acid residues may be performed.

The above-described another amino acid residue is not particularly limited as long as it is an amino acid residue other than a glycine residue, but it is preferably a hydrophobic amino acid residue such as a valine (V) residue, a leucine (L) residue, an isoleucine (I) residue, a methionine (M) residue, a proline (P) residue, a phenylalanine (F) residue, or a tryptophan (W) residue, or a hydrophilic amino acid residue such as a glutamine (Q) residue, an asparagine (N) residue, a serine (S) residue, a lysine (K) residue, or a glutamic acid (E) residue, more preferably a valine (V) residue, a leucine (L) residue, an isoleucine (I) residue, a phenylalanine (F) residue, or a glutamine (Q) residue, and still more preferably a glutamine (Q) residue.

A more specific example of the second modified fibroin can include modified fibroin including (2-i) the amino acid sequence set forth in SEQ ID NO: 6 (Met-PRT380), SEQ ID NO: 7 (Met-PRT410), SEQ ID NO: 8 (Met-PRT525), or SEQ ID NO: 9 (Met-PRT799), or (2-ii) an amino acid sequence having 90% or more sequence identity with the amino acid sequence set forth in SEQ ID NO: 6, SEQ ID NO: 7, SEQ ID NO: 8, or SEQ ID NO: 9.

The modified fibroin of (2-i) will be described. The amino acid sequence set forth in SEQ ID NO: 6 is obtained by substituting all GGXs with GQX in REP of the amino acid sequence set forth in SEQ ID NO: 10 (Met-PRT313) corresponding to naturally derived fibroin. The amino acid sequence set forth in SEQ ID NO: 7 is obtained by deleting every other two (A)ₙ motifs from the N-terminal side to the C-terminal side from the amino acid sequence set forth in SEQ ID NO: 6 and further inserting one [(A)ₙ motif-REP] before the C-terminal sequence. The amino acid sequence set forth in SEQ ID NO: 8 is obtained by inserting two alanine residues on the C-terminal side of each (A)ₙ motif of the amino acid sequence set forth in SEQ ID NO: 7 and further substituting a part of glutamine (Q) residues with a serine (S) residue to delete a part of amino acids on the C-terminal side so as to be almost the same as the molecular weight of SEQ ID NO: 7. The amino acid sequence set forth in SEQ ID NO: 9 is obtained by adding a predetermined hinge sequence and a His tag sequence to the C-terminus of a sequence obtained by repeating a region of 20 domain sequences (where several amino acid residues on the C-terminal side of the region are substituted) present in the amino acid sequence set forth in SEQ ID NO: 7 four times.

The value of z/w in the amino acid sequence set forth in SEQ ID NO: 10 (corresponding to naturally derived fibroin) is 46.8%. The values of z/w in the amino acid sequence set forth in SEQ ID NO: 6, the amino acid sequence set forth in SEQ ID NO: 7, the amino acid sequence set forth in SEQ ID NO: 8, and the amino acid sequence set forth in SEQ ID NO: 9 are 58.7%, 70.1%, 66.1%, and 70.0%, respectively. In addition, the values of x/y in the amino acid sequences set forth in SEQ ID NO: 10, SEQ ID NO: 6, SEQ ID NO: 7, SEQ ID NO: 8, and SEQ ID NO: 9 at a Giza ratio (described below) of 1:1.8 to 11.3 are 15.0%, 15.0%, 93.4%, 92.7%, and 89.8%, respectively.

The modified fibroin of (2-i) may consist of the amino acid sequence set forth in SEQ ID NO: 6, SEQ ID NO: 7, SEQ ID NO: 8, or SEQ ID NO: 9.

The modified fibroin of (2-ii) includes an amino acid sequence having 90% or more sequence identity with the amino acid sequence set forth in SEQ ID NO: 6, SEQ ID NO: 7, SEQ ID NO: 8, or SEQ ID NO: 9. The modified fibroin of (2-ii) is also a protein containing a domain sequence represented by Formula 1: [(A)ₙ motif-REP]ₘ. The sequence identity is preferably 95% or more.

It is preferable that the modified fibroin of (2-ii) preferably has 90% or more sequence identity with the amino acid sequence set forth in SEQ ID NO: 6, SEQ ID NO: 7, SEQ ID NO: 8, or SEQ ID NO: 9, and z/w is 50.9% or more in a case where the total number of amino acid residues in the amino acid sequence consisting of XGX (where X represents an amino acid residue other than glycine) included in REP is defined as z, and the total number of amino acid residues of REP in the domain sequence is defined as w.

The second modified fibroin may have a tag sequence at either or both of the N-terminus and the C-terminus. This enables the modified fibroin to be isolated, immobilized, detected, and visualized.

The tag sequence may be, for example, an affinity tag utilizing specific affinity (binding property, affinity) with another molecule. A specific example of the affinity tag includes a histidine tag (His tag). The His tag is a short peptide in which about 4 to 10 histidine residues are arranged and has a property of specifically binding to a metal ion such as nickel. Thus, the His tag can be used for isolation of modified fibroin by chelating metal chromatography. A specific example of the tag sequence can include the amino acid sequence set forth in SEQ ID NO: 11 (amino acid sequence including a His tag sequence and a hinge sequence).

Also, a tag sequence such as glutathione-S-transferase (GST) that specifically binds to glutathione, and a maltose binding protein (MBP) that specifically binds to maltose can also be utilized.

Further, an “epitope tag” utilizing an antigen-antibody reaction can also be utilized. Adding a peptide (epitope) exhibiting antigenicity as a tag sequence allows an antibody against the epitope to be bound. Examples of the epitope tag include an HA (peptide sequence of hemagglutinin of influenza virus) tag, a myc tag, and a FLAG tag. The modified fibroin can easily be purified with high specificity by utilizing an epitope tag.

Moreover, it is possible to use a tag sequence which can be cleaved with a specific protease. The modified fibroin from which the tag sequence has been cleaved can be recovered by treating a protein adsorbed through the tag sequence with protease.

A more specific example of the modified fibroin including a tag sequence can include modified fibroin including (2-iii) the amino acid sequence set forth in SEQ ID NO: 12 (PRT380), SEQ ID NO: 13 (PRT410), SEQ ID NO: 14 (PRT525), or SEQ ID NO: 15 (PRT799), or (2-iv) an amino acid sequence having 90% or more sequence identity with the amino acid sequence set forth in SEQ ID NO: 12, SEQ ID NO: 13, SEQ ID NO: 14, or SEQ ID NO: 15.

Each of the amino acid sequences set forth in SEQ ID NO: 16 (PRT313), SEQ ID NO: 12, SEQ ID NO: 13, SEQ ID NO: 14, and SEQ ID NO: 15 is obtained by adding the amino acid sequence set forth in SEQ ID NO: 11 (including a His tag sequence and a hinge sequence) to the N-terminus of each of the amino acid sequences set forth in SEQ ID NO: 10, SEQ ID NO: 6, SEQ ID NO: 7, SEQ ID NO: 8, and SEQ ID NO: 9.

The modified fibroin of (2-iii) may consist of the amino acid sequence set forth in SEQ ID NO: 12, SEQ ID NO: 13, SEQ ID NO: 14, or SEQ ID NO: 15.

The modified fibroin of (2-iv) includes an amino acid sequence having 90% or more sequence identity with the amino acid sequence set forth in SEQ ID NO: 12, SEQ ID NO: 13, SEQ ID NO: 14, or SEQ ID NO: 15. The modified fibroin of (2-iv) is also a protein containing a domain sequence represented by Formula 1: [(A)ₙ motif-REP]ₘ. The sequence identity is preferably 95% or more.

It is preferable that the modified fibroin of (2-iv) has 90% or more sequence identity with the amino acid sequence set forth in SEQ ID NO: 12, SEQ ID NO: 13, SEQ ID NO: 14, or SEQ ID NO: 15, and z/w is 50.9% or more in a case where the total number of amino acid residues in the amino acid sequence consisting of XGX (where X represents the amino acid residue other than glycine) in REP is defined as z, and the total number of amino acid residues in REP in the domain sequence is defined as w.

The second modified fibroin may include a secretory signal for releasing the protein produced in the recombinant protein production system to the outside of a host. The sequence of the secretory signal can be appropriately set depending on the type of the host.

The domain sequence of the third modified fibroin has an amino acid sequence in which the content of the (A)ₙ motif is reduced, as compared with naturally derived fibroin. It can be said that the domain sequence of the third modified fibroin has an amino acid sequence corresponding to an amino acid sequence in which at least one or a plurality of (A)ₙ motifs are deleted, as compared with naturally derived fibroin.

The third modified fibroin may have an amino acid sequence corresponding to an amino acid sequence in which 10 to 40% of the (A)ₙ motifs are deleted from naturally derived fibroin.

The domain sequence of the third modified fibroin may have an amino acid sequence corresponding to an amino acid sequence in which at least one (A)ₙ motif of every one to three (A)ₙ motifs is deleted from the N-terminal side to the C-terminal side, as compared with naturally derived fibroin.

The third modified fibroin may have an amino acid sequence corresponding to an amino acid sequence in which deletion of at least two consecutive (A)ₙ motifs and deletion of one (A)ₙ motif are repeated in this order from the N-terminal side to the C-terminal side, as compared with naturally derived fibroin.

The third modified fibroin may have a domain sequence having an amino acid sequence corresponding to an amino acid sequence in which at least (A)ₙ motif every other two positions is deleted from the N-terminal side to the C-terminal side.

The third modified fibroin contains a domain sequence represented by Formula 1: [(A)ₙ motif-REP]ₘ, and may have an amino acid sequence in which x/y is 20% or more, 30% or more, 40% or more, or 50% or more in a case where the numbers of amino acid residues in REPs of two adjacent [(A)ₙ motif-REP] units are sequentially compared from the N-terminal side to the C-terminal side, and the number of amino acid residues in one REP having a smaller number of amino acid residues is defined as 1, the maximum value of the total value of the number of amino acid residues in the two adjacent [(A)ₙ motif-REP] units where the ratio of the number of amino acid residues in the other REP is 1.8 to 11.3 is defined as x, and the total number of amino acid residues in the domain sequence is defined as y. The number of alanine residues with respect to the total number of amino acid residues in the (A)ₙ motif is 83% or more, preferably 86% or more, more preferably 90% or more, still more preferably 95% or more, and even still more preferably 100% (meaning that the (A)ₙ motif consists of only alanine residues).

The method of calculating x/y will be described in more detail with reference to FIG. 6. FIG. 6 illustrates a domain sequence excluding the N-terminal sequence and the C-terminal sequence from the modified fibroin. The domain sequence has a sequence of (A)ₙ motif-first REP (50 amino acid residues)-(A)ₙ motif-second REP (100 amino acid residues)-(A)ₙ motif-third REP (10 amino acid residues)-(A)ₙ motif-fourth REP (20 amino acid residues)-(A)ₙ motif-fifth REP (30 amino acid residues)-(A)ₙ motif from the N-terminal side (left side).

The two adjacent [(A)ₙ motif-REP] units are sequentially selected from the N-terminal side to the C-terminal side so as not to overlap. At this time, an unselected [(A)ₙ motif-REP] unit may exist. FIG. 6 illustrates a pattern 1 (a comparison between the first REP and the second REP, and a comparison between the third REP and the fourth REP), a pattern 2 (a comparison between the first REP and the second REP, and a comparison between the fourth REP and the fifth REP), a pattern 3 (a comparison between the second REP and the third REP, and a comparison between the fourth REP and the fifth REP), and a pattern 4 (a comparison between the first REP and the second REP). There are other selection methods besides this.

Subsequently, the number of amino acid residues of each REP in the selected two adjacent [(A)ₙ motif-REP] units is compared for each pattern. The comparison is performed by determining the ratio of the number of amino acid residues of the other REP in a case where one REP having a smaller number of amino acid residues is defined as 1. For example, in a case of comparing the first REP (50 amino acid residues) and the second REP (100 amino acid residues), the ratio of the number of amino acid residues of the second REP is 100/50=2 in a case where the first REP having a smaller number of amino acid residues is defined as 1. Similarly, in a case of comparing the fourth REP (20 amino acid residues) and the fifth REP (30 amino acid residues), the ratio of the number of amino acid residues of the fifth REP is 30/20=1.5 in a case where the fourth REP having a smaller number of amino acid residues is defined as 1.

In FIG. 6, a set of [(A)ₙ motif-REP] units in which the ratio of the number of amino acid residues of the other REP is 1.8 to 11.3 in a case where one REP having a smaller number of amino acid residues is defined as 1 is indicated by a solid line. In the present specification, the ratio is referred to as a Giza ratio. A set of [(A)ₙ motif-REP] units in which the ratio of the number of amino acid residues of the other REP is less than 1.8 or more than 11.3 in a case where one REP having a smaller number of amino acid residues is defined as 1 is indicated by a broken line.

In each pattern, the number of all amino acid residues of two adjacent [(A)ₙ motif-REP] units indicated by solid lines (including not only the number of amino acid residues of REP but also the number of amino acid residues of the (A)n motif) is combined. Then, the total values combined are compared, and the total value of the pattern whose total value is the maximum (the maximum value of the total value) is defined as x. In the example illustrated in FIG. 6, the total value of the pattern 1 is the maximum.

Then, x/y (%) can be calculated by dividing x by the total number of amino acid residues y of the domain sequence.

In the third modified fibroin, x/y is preferably 50% or more, more preferably 60% or more, still more preferably 65% or more, even still more preferably 70% or more, still further preferably 75% or more, and particularly preferably 80% or more. The upper limit of x/y is not particularly limited, but may be, for example, 100% or less. In a case where the Giza ratio is 1:1.9 to 11.3, x/y is preferably 89.6% or more; in a case where the Giza ratio is 1:1.8 to 3.4, x/y is preferably 77.1% or more; in a case where the Giza ratio is 1:1.9 to 8.4, x/y is preferably 75.9% or more; and in a case where the Giza ratio is 1:1.9 to 4.1, x/y is preferably 64.2% or more.

In a case where the third modified fibroin is modified fibroin in which at least seven of a plurality of (A)ₙ motifs in the domain sequence consist of only alanine residues, x/y is preferably 46.4% or more, more preferably 50% or more, still more preferably 55% or more, even still more preferably 60% or more, still further preferably 70% or more, and particularly preferably 80% or more. The upper limit of x/y is not particularly limited, but is only required to be 100% or less.

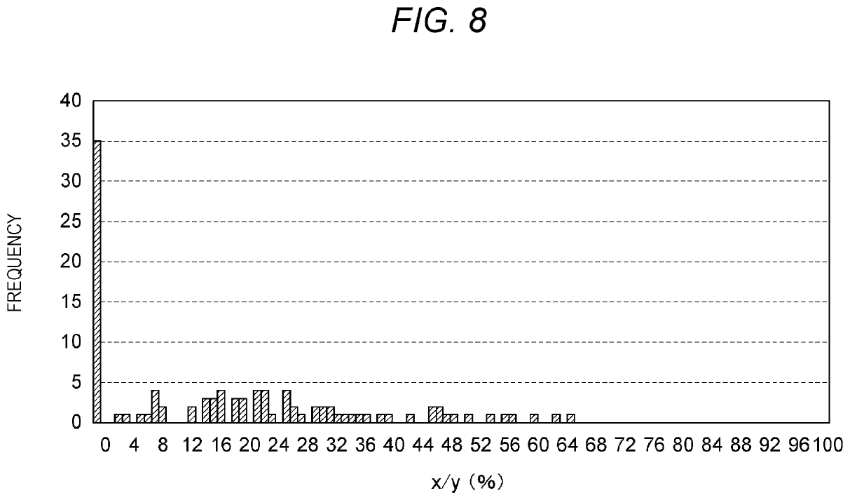

Here, x/y in naturally derived fibroin will be described. First, as described above, 663 types of fibroins (415 types of fibroins derived from spiders among them) were extracted by confirming fibroins with amino acid sequence information registered in NCBI GenBank by an exemplified method. The values of x/y were calculated by the calculation method described above, from amino acid sequences of naturally derived fibroins consisting of a domain sequence represented by Formula 1: [(A)ₙ motif-REP]ₘ, among all the extracted fibroins. The results in a case where the Giza ratio is 1:1.9 to 4.1 are illustrated in FIG. 8.

The horizontal axis in FIG. 8 represents x/y (%), and the vertical axis represents a frequency. As is clear from FIG. 8, the values of x/y in naturally derived fibroin are all smaller than 64.2% (the largest value is 64.14%).

The third modified fibroin can be obtained from, for example, a cloned gene sequence of naturally derived fibroin, by deleting one or a plurality of sequences encoding an (A)ₙ motif so that x/y is 64.2% or more. In addition, for example, the third modified fibroin can also be obtained, from the amino acid sequence of naturally derived fibroin, by designing an amino acid sequence corresponding to an amino acid sequence in which one or a plurality of (A)ₙ motifs are deleted so that x/y is 64.2% or more, and chemically synthesizing a nucleic acid encoding the designed amino acid sequence. In any case, in addition to the modification corresponding to deletion of the (A)ₙ motif from the amino acid sequence of naturally derived fibroin, modification of the amino acid sequence corresponding to substitution, deletion, insertion, and/or addition of one or a plurality of amino acid residues may be performed.

A more specific example of the third modified fibroin can include modified fibroin including (3-i) the amino acid sequence set forth in SEQ ID NO: 17 (Met-PRT399), SEQ ID NO: 7 (Met-PRT410), SEQ ID NO: 8 (Met-PRT525), or SEQ ID NO: 9 (Met-PRT799), or (3-ii) an amino acid sequence having 90% or more sequence identity with the amino acid sequence set forth in SEQ ID NO: 17, SEQ ID NO: 7, SEQ ID NO: 8, or SEQ ID NO: 9.

The modified fibroin of (3-i) will be described. The amino acid sequence set forth in SEQ ID NO: 17 is obtained by deleting every other two (A)ₙ motifs from the N-terminal side to the C-terminal side from the amino acid sequence set forth in SEQ ID NO: 10 (Met-PRT313) corresponding to naturally derived fibroin and further inserting one [(A)ₙ motif-REP] before the C-terminal sequence. The amino acid sequence set forth in SEQ ID NO: 7, SEQ ID NO: 8, or SEQ ID NO: 9 is as described in the second modified fibroin.

The value of x/y in the amino acid sequence set forth in SEQ ID NO: 10 (corresponding to naturally derived fibroin) at a Giza ratio of 1:1.8 to 11.3 is 15.0%. Both the value of x/y in the amino acid sequence set forth in SEQ ID NO: 17 and the value of x/y in the amino acid sequence set forth in SEQ ID NO: 7 are 93.4%. The value of x/y in the amino acid sequence set forth in SEQ ID NO: 8 is 92.7%. The value of x/y in the amino acid sequence set forth in SEQ ID NO: 9 is 89.8%. The values of z/w in the amino acid sequences set forth in SEQ ID NO: 10, SEQ ID NO: 17, SEQ ID NO: 7, SEQ ID NO: 8, and SEQ ID NO: 9 are 46.8%, 56.2%, 70.1%, 66.1%, and 70.0%, respectively.

The modified fibroin of (3-i) may consist of the amino acid sequence set forth in SEQ ID NO: 17, SEQ ID NO: 7, SEQ ID NO: 8, or SEQ ID NO: 9.

The modified fibroin of (3-ii) includes an amino acid sequence having 90% or more sequence identity with the amino acid sequence set forth in SEQ ID NO: 17, SEQ ID NO: 7, SEQ ID NO: 8, or SEQ ID NO: 9. The modified fibroin of (3-ii) is also a protein containing a domain sequence represented by Formula 1: [(A)ₙ motif-REP]ₘ. The sequence identity is preferably 95% or more.

It is preferable that the modified fibroin of (3-ii) has 90% or more sequence identity with the amino acid sequence set forth in SEQ ID NO: 17, SEQ ID NO: 7, SEQ ID NO: 8, or SEQ ID NO: 9, and x/y is 64.2% or more in a case where the numbers of amino acid residues in REPs of two adjacent [(A)ₙ motif-REP] units are sequentially compared from the N-terminal side to the C-terminal side, and the number of amino acid residues in one REP having a small number of amino acid residues is defined as 1, the maximum value of the total value of the number of amino acid residues in the two adjacent [(A)ₙ motif-REP] units where the ratio of the number of amino acid residues in the other REP is 1.8 to 11.3 (the Giza ratio is 1:1.8 to 11.3) is defined as x, and the total number of amino acid residues in the domain sequence is defined as y.

The third modified fibroin may include the above-described tag sequence at either or both of the N-terminus and the C-terminus.

A more specific example of the modified fibroin including a tag sequence can include modified fibroin including (3-iii) the amino acid sequence set forth in SEQ ID NO: 18 (PRT399), SEQ ID NO: 13 (PRT410), SEQ ID NO: 14 (PRT525), or SEQ ID NO: 15 (PRT799), or (3-iv) an amino acid sequence having 90% or more sequence identity with the amino acid sequence set forth in SEQ ID NO: 18, SEQ ID NO: 13, SEQ ID NO: 14, or SEQ ID NO: 15.

Each of the amino acid sequences set forth in SEQ ID NO: 18, SEQ ID NO: 13, SEQ ID NO: 14, and SEQ ID NO: 15 is obtained by adding the amino acid sequence set forth in SEQ ID NO: 11 (including a His tag sequence and a hinge sequence) to the N-terminus of each of the amino acid sequences set forth in SEQ ID NO: 17, SEQ ID NO: 7, SEQ ID NO: 8, and SEQ ID NO: 9.

The modified fibroin of (3-iii) may consist of the amino acid sequence set forth in SEQ ID NO: 18, SEQ ID NO: 13, SEQ ID NO: 14, or SEQ ID NO: 15.

The modified fibroin of (3-iv) includes an amino acid sequence having 90% or more sequence identity with the amino acid sequence set forth in SEQ ID NO: 18, SEQ ID NO: 13, SEQ ID NO: 14, or SEQ ID NO: 15. The modified fibroin of (3-iv) is also a protein containing a domain sequence represented by Formula 1: [(A)ₙ motif-REP]ₘ. The sequence identity is preferably 95% or more.

It is preferable that the modified fibroin of (3-iv) has 90% or more sequence identity with the amino acid sequence set forth in SEQ ID NO: 18, SEQ ID NO: 13, SEQ ID NO: 14, or SEQ ID NO: 15, and x/y is 64.2% or more in a case where the number of amino acid residues in REPs in two adjacent [(A)ₙ motif-REP] units are sequentially compared from the N-terminal side to the C-terminal side, and the number of amino acid residues in one REP having a small number of amino acid residues is defined as 1, the maximum value of the total value of the number of amino acid residues in the two adjacent [(A)ₙ motif-REP] units where the ratio of the number of amino acid residues in the other REP is 1.8 to 11.3 is defined as x, and the total number of amino acid residues in the domain sequence is defined as y.

The third modified fibroin may include a secretory signal for releasing the protein produced in the recombinant protein production system to the outside of a host. The sequence of the secretory signal can be appropriately set depending on the type of the host.

The domain sequence of the fourth modified fibroin has an amino acid sequence in which the content of an (A)ₙ motif and the content of glycine residues are reduced, as compared with naturally derived fibroin. It can be said that the domain sequence of the fourth modified fibroin has an amino acid sequence corresponding to an amino acid sequence in which at least one or a plurality of (A)ₙ motifs are deleted and at least one or a plurality of glycine residues in REP are substituted with another amino acid residue, as compared with naturally derived fibroin. That is, the fourth modified fibroin is modified fibroin having the characteristics of the above-described second modified fibroin and third modified fibroin. Specific aspects thereof and the like are as in the descriptions for the second modified fibroin and the third modified fibroin.

A more specific example of the fourth modified fibroin can include modified fibroin including (4-i) the amino acid sequence set forth in SEQ ID NO: 7 (Met-PRT410), SEQ ID NO: 8 (Met-PRT525), SEQ ID NO: 9 (Met-PRT799), SEQ ID NO: 13 (PRT410), SEQ ID NO: 14 (PRT525), or SEQ ID NO: 15 (PRT799), or (4-ii) an amino acid sequence having 90% or more sequence identity with the amino acid sequence set forth in SEQ ID NO: 7, SEQ ID NO: 8, SEQ ID NO: 9, SEQ ID NO: 13, SEQ ID NO: 14, or SEQ ID NO: 15. Specific aspects of the modified fibroin including the amino acid sequence set forth in SEQ ID NO: 7, SEQ ID NO: 8, SEQ ID NO: 9, SEQ ID NO: 13, SEQ ID NO: 14, or SEQ ID NO: 15 are as described above.

The domain sequence of the fifth modified fibroin may have an amino acid sequence including a region locally having a high hydropathy index corresponding to an amino acid sequence in which one or a plurality of amino acid residues in REP are substituted with amino acid residues having a high hydropathy index and/or one or a plurality of amino acid residues having a high hydropathy index are inserted into REP, as compared with naturally derived fibroin.

The region locally having a high hydropathy index preferably consists of consecutive two to four amino acid residues.

The above-described amino acid residue having a high hydropathy index is more preferably an amino acid residue selected from isoleucine (I), valine (V), leucine (L), phenylalanine (F), cysteine (C), methionine (M), and alanine (A).

The fifth modified fibroin may be further subjected to modification of an amino acid sequence corresponding to substitution, deletion, insertion, and/or addition of one or a plurality of amino acid residues as compared with naturally derived fibroin, in addition to modification corresponding to substitution of one or a plurality of amino acid residues in REP with amino acid residues having a high hydropathy index and/or insertion of one or a plurality of amino acid residues having a high hydropathy index into REP, as compared with naturally derived fibroin.

The fifth modified fibroin can be obtained by, for example, substituting one or a plurality of hydrophilic amino acid residues in REP (for example, amino acid residues having a negative hydropathy index) with hydrophobic amino acid residues (for example, amino acid residues having a positive hydropathy index) from a cloned gene sequence of naturally derived fibroin, and/or inserting one or a plurality of hydrophobic amino acid residues into REP. In addition, the fifth modified fibroin can be obtained by, for example, designing an amino acid sequence corresponding to an amino acid sequence in which one or a plurality of hydrophilic amino acid residues in REP are substituted with hydrophobic amino acid residues from an amino acid sequence of naturally derived fibroin, and/or one or a plurality of hydrophobic amino acid residues are inserted into REP, and chemically synthesizing a nucleic acid encoding the designed amino acid sequence. In any case, in addition to modification corresponding to substitution of one or a plurality of hydrophilic amino acid residues in REP with hydrophobic amino acid residues from an amino acid sequence of naturally derived fibroin, and/or insertion of one or a plurality of hydrophobic amino acid residues into REP, modification of an amino acid sequence corresponding to substitution, deletion, insertion, and/or addition of one or a plurality of amino acid residues may be further performed.

The fifth modified fibroin contains a domain sequence represented by Formula 1: [(A)ₙ motif-REP]ₘ, and may have an amino acid sequence in which p/q is 6.2% or more in a case where in all REPs included in a sequence excluding the sequence from the (A)ₙ motif located at the most C-terminal side to the C-terminus of the domain sequence from the domain sequence, the total number of amino acid residues included in a region where the average value of hydropathy indices of four consecutive amino acid residues is 2.6 or more is defined as p, and the total number of amino acid residues included in the sequence excluding the sequence from the (A)ₙ motif located at the most C-terminal side to the C-terminus of the domain sequence from the domain sequence is defined as q.

For the hydropathy index of the amino acid residue, a publicly known index (Hydropathy index: Kyte J, & Doolittle R (1982) “A simple method for displaying the hydropathic character of a protein”, J. Mol. Biol., 157, pp. 105-132) is used. Specifically, the hydropathy index (hereinafter, also referred to as “HI”) of each amino acid is as shown in Table 1.

TABLE 1

| Amino acid | HI |
|---|---|
| Isoleucine (Ile) | 4.5 |
| Valine (Val) | 4.2 |
| Leucine (Leu) | 3.8 |
| Phenylalanine (Phe) | 2.8 |
| Cysteine (Cys) | 2.5 |
| Methionine (Met) | 1.9 |
| Alanine (Ala) | 1.8 |
| Glycine (Gly) | −0.4 |
| Threonine (Thr) | −0.7 |
| Serine (Ser) | −0.8 |
| Tryptophan (Trp) | −0.9 |
| Tyrosine (Tyr) | −1.3 |
| Proline (Pro) | −1.6 |
| Histidine (His) | −3.2 |
| Asparagine (Asn) | −3.5 |
| Asparatic Acid (Asp) | −3.5 |
| Glutamine (Gln) | −3.5 |
| Glutamic Acid (Glu) | −3.5 |
| Lysine (Lys) | −3.9 |
| Arginine (Arg) | −4.5 |

The method of calculating p/q will be described in more detail. In the calculation, a sequence excluding the sequence from the (A)ₙ motif located at the most C-terminal side to the C-terminus of the domain sequence from the domain sequence represented by Formula 1 [(A)ₙ motif-REP]ₘ (hereinafter also referred to as “sequence A”) is used. First, in all REPs included in the sequence A, the average values of hydropathy indices of four consecutive amino acid residues are calculated. The average value of hydropathy indices is determined by dividing the sum of HIs of respective amino acid residues included in the four consecutive amino acid residues by 4 (number of amino acid residues). The average value of hydropathy indices is determined for all of the four consecutive amino acid residues (each of the amino acid residues is used for calculating the average value 1 to 4 times). Then, a region where the average value of hydropathy indices of the four consecutive amino acid residues is 2.6 or more is specified. Even in a case where a certain amino acid residue corresponds to the “four consecutive amino acid residues having an average value of hydropathy indices of 2.6 or more” multiple times, the amino acid residue is included as one amino acid residue in the region. The total number of amino acid residues included in the region is p. Also, the total number of amino acid residues included in the sequence A is q.

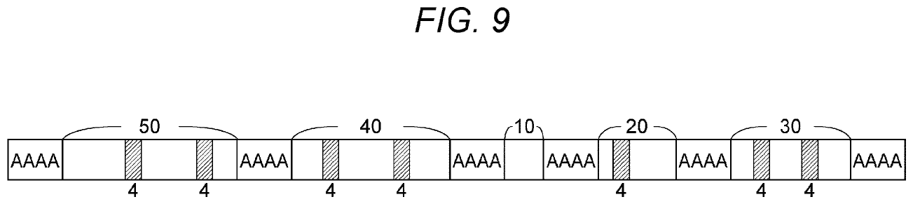

For example, in a case where the “four consecutive amino acid residues having an average value of hydropathy indices of 2.6 or more” are extracted from 20 places (no overlap), in the region where the average value of hydropathy indices of four consecutive amino acid residues is 2.6 or more, 20 of the four consecutive amino acid residues (no overlap) are included, and thus p is 20×4=80. Further, for example, in a case where two of the “four consecutive amino acid residues having an average value of hydropathy indices of 2.6 or more” overlap by one amino acid residue, in the region where the average value of hydropathy indices of the four consecutive amino acid residues is 2.6 or more, seven amino acid residues are included (p=2×4−1=7. “−1” is the deduction of the overlapping portion). For example, in a case of the domain sequence illustrated in FIG. 9, seven sets of “four consecutive amino acid residues having an average value of hydropathy indices of 2.6 or more” are present without overlaps, and thus, p is 7×4=28. Furthermore, for example, in the case of the domain sequence illustrated in FIG. 9, q is 4+50+4+40+4+10+4+20+4+30=170 (the (A)ₙ motif located at the end of the C-terminal side is excluded). Next, p/q (%) can be calculated by dividing p by q. In the case of FIG. 9, p/q is 28/170=16.47%.

In the fifth modified fibroin, p/q is preferably 6.2% or more, more preferably 7% or more, still more preferably 10% or more, even still more preferably 20% or more, and still further preferably 30% or more. The upper limit of p/q is not particularly limited, but may be 45% or less, for example.

The fifth modified fibroin can be obtained by, for example, substituting one or a plurality of hydrophilic amino acid residues in REP (for example, amino acid residues having a negative hydropathy index) with hydrophobic amino acid residues (for example, amino acid residues having a positive hydropathy index) so that a cloned amino acid sequence of naturally derived fibroin satisfies the condition of p/q, and/or modifying the cloned amino acid sequence of naturally derived fibroin into an amino acid sequence including a region locally having a high hydropathy index by inserting one or a plurality of hydrophobic amino acid residues into REP. In addition, the fifth modified fibroin can also be obtained by, for example, designing an amino acid sequence satisfying the condition of p/q from the amino acid sequence of naturally derived fibroin, and chemically synthesizing a nucleic acid encoding the designed amino acid sequence. In any case, modification corresponding to substitution, deletion, insertion, and/or addition of one or a plurality of amino acid residues may also be performed, in addition to modification corresponding to substitution of one or a plurality of amino acid residues in REP with amino acid residues having a high hydropathy index, and/or insertion of one or a plurality of amino acid residues having a high hydropathy index into REP, as compared with naturally derived fibroin.

The amino acid residue having a high hydropathy index is not particularly limited, but is preferably isoleucine (I), valine (V), leucine (L), phenylalanine (F), cysteine (C), methionine (M), and alanine (A), and more preferably valine (V), leucine (L), and isoleucine (I).

A more specific example of the fifth modified fibroin can include modified fibroin including (5-i) the amino acid sequence set forth in SEQ ID NO: 19 (Met-PRT720), SEQ ID NO: 20 (Met-PRT665), or SEQ ID NO: 21 (Met-PRT666), or (5-ii) an amino acid sequence having 90% or more sequence identity with the amino acid sequence set forth in SEQ ID NO: 19, SEQ ID NO: 20, or SEQ ID NO: 21.

The modified fibroin of (5-i) will be described. The amino acid sequence set forth in SEQ ID NO: 19 is obtained by inserting an amino acid sequence consisting of three amino acid residues (VLI) at two sites for each REP into the amino acid sequence set forth in SEQ ID NO: 7 (Met-PRT410), except for the domain sequence at the end on the C-terminal side, and further substituting a part of glutamine (Q) residues with serine (S) residues, and deleting a part of amino acids on the C-terminal side. The amino acid sequence set forth in SEQ ID NO: 20 is obtained by inserting the amino acid sequence consisting of three amino acid residues (VLI) at one site for each REP into the amino acid sequence set forth in SEQ ID NO: 8 (Met-PRT525). The amino acid sequence set forth in SEQ ID NO: 21 is obtained by inserting the amino acid sequence consisting of three amino acid residues (VLI) at two sites for each REP into the amino acid sequence set forth in SEQ ID NO: 8.

The modified fibroin of (5-i) may consist of the amino acid sequence set forth in SEQ ID NO: 19, SEQ ID NO: 20, or SEQ ID NO: 21.

The modified fibroin of (5-ii) includes an amino acid sequence having 90% or more sequence identity with the amino acid sequence set forth in SEQ ID NO: 19, SEQ ID NO: 20, or SEQ ID NO: 21. The modified fibroin of (5-ii) is also a protein containing a domain sequence represented by Formula 1: [(A)ₙ motif-REP]ₘ. The sequence identity is preferably 95% or more.

It is preferable that the modified fibroin of (5-ii) has 90% or more sequence identity with the amino acid sequence set forth in SEQ ID NO: 19, SEQ ID NO: 20, or SEQ ID NO: 21, and p/q is 6.2% or more in a case where in all REPs included in a sequence excluding the sequence from the (A)ₙ motif located at the most C-terminal side to the C-terminus of the domain sequence from the domain sequence, the total number of amino acid residues included in a region where the average value of hydropathy indices of four consecutive amino acid residues is 2.6 or more is defined as p, and the total number of amino acid residues included in the sequence excluding the sequence from the (A)ₙ motif located at the most the C-terminal side to the C-terminus of the domain sequence from the domain sequence is defined as q.

The fifth modified fibroin may include a tag sequence at either or both of the N-terminus and the C-terminus.

A more specific example of the modified fibroin including a tag sequence can include modified fibroin including (5-iii) the amino acid sequence set forth in SEQ ID NO: 22 (PRT720), SEQ ID NO: 23 (PRT665), or SEQ ID NO: 24 (PRT666), or (5-iv) an amino acid sequence having 90% or more sequence identity with the amino acid sequence set forth in SEQ ID NO: 22, SEQ ID NO: 23, or SEQ ID NO: 24.

Each of the amino acid sequences set forth in SEQ ID NO: 22, SEQ ID NO: 23, and SEQ ID NO: 24 is obtained by adding the amino acid sequence set forth in SEQ ID NO: 11 (including a His tag sequence and a hinge sequence) to the N-terminus of each of the amino acid sequences set forth in SEQ ID NO: 19, SEQ ID NO: 20, and SEQ ID NO: 21.

The modified fibroin of (5-iii) may consist of the amino acid sequence set forth in SEQ ID NO: 22, SEQ ID NO: 23, or SEQ ID NO: 24.

The modified fibroin of (5-iv) includes an amino acid sequence having 90% or more sequence identity with the amino acid sequence set forth in SEQ ID NO: 22, SEQ ID NO: 23, or SEQ ID NO: 24. The modified fibroin of (5-iv) is also a protein containing a domain sequence represented by Formula 1: [(A)ₙ motif-REP]ₘ. The sequence identity is preferably 95% or more.

It is preferable that the modified fibroin of (5-iv) has 90% or more sequence identity with the amino acid sequence set forth in SEQ ID NO: 22, SEQ ID NO: 23, or SEQ ID NO: 24, and p/q is 6.2% or more in a case where in all REPs included in a sequence excluding the sequence from the (A)ₙ motif located at the most C-terminal side to the C-terminus of the domain sequence from the domain sequence, the total number of amino acid residues included in a region where the average value of hydropathy indices of four consecutive amino acid residues is 2.6 or more is defined as p, and the total number of amino acid residues included in the sequence excluding the sequence from the (A)ₙ motif located at the most C-terminal side to the C-terminus of the domain sequence from the domain sequence is defined as q.

The fifth modified fibroin may include a secretory signal for releasing the protein produced in the recombinant protein production system to the outside of a host. The sequence of the secretory signal can be appropriately set depending on the type of the host.

The sixth modified fibroin has an amino acid sequence in which the content of glutamine residues is reduced, as compared with naturally derived fibroin.

In the sixth modified fibroin, at least one motif selected from a GGX motif and a GPGXX motif is preferably included in the amino acid sequence of REP.

In a case where the sixth modified fibroin has the GPGXX motif in REP, a content rate of the GPGXX motif is usually 1% or more, may also be 5% or more, and preferably 10% or more. The upper limit of the content rate of the GPGXX motif is not particularly limited, and may be 50% or less, or may also be 30% or less.

In the present specification, the “content rate of the GPGXX motif” is a value calculated by the following method.

The content rate of the GPGXX motif in fibroin (modified fibroin or naturally derived fibroin) containing a domain sequence represented by Formula 1: [(A)ₙ motif-REP]ₘ or Formula 2: [(A)ₙ motif-REP]ₘ-(A)ₙ motif is calculated as s/t, in a case where the number obtained by tripling the total number of GPGXX motifs in regions of all REPs included in a sequence excluding the sequence from the (A)ₙ motif located at the most C-terminal side to the C-terminus of the domain sequence from the domain sequence (that is, corresponding to the total number of G and P in the GPGXX motifs) is defined as s, and the total number of amino acid residues in all REPs excluding a sequence from the (A)ₙ motif located at the most C-terminal side to the C-terminus of the domain sequence from the domain sequence and further excluding the (A)ₙ motifs is defined as t.

In the calculation of the content rate of the GPGXX motif, the “sequence excluding the sequence from the (A)ₙ motif located at the most C-terminal side to the C-terminus of the domain sequence from the domain sequence” is used to exclude the effect occurring due to the fact that the “sequence from the (A)ₙ motif located at the most C-terminal side to the C-terminus of the domain sequence” (a sequence corresponding to REP) may include a sequence having a low correlation with the sequence characteristic of fibroin, which influences the calculation result of the content rate of the GPGXX motif in a case where m is small (that is, in a case where the domain sequence is short). Incidentally, in a case where the “GPGXX motif” is located at the C-terminus of REP, even when “XX” is “AA”, for example, it is treated as the “GPGXX motif”.

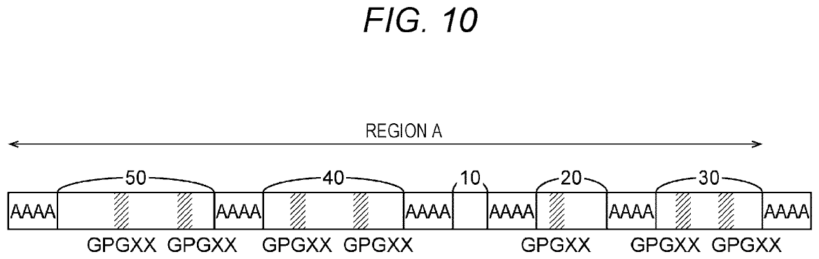

FIG. 10 is a schematic view illustrating a domain sequence of modified fibroin. The method for calculating the content rate of the GPGXX motif will be specifically described with reference to FIG. 10. First, in the domain sequence of the modified fibroin illustrated in FIG. 10 (which is the “[(A)ₙ motif-REP]ₘ-(A)ₙ motif” type), all REPs are included in the “sequence excluding the sequence from the (A)ₙ motif located at the most C-terminal side to the C-terminus of the domain sequence from the domain sequence” (in FIG. 10, the sequence indicated as a “region A”), and therefore, the number of the GPGXX motifs for calculating s is 7, and s is 7×3=21. Similarly, since all REPs are included in the “sequence excluding the sequence from the (A)ₙ motif located at the most C-terminal side to the C-terminus of the domain sequence from the domain sequence” (in FIG. 10, the sequence indicated as the “region A”), the total number t of the amino acid residues in all REPs when the (A)ₙ motifs are further excluded from the sequence is 50+40+10+20+30=150. Next, s/t (%) can be calculated by dividing s by t, and in the case of the modified fibroin of FIG. 10, s/t is 21/150=14.0%.

In the sixth modified fibroin, a content rate of the glutamine residue is preferably 9% or less, more preferably 7% or less, still more preferably 4% or less, and particularly preferably 0%.

In the present specification, the “content rate of the glutamine residue” is a value calculated by the following method.

The content rate of the glutamine residue in fibroin (modified fibroin or naturally derived fibroin) containing a domain sequence represented by Formula 1: [(A)ₙ motif-REP]ₘ or Formula 2: [(A)ₙ motif-REP]ₘ-(A)ₙ motif is calculated as u/t, in a case where the total number of glutamine residues included in regions of all REPs included in a sequence excluding the sequence from the (A)ₙ motif located at the most C-terminal side to the C-terminus of the domain sequence from the domain sequence (a sequence corresponding to the “region A” in FIG. 10) is defined as u, and the total number of amino acid residues in all REPs in the sequence excluding the sequence from the (A)ₙ motif located at the most C-terminal side to the C-terminus of the domain sequence from the domain sequence and further excluding the (A)ₙ motifs is defined as t. In the calculation of the content rate of the glutamine residue, the reason for targeting the “sequence excluding the sequence from the (A)ₙ motif located at the most C-terminal side to the C-terminus of the domain sequence from the domain sequence” is the same as the reason described above.

The domain sequence of the sixth modified fibroin may have an amino acid sequence corresponding to an amino acid sequence in which one or a plurality of glutamine residues in REP are deleted, or one or a plurality of glutamine residues are substituted with another amino acid residue, as compared with naturally derived fibroin.

The “another amino acid residue” may be an amino acid residue other than the glutamine residue, but is preferably an amino acid residue having a higher hydropathy index than that of the glutamine residue. The hydropathy index of the amino acid residue is as shown in Table 1.

As shown in Table 1, examples of the amino acid residue having a higher hydropathy index than that of the glutamine residue include amino acid residues selected from isoleucine (I), valine (V), leucine (L), phenylalanine (F), cysteine (C), methionine (M), alanine (A), glycine (G), threonine (T), serine (S), tryptophan (W), tyrosine (Y), proline (P), and histidine (H). Among them, the amino acid residue is more preferably an amino acid residue selected from isoleucine (I), valine (V), leucine (L), phenylalanine (F), cysteine (C), methionine (M), and alanine (A), and still more preferably an amino acid residue selected from isoleucine (I), valine (V), leucine (L), and phenylalanine (F).

In the sixth modified fibroin, the hydrophobicity of REP is preferably −0.8 or more, more preferably −0.7 or more, still more preferably 0 or more, even still more preferably 0.3 or more, and particularly preferably 0.4 or more. The upper limit of the hydrophobicity of REP is not particularly limited, but may be 1.0 or less or 0.7 or less.

In the present specification, the “hydrophobicity of REP” is a value calculated by the following method.

The hydrophobicity of REP in fibroin containing a domain sequence represented by Formula 1: [(A)ₙ motif-REP]ₘ or Formula 2: [(A)ₙ motif-REP]ₘ-(A)ₙ motif (modified fibroin or naturally derived fibroin) is calculated as v/t, in a case where the sum of hydropathy indices of amino acid residues in regions of all REPs included in a sequence excluding the sequence from the (A)ₙ motif located at the most C-terminal side to the C-terminus of the domain sequence from the domain sequence (a sequence corresponding to the “region A” in FIG. 10) is defined as v, and the total number of amino acid residues in all REPs in the sequence excluding the sequence from the (A)ₙ motif located at the most C-terminal side to the C-terminus of the domain sequence from the domain sequence and further excluding the (A)ₙ motifs is defined as t. In the calculation of the hydrophobicity of REP, the reason for targeting the “sequence excluding the sequence from the (A)ₙ motif located at the most C-terminal side to the C-terminus of the domain sequence from the domain sequence” is the same as the reason described above.

The domain sequence of the sixth modified fibroin may be further subjected to modification of an amino acid sequence corresponding to substitution, deletion, insertion, and/or addition of one or a plurality of amino acid residues, in addition to modification corresponding to deletion of one or a plurality of glutamine residues in REP, and/or substitution of one or a plurality of glutamine residues in REP with another amino acid residue, as compared with naturally derived fibroin.

The sixth modified fibroin can be obtained by, for example, deleting one or a plurality of glutamine residues in REP from a cloned gene sequence of naturally derived fibroin, and/or substituting one or a plurality of glutamine residues in REP with another amino acid residue. In addition, the sixth modified fibroin can be obtained by, for example, designing an amino acid sequence corresponding to an amino acid sequence in which one or a plurality of glutamine residues in REP are deleted from an amino acid sequence of naturally derived fibroin, and/or one or a plurality of glutamine residues in REP are substituted with another amino acid residue, and chemically synthesizing a nucleic acid encoding the designed amino acid sequence.

A more specific example of the sixth modified fibroin can include modified fibroin including (6-i) the amino acid sequence set forth in SEQ ID NO: 25 (Met-PRT888), SEQ ID NO: 26 (Met-PRT965), SEQ ID NO: 27 (Met-PRT889), SEQ ID NO: 28 (Met-PRT916), SEQ ID NO: 29 (Met-PRT918), SEQ ID NO: 30 (Met-PRT699), SEQ ID NO: 31 (Met-PRT698), SEQ ID NO: 32 (Met-PRT966), SEQ ID NO: 41 (Met-PRT917), or SEQ ID NO: 42 (Met-PRT1028), and modified fibroin including (6-ii) an amino acid sequence having 90% or more sequence identity with the amino acid sequence set forth in SEQ ID NO: 25, SEQ ID NO: 26, SEQ ID NO: 27, SEQ ID NO: 28, SEQ ID NO: 29, SEQ ID NO: 30, SEQ ID NO: 31, SEQ ID NO: 32, SEQ ID NO: 41, or SEQ ID NO: 42.

The modified fibroin of (6-i) will be described. The amino acid sequence set forth in SEQ ID NO: 25 is obtained by substituting all QQs in the amino acid sequence set forth in SEQ ID NO: 7 (Met-PRT410) with VL. The amino acid sequence set forth in SEQ ID NO: 26 is obtained by substituting all QQs in the amino acid sequence set forth in SEQ ID NO: 7 with TS and substituting the remaining Q with A. The amino acid sequence set forth in SEQ ID NO: 27 is obtained by substituting all QQs in the amino acid sequence set forth in SEQ ID NO: 7 with VL and substituting the remaining Q with I. The amino acid sequence set forth in SEQ ID NO: 28 is obtained by substituting all QQs in the amino acid sequence set forth in SEQ ID NO: 7 with VI and substituting the remaining Q with L. The amino acid sequence set forth in SEQ ID NO: 29 is obtained by substituting all QQs in the amino acid sequence set forth in SEQ ID NO: 7 with VF and substituting the remaining Q with I.

The amino acid sequence set forth in SEQ ID NO: 30 is obtained by substituting all QQs in the amino acid sequence set forth in SEQ ID NO: 8 (Met-PRT525) with VL. The amino acid sequence set forth in SEQ ID NO: 31 is obtained by substituting all QQs in the amino acid sequence set forth in SEQ ID NO: 8 with VL and substituting the remaining Q with I.

The amino acid sequence set forth in SEQ ID NO: 32 is obtained by substituting, with VF, all QQs in a sequence obtained by repeating a region of 20 domain sequences present in the amino acid sequence set forth in SEQ ID NO: 7 (Met-PRT410) two times and substituting the remaining Q with I.

The amino acid sequence set forth in SEQ ID NO: 41 (Met-PRT917) is obtained by substituting all QQs in the amino acid sequence set forth in SEQ ID NO: 7 with LI and substituting the remaining Q with V. The amino acid sequence set forth in SEQ ID NO: 42 (Met-PRT1028) is obtained by substituting all QQs in the amino acid sequence set forth in SEQ ID NO: 7 with IF and substituting the remaining Q with T.

The content rate of the glutamine residue in each of the amino acid sequences set forth in SEQ ID NO: 25, SEQ ID NO: 26, SEQ ID NO: 27, SEQ ID NO: 28, SEQ ID NO: 29, SEQ ID NO: 30, SEQ ID NO: 31, SEQ ID NO: 32, SEQ ID NO: 41, and SEQ ID NO: 42 is 9% or less (Table 2).

TABLE 2

| | Content | Content | |
|---|---|---|---|
| | rate of | rate of | |
| | glutamine | GPGXX | Hydrophobicity |
| Modified fibroin | residue | motif | of REP |
| Met-PRT410 (SEQ ID NO: 7) | 17.7% | 27.9% | −1.52 |
| Met-PRT888 (SEQ ID NO: 25) | 6.3% | 27.9% | −0.07 |
| Met-PRT965 (SEQ ID NO: 26) | 0.0% | 27.9% | −0.65 |
| Met-PRT889 (SEQ ID NO: 27) | 0.0% | 27.9% | 0.35 |
| Met-PRT916 (SEQ ID NO: 28) | 0.0% | 27.9% | 0.47 |
| Met-PRT918 (SEQ ID NO: 29) | 0.0% | 27.9% | 0.45 |
| Met-PRT699 (SEQ ID NO: 30) | 3.6% | 26.4% | −0.78 |
| Met-PRT698 (SEQ ID NO: 31) | 0.0% | 26.4% | −0.03 |
| Met-PRT966 (SEQ ID NO: 32) | 0.0% | 28.0% | 0.35 |
| Met-PRT917 (SEQ ID NO: 41) | 0.0% | 27.9% | 0.46 |
| Met-PRT1028 (SEQ ID NO: 42) | 0.0% | 28.1% | 0.05 |

The modified fibroin of (6-i) may consist of the amino acid sequence set forth in SEQ ID NO: 25, SEQ ID NO: 26, SEQ ID NO: 27, SEQ ID NO: 28, SEQ ID NO: 29, SEQ ID NO: 30, SEQ ID NO: 31, SEQ ID NO: 32, SEQ ID NO: 41, or SEQ ID NO: 42.

The modified fibroin of (6-ii) includes an amino acid sequence having 90% or more sequence identity with the amino acid sequence set forth in SEQ ID NO: 25, SEQ ID NO: 26, SEQ ID NO: 27, SEQ ID NO: 28, SEQ ID NO: 29, SEQ ID NO: 30, SEQ ID NO: 31, SEQ ID NO: 32, SEQ ID NO: 41, or SEQ ID NO: 42. The modified fibroin of (6-ii) is also a protein containing a domain sequence represented by Formula 1: [(A)ₙ motif-REP]ₘ or Formula 2: [(A)ₙ motif-REP]ₘ-(A)ₙ motif. The sequence identity is preferably 95% or more.

In the modified fibroin of (6-ii), the content rate of the glutamine residue is preferably 9% or less. In the modified fibroin of (6-ii), the content rate of the GPGXX motif is preferably 10% or more.

The sixth modified fibroin may have a tag sequence at either or both of the N-terminus and the C-terminus. This enables the modified fibroin to be isolated, immobilized, detected, and visualized.

A more specific example of the modified fibroin including a tag sequence can include modified fibroin including (6-iii) the amino acid sequence set forth in SEQ ID NO: 33 (PRT888), SEQ ID NO: 34 (PRT965), SEQ ID NO: 35 (PRT889), SEQ ID NO: 36 (PRT916), SEQ ID NO: 37 (PRT918), SEQ ID NO: 38 (PRT699), SEQ ID NO: 39 (PRT698), SEQ ID NO: 40 (PRT966), SEQ ID NO: 43 (PRT917), or SEQ ID NO: 44 (PRT1028), or modified fibroin including (6-iv) an amino acid sequence having 90% or more sequence identity with the amino acid sequence set forth in SEQ ID NO: 33, SEQ ID NO: 34, SEQ ID NO: 35, SEQ ID NO: 36, SEQ ID NO: 37, SEQ ID NO: 38, SEQ ID NO: 39, SEQ ID NO: 40, SEQ ID NO: 43, or SEQ ID NO: 44.

Each of the amino acid sequences set forth in SEQ ID NO: 33, SEQ ID NO: 34, SEQ ID NO: 35, SEQ ID NO: 36, SEQ ID NO: 37, SEQ ID NO: 38, SEQ ID NO: 39, SEQ ID NO: 40, SEQ ID NO: 43, and SEQ ID NO: 44 is obtained by adding the amino acid sequence set forth in SEQ ID NO: 11 (including a His tag sequence and a hinge sequence) to the N-terminus of each of the amino acid sequences set forth in SEQ ID NO: 25, SEQ ID NO: 26, SEQ ID NO: 27, SEQ ID NO: 28, SEQ ID NO: 29, SEQ ID NO: 30, SEQ ID NO: 31, SEQ ID NO: 32, SEQ ID NO: 41, and SEQ ID NO: 42. Since only the tag sequence is added to the N-terminus, the content rate of the glutamine residue is not changed, and the content rate of the glutamine residue in each of the amino acid sequences set forth in SEQ ID NO: 33, SEQ ID NO: 34, SEQ ID NO: 35, SEQ ID NO: 36, SEQ ID NO: 37, SEQ ID NO: 38, SEQ ID NO: 39, SEQ ID NO: 40, SEQ ID NO: 43, or SEQ ID NO: 44 is 9% or less (Table 3).

TABLE 3

| | Content rate | Content rate | |
|---|---|---|---|
| | of glutamine | of GPGXX | Hydrophobicity |
| Modified fibroin | residue | motif | of REP |
| PRT888 (SEQ ID NO: 33) | 6.3% | 27.9% | −0.07 |
| PRT965 (SEQ ID NO: 34) | 0.0% | 27.9% | −0.65 |
| PRT889 (SEQ ID NO: 35) | 0.0% | 27.9% | 0.35 |
| PRT916 (SEQ ID NO: 36) | 0.0% | 27.9% | 0.47 |
| PRT918 (SEQ ID NO: 37) | 0.0% | 27.9% | 0.45 |
| PRT699 (SEQ ID NO: 38) | 3.6% | 26.4% | −0.78 |
| PRT698 (SEQ ID NO: 39) | 0.0% | 26.4% | −0.03 |
| PRT966 (SEQ ID NO: 40) | 0.0% | 28.0% | 0.35 |
| PRT917 (SEQ ID NO: 43) | 0.0% | 27.9% | 0.46 |
| PRT1028 (SEQ ID NO: 44) | 0.0% | 28.1% | 0.05 |

The modified fibroin of (6-iii) may consist of the amino acid sequence set forth in SEQ ID NO: 33, SEQ ID NO: 34, SEQ ID NO: 35, SEQ ID NO: 36, SEQ ID NO: 37, SEQ ID NO: 38, SEQ ID NO: 39, SEQ ID NO: 40, SEQ ID NO: 43, or SEQ ID NO: 44.

The modified fibroin of (6-iv) includes an amino acid sequence having 90% or more sequence identity with the amino acid sequence set forth in SEQ ID NO: 33, SEQ ID NO: 34, SEQ ID NO: 35, SEQ ID NO: 36, SEQ ID NO: 37, SEQ ID NO: 38, SEQ ID NO: 39, SEQ ID NO: 40, SEQ ID NO: 43, or SEQ ID NO: 44. The modified fibroin of (6-iv) is also a protein containing a domain sequence represented by Formula 1: [(A)ₙ motif-REP]ₘ or Formula 2: [(A)ₙ motif-REP]ₘ-(A)ₙ motif. The sequence identity is preferably 95% or more.

In the modified fibroin of (6-iv), the content rate of the glutamine residue is preferably 9% or less. In the modified fibroin of (6-iv), the content rate of the GPGXX motif is preferably 10% or more.

The sixth modified fibroin may include a secretory signal for releasing the protein produced in the recombinant protein production system to the outside of a host. The sequence of the secretory signal can be appropriately set depending on the type of the host.

The modified fibroin may also be modified fibroin having at least two or more characteristics among the characteristics of the first modified fibroin, the second modified fibroin, the third modified fibroin, the fourth modified fibroin, the fifth modified fibroin, and the sixth modified fibroin.

The modified fibroin may be hydrophilic modified fibroin or hydrophobic modified fibroin. In the present specification, the “hydrophilic modified fibroin” is modified fibroin of which a value calculated by obtaining the sum of hydropathy indices (HIs) of all amino acid residues constituting the modified fibroin and then dividing the sum by the total number of amino acid residues (average HI) is 0 or less. The hydropathy index is as shown in Table 1. In addition, the “hydrophobic modified fibroin” is modified fibroin of which the average HI is more than 0. The hydrophilic modified fibroin is particularly excellent in flame retardancy. The hydrophobic modified fibroin is particularly excellent in hygroscopic exothermicity and heat-retaining property.

Examples of the hydrophilic modified fibroin can include modified fibroin including the amino acid sequence set forth in SEQ ID NO: 4, the amino acid sequence set forth in SEQ ID NO: 6, SEQ ID NO: 7, SEQ ID NO: 8, or SEQ ID NO: 9, the amino acid sequence set forth in SEQ ID NO: 13, SEQ ID NO: 11, SEQ ID NO: 14, or SEQ ID NO: 15, the amino acid sequence set forth in SEQ ID NO: 18, SEQ ID NO: 7, SEQ ID NO: 8, or SEQ ID NO: 9, the amino acid sequence set forth in SEQ ID NO: 17, SEQ ID NO: 11, SEQ ID NO: 14, or SEQ ID NO: 15, or the amino acid sequence set forth in SEQ ID NO: 19, SEQ ID NO: 20, or SEQ ID NO: 21.

Examples of the hydrophobic modified fibroin can include modified fibroin including the amino acid sequence set forth in SEQ ID NO: 27, SEQ ID NO: 28, SEQ ID NO: 29, SEQ ID NO: 30, SEQ ID NO: 31, SEQ ID NO: 32, SEQ ID NO: 33, or SEQ ID NO: 43, or the amino acid sequence set forth in SEQ ID NO: 35, SEQ ID NO: 37, SEQ ID NO: 38, SEQ ID NO: 39, SEQ ID NO: 40, SEQ ID NO: 41, or SEQ ID NO: 44.

### EXAMPLES

Hereinafter, the present invention will be described more specifically based on Test Examples and the like. However, the present invention is not limited to the following Test Examples.

### Test Example 1: Production of Modified Fibroin

Modified spider silk fibroin having the amino acid sequence set forth in SEQ ID NO: 18 (PRT399), modified spider silk fibroin having the amino acid sequence set forth in SEQ ID NO: 12 (PRT380), modified spider silk fibroin having the amino acid sequence set forth in SEQ ID NO: 13 (PRT410), modified fibroin having the amino acid sequence set forth in SEQ ID NO: 37 (PRT918), modified fibroin having the amino acid sequence set forth in SEQ ID NO: 40 (PRT966), and modified fibroin having the amino acid sequence set forth in SEQ ID NO: 15 (PRT799) were designed. A nucleic acid encoding the designed modified fibroin was synthesized. The nucleic acid had an NdeI site added at the 5′ end and an EcoRI site added downstream from the stop codon. The nucleic acid was cloned in a cloning vector (pUC118). Thereafter, the nucleic acid was enzymatically cleaved by treatment with NdeI and EcoRI, and then recombined into a protein expression vector pET-22b(+) to obtain an expression vector.

Escherichia coli BLR (DE3) was transformed with the obtained expression vector. The transformed Escherichia coli was cultured in 2 mL of an LB culture medium containing ampicillin for 15 hours. The culture solution was added to a 100 mL seed culture medium containing ampicillin (Table 4) so that OD₆₀₀ was 0.005. The temperature of the culture solution was maintained at 30° C., and the flask culture was performed (for about 15 hours) until the OD₆₀₀ reached 5, thus obtaining a seed culture medium.

TABLE 4
Seed culture medium

| Reagent | Concentration (g/L) |
|---|---|
| Glucose | 5.0 |
| KH₂PO₄ | 4.0 |
| K₂HPO₄ | 9.3 |
| Yeast Extract | 6.0 |
| Ampicillin | 0.1 |

The seed culture medium was added to a jar fermenter to which a 500 mL production medium (Table 5) was added so that OD₆₀₀ was 0.05. The culture was performed while maintaining the culture solution temperature at 37° C. and constantly controlling the pH to 6.9. Further, the dissolved oxygen concentration in the culture solution was maintained at 20% of the dissolved oxygen saturation concentration.

TABLE 5
Production medium

| Reagent | Concentration (g/L) |
|---|---|
| Glucose | 12.0 |
| KH₂PO₄ | 9.0 |
| MgSO₄•7H₂O | 2.4 |
| Yeast Extract | 15 |
| FeSO₄•7H₂O | 0.04 |
| MnSO₄•5H₂O | 0.04 |
| CaCl₂•2H₂O | 0.04 |
| ADECANOL (ADEKA, LG-295S) | 0.1 (mL/L) |

Immediately after glucose in the production medium was completely consumed, a feed solution (455 g/l L of glucose, 120 g/l L of Yeast Extract) was added at a rate of 1 mL/min. The culture was performed while maintaining the culture solution temperature at 37° C. and constantly controlling the pH to 6.9. Further, the dissolved oxygen concentration in the culture solution was maintained at 20% of the dissolved oxygen saturation concentration, and the culture was performed for 20 hours. Thereafter, 1 M isopropyl-3-thiogalactopyranoside (IPTG) was added to the culture solution to a final concentration of 1 mM to induce the expression of the modified fibroin. The culture solution was centrifuged 20 hours after addition of IPTG, and bacterial cells were recovered. SDS-PAGE was conducted using the bacterial cells prepared from the culture solutions obtained before the addition of IPTG and after the addition of IPTG. The expression of the target modified fibroin which depended on the addition of IPTG was confirmed by the appearance of a band of the size of the target modified fibroin.

The bacterial cell pellet recovered 2 hours after the addition of IPTG were washed with 20 mM Tris-HCl buffer solution (pH 7.4). The bacterial cells after washing were suspended in 20 mM Tris-HCl buffer (pH 7.4) containing about 1 mM PMSF, and the cells were disrupted with a high-pressure homogenizer (manufactured by GEA Niro Soavi). The disrupted cells were centrifuged to obtain a precipitate. The obtained precipitate was washed with a 20 mM Tris-HCl buffer (pH 7.4) until the purity of the precipitate became high. The precipitate after washing was suspended in an 8 M guanidine buffer (8 M guanidine hydrochloride, 10 mM sodium dihydrogen phosphate, 20 mM NaCl, 1 mM Tris-HCl, pH 7.0) so that the concentration of the precipitate was 100 mg/mL, and dissolved by stirring with a stirrer at 60° C. for 30 minutes. After dissolution, dialysis was performed with water using a dialysis tube (cellulose tube 36/32, manufactured by Sanko Junyaku Co., Ltd.). The white aggregated protein obtained after dialysis was collected by centrifugation, moisture was removed with a lyophilizer, and a lyophilized powder was collected to obtain modified fibroins (PRT399, PRT380, PRT410, PRT918, PRT966, and PRT799).

### Test Example 2: Production of Modified Fibroin Fiber (Artificial Protein Fiber) and Evaluation of Shrinkability

Dimethyl sulfoxide (DMSO) in which LiCl was dissolved so that a concentration thereof was 4.0 mass % was prepared as a solvent, and a lyophilized powder of the modified fibroin (PRT399, PRT380, PRT410, or PRT799) was added thereto so as to have a concentration of 18 mass % or 24 mass %, and dissolved using a shaker for 3 hours. Thereafter, insoluble matters and foams were removed to obtain a modified fibroin solution.

The obtained modified fibroin solution (spinning raw material solution) is used as a dope solution, and spun and drawn modified fibroin fibers (modified spider silk fibroin fibers) were produced by dry wet spinning. The conditions of dry wet spinning are as described below.

Diameter of extrusion nozzle: 0.2 mm

Coagulation bath temperature: 2 to 15° C.

Total draw ratio: 1 to 4 times

Dry temperature: 60° C.

### (Evaluation of Shrinkability)

A shrinkage rate of each of the obtained modified fibroin fibers (Production Examples 1 to 19) was evaluated. That is, each of the modified fibroin fibers (fibers before being brought into contact with water after spinning) was subjected to a shrinking step of bringing the modified fibroin fiber into contact with water to be in a wet state (contact step) and then drying the modified fibroin fiber (drying step), and a shrinkage rate of the modified fibroin fiber in the wet state and a shrinkage rate of the dried modified fibroin fiber after being in the wet state were determined.

### <Contact Step>

A plurality of modified fibroin fibers for a test each having a length of 30 cm were cut out from a wound product of each of modified fibroin fibers. The plurality of modified fibroin fibers were bundled to obtain a modified fibroin fiber bundle having a fineness of 150 denier. A lead weight of 0.8 g was attached to each of the modified fibroin fiber bundles, and each of the modified fibroin fiber bundles in this state was immersed in water at temperatures shown in Tables 6 to 9 for 10 minutes. Thereafter, a length of each of the modified fibroin fiber bundles was measured in water. The measurement was performed while 0.8 g of a lead weight was attached to the modified fibroin fiber bundle in order to eliminate shrinkage of the modified fibroin fiber bundle. Next, a shrinkage rate (shrinkage rate when wetted) of the modified fibroin fiber in a wet state was calculated according to the following Equation V. In Equation V, L0 represents a length (30 cm) of the modified fibroin fiber bundle before being immersed in water, and Lw represents a length of the modified fibroin fiber bundle immersed in water in a wet state.

Shrinkage rate when wetted (%)={1−(Lw/L0)}×100 (Equation V)

### <Drying Step>

After the contact step, the modified fibroin fiber bundle was taken out from the water. The taken-out modified fibroin fiber bundle was dried at room temperature for 2 hours with 0.8 g of the attached lead weight. After the drying, a length of each of the modified fibroin fiber bundles was measured. Next, a shrinkage rate (shrinkage rate when dried) of the dried modified fibroin fiber after being in the wet state was calculated according to the following Equation VI. In Equation VI, L0 represents a length (30 cm) of the modified fibroin fiber bundle before being immersed in water, and Lwd represents a length of the dried modified fibroin fiber bundle after being immersed in water to be in the wet state.

Shrinkage rate when dried (%)={1−(Lwd/L0)}×100(%) (Equation VI)

The results are shown in Tables 6 to 9. In Tables 6 to 9, a “total draw ratio” represents a total draw ratio in the spinning step.

TABLE 6

| | Modified | Total | | Shrinkage | Shrinkage |
|---|---|---|---|---|---|
| | spider | draw | Temperature | rate when | rate when |
| | silk | ratio | of water | wetted | dried |
| | fibroin | (times) | (° C.) | (%) | (%) |
| Production | 24 wt % | 1 | 20 | 0.0 | 7.8 |
| Example 1 | PRT799 | | | | |
| Production | 24 wt % | 2 | | −1.2 | 10.3 |
| Example 2 | PRT799 | | | | |
| Production | 24 wt % | 3 | | 7.2 | 21.2 |
| Example 3 | PRT799 | | | | |
| Production | 24 wt % | 4 | | 13.5 | 26.3 |
| Example 4 | PRT799 | | | | |
| Production | 18 wt % | 2 | | −2.3 | 9.5 |
| Example 6 | PRT799 | | | | |
| Production | 18 wt % | 3 | | 6.0 | 19.7 |
| Example 7 | PRT799 | | | | |
| Production | 18 wt % | 4 | | 14.3 | 27.5 |
| Example 8 | PRT799 | | | | |
| Production | 24 wt % | 2 | 40 | −5.3 | 7.2 |
| Example 2 | PRT799 | | | | |
| Production | 24 wt % | 3 | | 8.7 | 21.3 |
| Example 3 | PRT799 | | | | |
| Production | 24 wt % | 4 | | 14.5 | 26.0 |
| Example 4 | PRT799 | | | | |
| Production | 18 wt % | 2 | | −4.3 | 7.3 |
| Example 6 | PRT799 | | | | |
| Production | 18 wt % | 3 | | 6.2 | 18.3 |
| Example 7 | PRT799 | | | | |
| Production | 18 wt % | 4 | | 16.0 | 28.7 |
| Example 8 | PRT799 | | | | |
| Production | 24 wt % | 3 | 60 | 6.8 | 21.0 |
| Example 3 | PRT799 | | | | |
| Production | 24 wt % | 4 | | 15.0 | 27.5 |
| Example 4 | PRT799 | | | | |
| Production | 18 wt % | 2 | | −1.5 | 10.7 |
| Example 6 | PRT799 | | | | |
| Production | 18 wt % | 3 | | 3.3 | 18.2 |
| Example 7 | PRT799 | | | | |
| Production | 18 wt % | 4 | | 16.2 | 29.0 |
| Example 8 | PRT799 | | | | |

TABLE 7

| | | Total | | Shrinkage | Shrinkage |
|---|---|---|---|---|---|
| | | draw | Temperature | rate when | rate when |
| | Modified | ratio | of water | wetted | dried |
| | fibroin | (times) | (° C.) | (%) | (%) |
| Production | 24 wt % | 2 | 20 | −2.3 | 8.7 |
| Example 10 | PRT410 | | | | |
| Production | 24 wt % | 3 | | 4.7 | 16.7 |
| Example 11 | PRT410 | | | | |
| Production | 24 wt % | 4 | | 10.3 | 22.3 |
| Example 12 | PRT410 | | | | |
| Production | 24 wt % | 3 | 40 | 4.7 | 17.5 |
| Example 11 | PRT410 | | | | |
| Production | 24 wt % | 4 | | 11.5 | 24.0 |
| Example 12 | PRT410 | | | | |
| Production | 24 wt % | 3 | 60 | 2.0 | 16.5 |
| Example 11 | PRT410 | | | | |
| Production | 24 wt % | 4 | | 10.8 | 25.0 |
| Example 12 | PRT410 | | | | |

TABLE 8

| | | Total | | Shrinkage | Shrinkage |
|---|---|---|---|---|---|
| | | draw | Temperature | rate when | rate when |
| | Modified | ratio | of water | wetted | dried |
| | fibroin | (times) | (° C.) | (%) | (%) |
| Production | 24 wt % | 1 | 20 | −3.5 | 7.6 |
| Example 13 | PRT399 | | | | |
| Production | 24 wt % | 2 | | 3.7 | 12.5 |
| Example 14 | PRT399 | | | | |
| Production | 24 wt % | 3 | | 7.0 | 16.8 |
| Example 15 | PRT399 | | | | |
| Production | 24 wt % | 2 | 40 | 3.0 | 12.7 |
| Example 14 | PRT399 | | | | |
| Production | 24 wt % | 3 | | 7.3 | 16.7 |
| Example 15 | PRT399 | | | | |
| Production | 24 wt % | 2 | 60 | 3.3 | 9.3 |
| Example 14 | PRT399 | | | | |
| Production | 24 wt % | 3 | | 6.8 | 14.2 |
| Example 15 | PRT399 | | | | |

TABLE 9

| | | Total | | Shrinkage | Shrinkage |
|---|---|---|---|---|---|
| | | draw | Temperature | rate when | rate when |
| | Modified | ratio | of water | wetted | dried |
| | fibroin | (times) | (° C.) | (%) | (%) |
| Production | 24 wt % | 1 | 20 | −1.1 | 9.4 |
| Example 16 | PRT380 | | | | |
| Production | 24 wt % | 2 | | 2.7 | 13.3 |
| Example 17 | PRT380 | | | | |
| Production | 24 wt % | 3 | | 7.0 | 17.7 |
| Example 18 | PRT380 | | | | |
| Production | 24 wt % | 4 | | 10.0 | 20.2 |
| Example 19 | PRT380 | | | | |
| Production | 24 wt % | 2 | 40 | 3.3 | 14.2 |
| Example 17 | PRT380 | | | | |
| Production | 24 wt % | 3 | | 7.7 | 19.0 |
| Example 18 | PRT380 | | | | |
| Production | 24 wt % | 4 | | 12.0 | 22.0 |
| Example 19 | PRT380 | | | | |
| Production | 24 wt % | 2 | 60 | 2.7 | 14.3 |
| Example 17 | PRT380 | | | | |
| Production | 24 wt % | 3 | | 8.2 | 20.3 |
| Example 18 | PRT380 | | | | |
| Production | 24 wt % | 4 | | 12.0 | 23.2 |
| Example 19 | PRT380 | | | | |

As shown in Tables 6 to 9, it can be understood that the artificial protein fiber (modified fibroin fiber) has a high shrinkage rate when wetted or a high shrinkage rate when dried, and is preferable as a fiber constituting a base material of the fabric according to the present invention.

### Test Example 3: Production of Base Material and Water-Repellent Processing of Surface of Base Material

### (1) Preparation of Spinning Solution (Dope Solution)

Using DMSO in which lithium chloride was dissolved so that a concentration thereof was 4 mass % as a solvent, a lyophilized powder of the modified fibroin (PRT799) produced above was added to the solvent so that a concentration thereof was 24 mass %. The mixture was dissolved with an aluminum block heater at 90° C. for 1 hour, and then insoluble matters and bubbles were removed to obtain a spinning solution (dope solution).

### (2) Spinning

The spinning solution was filled in a reserve tank, and the spinning solution was discharged into 100 mass % of a methanol coagulation bath from a mono-hole nozzle having a diameter of 0.1 or 0.2 mm using a gear pump. A discharge amount was adjusted to 0.01 to 0.08 mL/min. After the coagulation, washing and drawing were performed in 100 mass % of the methanol washing bath. After the washing and drawing, drying was performed using a dry heat plate, and the obtained raw yarns (modified fibroin fibers) were wound.

### (3) Production of Base Material (Woven Fabric)

Twisted yarns were produced from the obtained modified fibroin fibers. The produced twisted yarns were subjected to plain weaving to obtain a woven fabric.

### (4) Binding of Hydrophobic Polymer to Base Material (Woven Fabric)

Fluorine-based coating monomers were applied to the obtained woven fabric, and a plasma treatment was performed using a plasma treatment apparatus (manufactured by Europlasma, SA). A woven fabric in which fluorine-based polymers (water resistance imparting substance) obtained by polymerizing the fluorine-based coating monomers were covalently bound was obtained by the plasma treatment. Nanofics 110 (Example 1) and Nanofics 120 (Examples 2) (both were manufactured by Europlasma, SA) were used as the fluorine-based coating monomers.

### (5) Evaluation of Water Repellency

A water repellent test (spray test) was performed on each of the woven fabrics of Examples 1 and 2 subjected to the plasma treatment and a woven fabric (Comparative Example 1) subjected to no plasma treatment. The water repellent test (spray test) was performed according to ISO 4920:2012. Determination was performed visually according to the following evaluation criteria of 6 grades (scores of 0 to 5).

Score 5: No wetting and water droplet adhesion were observed on the surface.

Score 4: No wetting was observed and water droplet adhesion was observed on the surface.

Score 3: Small wetting was observed on the surface.

Score 2: Wetting was widespread and some sites where wetting was observed were connected to each other.

Score 1: Complete wetting was observed on the part butted against water.

Score 0: Wetting was observed on the entire surface.

The results are shown in Table 10. The woven fabric of Comparative Example 1 subjected to no plasma treatment had a score of 0, whereas each of the woven fabrics of Examples 1 and 2 subjected to the plasma treatment had a score of 4 and was imparted with water resistance (water repellency).

TABLE 10

| | Score |
|---|---|
| Comparative Example 1 | 0 |
| Example 1 | 4 |
| Example 2 | 4 |

### (6) Evaluation of Tactile Impression and Evaluation of Shrinkability

A square test piece having one side of 5 cm was cut out from each of the woven fabrics of Examples 1 and 2 and Comparative Example 1. Vortexes (four points) of the square having one side of 30 mm were marked with a pencil on one surface of the test piece. A step of immersing each test piece in water at 40° C. for 10 minutes and then vacuum-drying the test piece at room temperature was repeated 5 cycles. The vacuum drying was performed using a vacuum constant temperature dryer (VOS-310C, manufactured by TOKYO RIKAKIKAI CO, LTD.) at a set pressure of −0.1 MPa for 30 minutes. In addition, at the end of each cycle, a sensory evaluation of the tactile impression was performed, and a distance between the marked four points was measured to evaluate a shrinkage rate.

The tactile impression was determined according to the following criteria. The results are shown in Table 11. In both the woven fabrics of Examples 1 and 2 subjected to the plasma treatment, the deterioration of the tactile impression was suppressed as compared to the woven fabric of Comparative Example 1 subjected to no plasma treatment.

Score 5: The tactile impression was as good as the original.

Score 4: The tactile impression was good, but was slightly inferior to the original.

Score 3: The tactile impression was not bad, but the woven fabric was slightly stiff.

Score 2: The tactile impression was bad, and the woven fabric was stiff and but bent.

Score 1: The tactile impression was significantly bad, and the woven fabric was stiff and not bent.

TABLE 11

| | Score | | | | | |
|---|---|---|---|---|---|---|
| | | After | After | After | After | After |
| | | one | two | three | four | five |
| | Original | cycle | cycles | cycles | cycles | cycles |
| Comparative | 5 | 2 | 2 | 2 | 2 | 2 |
| Example 1 | | | | | | |
| Example 1 | 5 | 3 | 3 | 3 | 3 | 3 |
| Example 2 | 5 | 4 | 4 | 4 | 4 | 4 |

The shrinkage rate was calculated according to following equation. The “average value of lengths of sides” is a value obtained by dividing the sum of the lengths of the sides of the square formed by the marked four points by 4.

Shrinkage rate (%)={1−(average value (mm) of lengths of sides/30 mm)}×100

The results are shown in Table 12. In both the woven fabrics of Examples 1 and 2 subjected to the plasma treatment, the shrinkage rate was lower than that of the woven fabric of Comparative Example 1 subjected to no plasma treatment.

TABLE 12

| | Shrinkage rate (%) | | | | |
|---|---|---|---|---|---|
| | After one | After two | After three | After four | After five |
| | cycle | cycles | cycles | cycles | cycles |
| Comparative | 25.0 | 24.5 | 25.3 | 25.6 | 25.6 |
| Example 1 | | | | | |
| Example 1 | 3.8 | 5.4 | 10.5 | 17.4 | 17.8 |
| Example 2 | 9.4 | 9.5 | 9.9 | 14.7 | 15.0 |

### Test Example 4: Production of Base Material and Water-Repellent Processing of Surface of Base Material

### (1) Preparation of Spinning Solution (Dope Solution)

Using DMSO in which lithium chloride was dissolved so that a concentration thereof was 4 mass % as a solvent, a lyophilized powder of the modified fibroin (PRT918) produced above was added to the solvent so that a concentration thereof was 24 mass %. The mixture was dissolved with an aluminum block heater at 90° C. for 1 hour, and then insoluble matters and bubbles were removed to obtain a spinning solution (dope solution).

### (2) Spinning

The spinning solution was filled in a reserve tank, and the spinning solution was discharged into 100 mass % of a methanol coagulation bath from a mono-hole nozzle having a diameter of 0.1 or 0.2 mm using a gear pump. A discharge amount was adjusted to 0.01 to 0.08 mL/min. After the coagulation, washing and drawing were performed in 100 mass % of the methanol washing bath. After the washing and drawing, drying was performed using a dry heat plate, and the obtained raw yarns (modified fibroin fibers) were wound.

### (3) Production of Base Material (Knitted Fabric)

The obtained modified fibroin fiber was cut to produce a modified fibroin staple. The produced modified fibroin staple was opened and then spun by a known spinning apparatus to obtain spun yarns. The obtained spun yarns were knitted using a whole garment flat knitting machine (MACH2XS, manufactured by SHIMA SEIKI MFG., LTD.) to obtain a knitted fabric.

### (4) Binding of Hydrophobic Polymer to Base Material (Knitted Fabric)

Fluorine-based coating monomers were applied to the obtained knitted fabric, and a plasma treatment was performed using a plasma treatment apparatus (manufactured by Europlasma, SA). A knitted fabric in which fluorine-based polymers (water resistance imparting substance) obtained by polymerizing the fluorine-based coating monomers were covalently bound was obtained by the plasma treatment (Example 3). Nanofics 120 (manufactured by Europlasma, SA) was used as the fluorine-based coating monomer.

### (5) Evaluation of Water Repellency

A water repellent test (spray test) was performed on each of the knitted fabric of Example 3 subjected to the plasma treatment and a knitted fabric (Comparative Example 2) subjected to no plasma treatment using the same method as that of Test Example 1. The results are shown in Table 13. The knitted fabric of Comparative Example 2 subjected to no plasma treatment had a score of 0, whereas the knitted fabric of Example 3 subjected to the plasma treatment had a score of 5 and was imparted with water resistance (water repellency).

TABLE 13

| | Score |
|---|---|
| Comparative Example 2 | 0 |
| Example 3 | 5 |

### (6) Evaluation of Tactile Impression and Evaluation of Shrinkability

A square test piece having one side of 5 cm was cut out from each of the knitted fabrics of Example 3 and Comparative Example 2. Vortexes (four points) of the square having one side of 30 mm were marked with a pencil on one surface of the test piece. As a preliminary treatment, a step of immersing each test piece in water at 40° C. for 10 minutes and then vacuum-drying the test piece at room temperature was repeated 5 cycles. The vacuum drying was performed using a vacuum constant temperature dryer (VOS-310C, manufactured by TOKYO RIKAKIKAI CO, LTD.) at a set pressure of −0.1 MPa for 30 minutes.

Next, a washing step, a drying step, an immersion step, and a drying step were repeated 5 cycles in this order for the test piece subjected to the preliminary treatment. In the washing step, the test piece was washed for 5 minutes using a washing machine (NA-VG1100L) manufactured by Panasonic Corporation and a detergent (top clear liquid) manufactured by Lion Corporation, rinsing was performed twice, and then, dehydration was performed for 1 minute. In the drying step, the test piece was dried at room temperature at a set pressure of −0.1 MPa for 30 minutes using a vacuum constant temperature dryer (VOS-310C, manufactured by TOKYO RIKAKIKAI CO, LTD.). In the immersion step, the test piece was immersed in water at 40° C. for 10 minutes. At the end of each cycle, a sensory evaluation of the tactile impression was performed, and a distance between the marked four points was measured to evaluate a shrinkage rate, based on the same criteria as those of Test Example 1.

The sensory evaluation results of the tactile impression are shown in Table 14. The “at the time of starting” is an evaluation result after the preliminary treatment is performed and before the cycle is started. In the knitted fabric of Example 3 subjected to the plasma treatment, the deterioration of the tactile impression was suppressed as compared to the knitted fabric of Comparative Example 2 subjected to no plasma treatment.

TABLE 14

| | Score | | | | | |
|---|---|---|---|---|---|---|
| | | After | After | After | After | After |
| | At time of | one | two | three | four | five |
| | starting | cycle | cycles | cycles | cycles | cycles |
| Comparative | 5 | 4 | 4 | 4 | 4 | 4 |
| Example 2 | | | | | | |
| Example 3 | 5 | 5 | 5 | 5 | 5 | 5 |

The evaluation results of the shrinkage rate are shown in Table 15. In the knitted fabric of Example 3 subjected to the plasma treatment, the shrinkage rate was lower than that of the knitted fabric of Comparative Example 2 subjected to no plasma treatment.

TABLE 15

| | Shrinkage rate (%) | | | | |
|---|---|---|---|---|---|
| | After one | After two | After three | After four | After five |
| | cycle | cycles | cycles | cycles | cycles |
| Comparative | 19.5 | 22.0 | 24.3 | 25.3 | 27.1 |
| Example 2 | | | | | |
| Example 3 | 10.7 | 15.0 | 17.0 | 17.0 | 18.9 |

From the results of Test Examples 3 and 4, it can be understood that the portion B can be formed (therefore, a region other than the portion B is configured as the portion A) by binding the hydrophobic polymer to the surface of the base material (woven fabric or knitted fabric) by the plasma treatment.

### Test Example 5: Production of Fabric

### (1) Preparation of Spinning Solution (Dope Solution)

Using DMSO in which lithium chloride was dissolved so that a concentration thereof was 4 mass % as a solvent, a lyophilized powder of the modified fibroin (PRT799) produced above was added to the solvent so that a concentration thereof was 24 mass %. The mixture was dissolved with an aluminum block heater at 90° C. for 1 hour, and then insoluble matters and bubbles were removed to obtain a spinning solution (dope solution).

### (2) Spinning

The spinning solution was filled in a reserve tank, and the spinning solution was discharged into 100 mass % of a methanol coagulation bath from a mono-hole nozzle having a diameter of 0.1 or 0.2 mm using a gear pump. A discharge amount was adjusted to 0.01 to 0.08 mL/min. After the coagulation, washing and drawing were performed in 100 mass % of the methanol washing bath. After the washing and drawing, drying was performed using a dry heat plate, and the obtained raw yarns (modified fibroin fibers) were wound.

### (3) Production of Base Material (Woven Fabric)

Twisted yarns were produced from the obtained modified fibroin fibers. The produced twisted yarns were subjected to plain weaving to obtain a woven fabric.

### (4) UV Printing on Surface of Base Material (Woven Fabric)

A pattern was printed on the obtained woven fabric using a UV printer (VersaUV LEF2-200, manufactured by Roland DG Corporation) according to the pattern illustrated in FIG. 3 so that the ink was fixed to the region corresponding to the portion B and the ink was not fixed to the region corresponding to the portion A. The used ink is an ink obtained by mixing the same amounts of the following six types of inks. The photograph of the obtained fabric is illustrated in FIG. 4.
EUV-CY Ver. 2, manufactured by Roland DG Corporation
EUV-MG Ver. 2, manufactured by Roland DG Corporation
EUV-YE Ver. 2, manufactured by Roland DG Corporation
EUV-BK Ver. 2, manufactured by Roland DG

Corporation
EUV-WH Ver. 2, manufactured by Roland DG Corporation
EUV-GL Ver. 2, manufactured by Roland DG Corporation

A diameter of the portion A (circular shape) was 1.5 cm, and a distance between the portions A was 1.5 cm.

### Test Example 6: Production of Fabric 6 Having Three-Dimensional Shape

The fabric obtained in Test Example 5 (see FIG. 4) was immersed in water at 70° C. for 1 minute and then was brought into contact with water. After the immersion, the fabric was immediately pulled up, was placed on a dried towel, and then was dried by blowing hot air with a dryer. Next, steam and pressure were applied using an iron to flatten the fabric, thereby obtaining a fabric 6 having a three-dimensional shape. The photograph of the obtained fabric 6 having a three-dimensional shape is illustrated in FIG. 5.

As illustrated in FIG. 5, it can be seen that the portion A to which the ink is not fixed shrinks when being brought into contact with water, wrinkles are formed between the portions A, convex portions (concave portions when viewed from the back) are formed by the region of the portion B interposed by the wrinkles, and thus, the three-dimensional shape is formed.

### Test Example 7: Production of Fabric 7 Having Three-Dimensional Shape

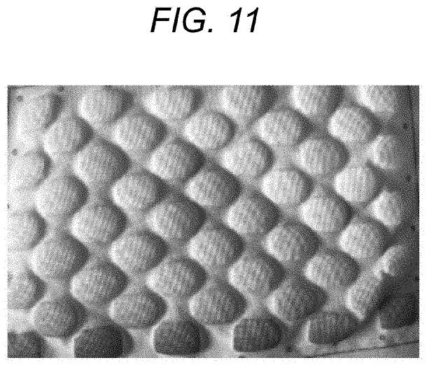

A fabric 7 having a three-dimensional shape different from the three-dimensional shape of the fabric 6 having a three-dimensional shape was produced by performing the same method as for the fabric 6 having a three-dimensional shape except that the pattern to be printed on the base material was different. The photograph of the produced fabric 7 having a three-dimensional shape is illustrated in FIG. 11.

As illustrated in FIG. 11, it can be seen that various fabrics having three-dimensional shapes can be produced by changing the printing pattern.

### REFERENCE SIGNS LIST

1 Base material
2 Water-repellent or waterproof coating film
10, 20, 30, 40, 50 Fabric

### SEQUENCE LISTING

1. A fabric comprising an artificial protein fiber that contains a protein,
wherein the fabric has a surface including:
a portion A that shrinks at a predetermined shrinkage rate when being brought into contact with water; and
a portion B that has a shrinkage rate lower than that of the portion A when being brought into contact with water.

2. The fabric according to claim 1, wherein the portion B is a portion that does not shrink when being brought into contact with water.

3. The fabric according to claim 1, wherein a plurality of portions A are present.

4. The fabric according to claim 1, wherein the fabric includes a base material that contains the artificial protein fiber and a water-repellent or waterproof coating film that partially covers a surface of the base material, and
the portion B is composed of a coated portion by the coating film, and the portion A is composed of an uncoated portion.

5. The fabric according to claim 1, wherein the portion A contains the artificial protein fiber that shrinks at the predetermined shrinkage rate when being brought into contact with water, and the portion B contains a fiber that has the shrinkage rate lower than that of the artificial protein fiber contained in the portion A.

6. The fabric according to claim 5, wherein the portion B contains an artificial protein fiber that has the shrinkage rate lower than that of the artificial protein fiber contained in the portion A.

7. The fabric according to claim 1, wherein at least the artificial protein fiber contained in the portion A has a shrinkage rate when dried of more than 7%, the shrinkage rate when dried being defined by the following Equation I:
Shrinkage rate when dried={1−(length of artificial protein fiber in dry state/length of artificial protein fiber before being brought into contact with water after spinning)}×100(%) (Equation I).

8. The fabric according to claim 1, wherein the protein is modified fibroin.

9. A fabric, wherein the fabric has a surface including:
a portion C that contains a fiber that shrinks at a predetermined shrinkage rate in response to an external stimulus; and
a portion D that contains a fiber of which a shrinkage rate obtained by the external stimulus is smaller than that of the fiber contained in the portion C, and
a shrinkage rate obtained by the external stimulus of the portion D is smaller than that of the portion C.

10. The fabric according to claim 9, wherein the fabric is made of a woven fabric obtained by knitting yarns extending in one direction and yarns extending in a direction intersecting with the one direction, the yarns extending in the one direction form the portion C that contains the fiber that shrinks at the predetermined shrinkage rate in response to the external stimulus, and the yarns extending in the direction intersecting with the one direction form the portion D that contains the fiber of which the shrinkage rate obtained by the external stimulus is smaller than that of the fiber contained in the portion C.

11. A fabric having a three-dimensional shape, comprising an artificial protein fiber that contains a protein,
wherein the fabric has a surface including:
a portion E that is shrunk at a predetermined shrinkage rate by being brought into contact with water; and
a portion F that is shrunk at a shrinkage rate lower than that of the portion E by being brought into contact with water or is not shrunk even by being brought into contact with water, and
the three-dimensional shape is formed on the surface due to a difference in shrinkage rate between the portion E and the portion F.

12. The fabric having a three-dimensional shape according to claim 11, wherein the portion F is a portion that is not shrunk even by being brought into contact with water.

13. (canceled)

14. A method for producing a fabric having a three-dimensional shape, the method comprising a step of performing shrinking processing including bringing the fabric according to claim 1 into contact with water.

15. A method for producing a fabric having a three-dimensional shape, the method comprising a step of performing shrinking processing including applying an external stimulus to the fabric according to claim 9.
